(19) United States
(12) Patent Application Publication
(10) Pub. No.: US 2026/0161104 A1
(43) Pub. Date: Jun. 11, 2026

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: SHUNTARO WATANABE, Kanagawa (JP); TAICHI SATO, Shizuoka (JP); NAO HIGUCHI, Shizuoka (JP); KENTARO TANAKA, Shizuoka (JP); MASATADA HIROTA, Shizuoka (JP); TOMOHITO ISHIDA, Shizuoka (JP); TSUTOMU NISHIDA, Shizuoka (JP)

(21) Appl. No.: 19/179,882

(22) Filed: Apr. 15, 2025

Related U.S. Application Data
(63) Continuation of application No. PCT/JP2023/037414, filed on Oct. 16, 2023.

(30) Foreign Application Priority Data
Oct. 19, 2022 (JP) 2022-167788
Apr. 26, 2023 (JP) 2023-072647

(51) Int. Cl. G03G 5/147; G03G 5/06

(52) U.S. Cl. CPC G03G 5/14704; G03G 5/14734; G03G 5/0696

(57) ABSTRACT

The electrophotographic photosensitive member of the present invention is characterized in that: when convex portions, which are derived from particles PAA, and which each have a height in a range of 10 nm or more and 300 nm or less, are defined as convex portions CA, the convex portions CA are arranged on a surface of the surface layer; an average value of distances between gravity centers of the convex portions CA is 150 nm or more and 500 nm or less, and a standard deviation of the distances between gravity centers of the convex portions CA is 250 nm or less; and, an area occupied by the particles on the surface of the surface layer is represented by S1 and an area occupied by portions except the particles is represented by S2, S1/(S1+S2) is 0.70 or more and 1.00 or less.

### CROSS-REFERENCE TO RELATED APPLICATIONS

This application is a Continuation of International Patent Application No. PCT/JP2023/037414, filed Oct. 16, 2023, which claims the benefit of Japanese Patent Application No. 2022-167788, filed Oct. 19, 2022, and Japanese Patent Application No. 2023-072647, filed Apr. 26, 2023, all of which are hereby incorporated by reference herein in their entirety.

### BACKGROUND OF THE INVENTION

### Field of the Invention

The present invention relates to an electrophotographic photosensitive member, and a process cartridge and an electrophotographic apparatus each including the electrophotographic photosensitive member.

### Description of the Related Art

In recent years, lengthening a lifetime of an electrophotographic photosensitive member to be mounted on an electrophotographic apparatus and improving image quality in a case of its repeated use has been demanded, and an improvement in mechanical durability of a surface layer of the electrophotographic photosensitive member has been required. In addition, in the electrophotographic apparatus, there is a transferring step including, after developing a latent image exposed to light on the electrophotographic photosensitive member with toner, applying a predetermined transfer bias to the toner to transfer the toner from the electrophotographic photosensitive member to a transfer material such as paper through an intermediate transfer member. In the transferring step, it is required to efficiently transfer the toner developed on the surface of the electrophotographic photosensitive member to the intermediate transfer member or the transfer material such as paper without leaving much of the toner on the surface of the electrophotographic photosensitive member. Thus, great reduction of an adhesive force of the toner to the surface layer of the electrophotographic photosensitive member greatly contributes to reduction of residual toner. In addition, the reduction of residual toner that is not transferred enables cleaning means in a process cartridge of the electrophotographic apparatus to be omitted and contributes to the reduction in size of the electrophotographic apparatus.

The reduction of the adhesive property between the toner and the surface layer of the electrophotographic photosensitive member reduces the transfer bias to be applied in the transferring step, and hence a space for a high-voltage power source for applying a high transfer bias can be saved in the electrophotographic apparatus. Further, scattering of the toner on the transfer material by discharge caused by a high transfer bias is suppressed, and image quality can be improved. Two types of adhesive forces, non-electrostatic adhesive force and electrostatic adhesive force, greatly contribute to the adhesive property between the toner and the surface layer of the electrophotographic photosensitive member in the transferring step. The non-electrostatic adhesive force can be reduced by imparting a shape to the surface of the surface layer of the electrophotographic photosensitive member to reduce the contact area with the toner, to thereby bring the toner and the surface of the electrophotographic photosensitive member into point contact with each other to the extent possible. In addition, the electrostatic adhesive force can be reduced by causing the toner to roll or rotate in a layer of the toner sandwiched between the surface layer of the electrophotographic photosensitive member and the transfer material to reduce the image force caused by the surface charge of the toner. There are several methods of imparting a shape to the surface of the surface layer of the electrophotographic photosensitive member, and as one of these methods, a method including incorporating particles and a binder resin be into the surface layer of the electrophotographic photosensitive member to form convex portions derived from the particles on the surface of the surface layer of the electrophotographic photosensitive member has hitherto been proposed.

In Japanese Patent Application Laid-Open No. 2009-229495, a technology including incorporating electroconductive titanium oxide particles into the protection layer of an electrophotographic photosensitive member in order to improve a cleaning property and maintain a stable potential characteristic even under a severe environment is described.

In Japanese Patent Application Laid-Open No. 2020-071423, a technology including controlling convex shapes on a surface of toner and incorporating an inorganic filler into an outermost layer of an electrophotographic photosensitive member in order to improve a cleaning property is described.

In Japanese Patent Application Laid-Open No. 2013-195707, a technology including causing electroconductive particles to be present near insulating particles in a protection layer of an electrophotographic photosensitive member in order to improve abrasion resistance thereof and suppress an increase in potential of an exposure portion thereof is described.

In Japanese Patent Application Laid-Open No. 2014-002364, a technology including incorporating tin oxide treated with a special surface treatment agent and silica particles into the protection layer of an electrophotographic photosensitive member in order to increase the surface hardness of the protection layer to improve the abrasion resistance and flaw resistance thereof is described.

However, an investigation made by the inventors of the present invention has found that in each of the electrophotographic photosensitive members described in Japanese Patent Application Laid-Open No. 2009-229495, Japanese Patent Application Laid-Open No. 2020-071423, Japanese Patent Application Laid-Open No. 2013-195707, and Japanese Patent Application Laid-Open No. 2014-002364, the contact area between the toner and the surface layer of the electrophotographic photosensitive member is reduced by convex portions derived from the particles in the surface layer of the electrophotographic photosensitive member, but it is difficult to suppress detachment of the particles from the surface layer through closeness between the particles. Further, it has been found that transferability is deteriorated when the adhesive property of the toner to the surface layer in a durability test of the electrophotographic photosensitive member is increased.

### SUMMARY OF THE INVENTION

Accordingly, an object of the present invention is to provide an electrophotographic photosensitive member, which has transferability improved by controlling a distance between particles in a surface layer to reduce the adhesive force of toner, and which has durability improved by suppressing the detachment of the particles from the surface layer.

The above-mentioned object is achieved by the present invention described below. That is, the present invention is directed to an electrophotographic photosensitive member including a surface layer containing particles and a binder resin, wherein the particles in the surface layer have a plurality of peaks in a number-based particle size distribution, wherein, when, of the peaks each having a peak top at 20 nm or more among the plurality of peaks, the peak having a highest frequency at the peak top is defined as a first peak, and the peak having a second highest frequency at the peak top after the first peak is defined as a second peak, and when, of the first peak and the second peak, the peak having a larger value of a particle diameter at the peak top is defined as a peak PEA, a particle diameter DA at the peak top of the peak PEA falls within a range of 80 nm or more and 300 nm or less, wherein, when, of the particles in the surface layer, the particles each having a particle diameter in a range of DA±20 nm are defined as particles PAA, and convex portions, which are derived from the particles PAA, and which each have a height in a range of 10 nm or more and 300 nm or less, are defined as convex portions CA, the convex portions CA are arranged on a surface of the surface layer, wherein, when the surface layer is viewed from above, an average value of distances between gravity centers of the convex portions CA is 150 nm or more and 500 nm or less, and a standard deviation of distances between gravity centers of the convex portions CA is 250 nm or less, and wherein, when the surface layer is viewed from above, and when an area occupied by the particles on the surface of the surface layer is represented by S1 and an area occupied by portions except the particles is represented by S2, S1/(S1+S2) is 0.70 or more and 1.00 or less.

The present invention is also directed to a process cartridge including: the above-mentioned electrophotographic photosensitive member; and at least one means selected from the group consisting of: charging means; developing means; and cleaning means, the process cartridge integrally supporting the electrophotographic photosensitive member and the at least one means, and being detachably attachable onto a main body of an electrophotographic apparatus.

The present invention is also directed to an electrophotographic apparatus including: the above-mentioned electrophotographic photosensitive member; and charging means, exposing means, developing means, and transfer means.

Further features of the present invention will become apparent from the following description of exemplary embodiments with reference to the attached drawings.

### BRIEF DESCRIPTION OF THE DRAWINGS

FIG. 1 is a conceptual view for illustrating an example of the layer configuration of an electrophotographic photosensitive member according to the present invention.

FIG. 2 is a conceptual view for illustrating another example of the layer configuration of the electrophotographic photosensitive member according to the present invention.

FIG. 3 is a conceptual view obtained by observing a surface layer of the electrophotographic photosensitive member according to the present invention from above (surface observation).

FIG. 4 is a conceptual view for illustrating a method including observing the surface layer of the electrophotographic photosensitive member according to the present invention from above (surface observation) and calculating an interparticle distance of particles PAA.

FIG. 5 is a conceptual view of an example of observation of the surface layer of the electrophotographic photosensitive member according to the present invention from a side (sectional observation).

FIG. 6 is a conceptual view of another example of the observation of the surface layer of the electrophotographic photosensitive member according to the present invention from a side (sectional observation).

FIG. 7 shows an example of a scanning probe microscope (SPM) image obtained by observing the surface layer of the electrophotographic photosensitive member according to the present invention.

FIG. 8 shows an example of a STEM image of electroconductive particles according to the present invention.

FIG. 9 is a schematic view for illustrating the STEM image of FIG. 8.

FIG. 10 is a view for illustrating an example of a schematic configuration of an electrophotographic apparatus including a process cartridge that includes an electrophotographic photosensitive member and charging means.

FIG. 11A is a graph showing an example of a particle size distribution of particles in the surface layer of the electrophotographic photosensitive member according to the present invention.

FIG. 11B is a graph showing another example of the particle size distribution of the particles in the surface layer of the electrophotographic photosensitive member according to the present invention.

### DESCRIPTION OF THE EMBODIMENTS

The present invention is described in detail below by way of preferred embodiments.

### [Electrophotographic Photosensitive Member]

An electrophotographic photosensitive member of the present invention is characterized by including a surface layer containing particles and a binder resin.

The term “surface layer” as used herein refers to a layer positioned on an outermost surface in the electrophotographic photosensitive member, and means a layer to be brought into contact with a charging member or toner.

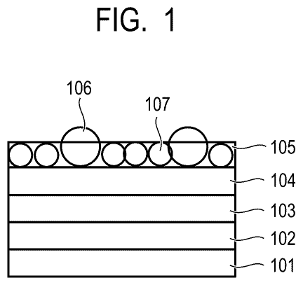

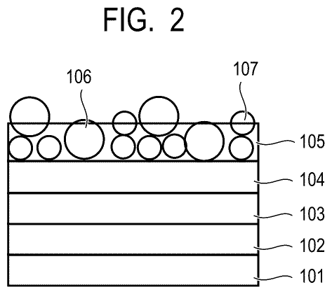

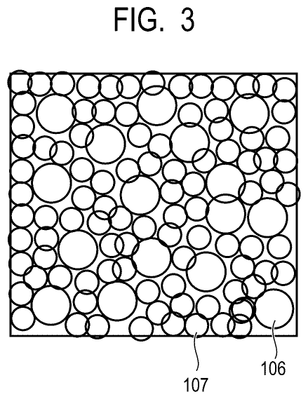

FIG. 1 and FIG. 2 are each a view for illustrating an example of layer configuration of the electrophotographic photosensitive member. In each of FIG. 1 and FIG. 2, a support is represented by reference symbol 101, an undercoat layer is represented by reference symbol 102, a charge-generating layer is represented by reference symbol 103, and a charge-transporting layer is represented by reference symbol 104. The surface layer according to the present invention is represented by reference symbol 105, particles PAA according to the present invention are each represented by reference symbol 106, and particles except the particles PAA according to the present invention are each represented by reference symbol 107.

A method of producing the electrophotographic photosensitive member of the present invention is, for example, a method including: preparing coating liquids for respective layers to be described later; applying the coating liquids in a desired order of layers; and drying the coating liquids. In this case, examples of a method of applying the coating liquid include dip coating, spray coating, inkjet coating, roll coating, die coating, blade coating, curtain coating, wire bar coating, ring coating, and dispense coating. Among those, dip coating is preferred from viewpoints of efficiency and productivity.

The respective layers are described below.

### <Surface Layer>

The electrophotographic photosensitive member of the present invention is an electrophotographic photosensitive member including a surface layer containing particles and a binder resin, wherein the particles in the surface layer have a plurality of peaks in a number-based particle size distribution, wherein, when, of the peaks each having a peak top at 20 nm or more among the plurality of peaks, the peak having a highest frequency at the peak top is defined as a first peak, and the peak having a second highest frequency at the peak top after the first peak is defined as a second peak, and when, of the first peak and the second peak, the peak having a larger value of a particle diameter at the peak top is defined as a peak PEA, a particle diameter DA at the peak top of the peak PEA falls within a range of 80 nm or more and 300 nm or less, wherein, when, of the particles in the surface layer, the particles each having a particle diameter in a range of DA±20 nm are defined as particles PAA, and convex portions, which are derived from the particles PAA, and which each have a height in a range of 10 nm or more and 300 nm or less, are defined as convex portions CA, the convex portions CA are arranged on a surface of the surface layer, wherein, when the surface layer is viewed from above, an average value of distances between gravity centers of the convex portions CA is 150 nm or more and 500 nm or less, and a standard deviation of the distances between gravity centers of the convex portions CA is 250 nm or less, and wherein, when the surface layer is viewed from above, and when an area occupied by the particles on the surface of the surface layer is represented by S1 and an area occupied by portions except the particles is represented by S2, S1/(S1+S2) is 0.70 or more and 1.00 or less.

Although the reason why effects of the present invention can be exhibited by the above-mentioned conditions has not been clearly elucidated, the inventors of the present invention have assumed the reason to be as described below.

Meanwhile, to improve transferability in an electrophotographic apparatus, the adhesive force of toner with which an electrostatic latent image on its electrophotographic photosensitive member is developed needs to be reduced. The adhesive force between the toner and the electrophotographic photosensitive member is roughly classified into an electrostatic adhesive force and a non-electrostatic adhesive force. Non-electrostatic adhesive force is caused by a van der Waals force based on an intermolecular force between objects. Accordingly, the impartment of a shape to the surface of the surface layer of the electrophotographic photosensitive member leads to the reduction of the contact area between the toner and the surface layer of the electrophotographic photosensitive member, and can greatly contribute to the reduction of the non-electrostatic adhesive force. The electrostatic adhesive force is mainly caused by an image force, and is hence greatly influenced by a charge amount of toner. The magnitude of an image force is proportional to the charge amount of toner, and is inversely proportional to a square of a distance between the charge amount of toner and the surface of the electrophotographic photosensitive member to which the toner adheres. Thus, the distance between the electrophotographic photosensitive member and the toner can be secured by properly setting the height of each of the convex portions derived from the particles on the surface of the electrophotographic photosensitive member, and hence the image force is reduced. In addition, impartment of a surface profile to the surface layer accelerates rolling of toner in a layer of the toner sandwiched between the surface of the surface layer of the electrophotographic photosensitive member and an intermediate transfer member or a transfer material such as paper. Thus, the image force in the surface charge of the surface of the toner can also be reduced. As a result, the adhesive force of the toner is reduced, and the transferability of the toner to the transfer material is improved. Examples of a method of properly arranging the convex portions include: controlling the particle diameter of each of the particles to be introduced; and arranging the particles on the surface of the surface layer by increasing the ratio of the particles in the surface layer. An investigation made by the inventors of the present invention has found that the height of each of the convex portions derived from the particles is easily controlled by allowing a plurality of particles having different particle diameters to be mixed in the surface layer.

The electrophotographic photosensitive member of the present invention is an electrophotographic photosensitive member including a surface layer containing particles and a binder resin, and the particles have a plurality of peaks in a number-based particle size distribution. Of the peaks each having a peak top at 20 nm or more among the plurality of peaks, the peak having the highest frequency at the peak top is defined as a first peak, and further, of the peaks each having a peak top at 20 nm or more among the plurality of peaks, the peak having the second highest frequency at the peak top after the first peak is defined as a second peak. When the first peak and the second peak are compared to each other, the peak having a larger value of a particle diameter at the peak top is defined as a peak PEA. In the present invention, a particle diameter DA at the peak top of the peak PEA preferably falls within a range of from 80 nm to 300 nm, more preferably falls within a range of from 85 nm to 250 nm, and still more preferably falls within a range of from 90 nm to 250 nm. When the particle diameter DA falls within the above-mentioned ranges, the above-mentioned reducing effect on the adhesive property between the toner and the surface layer of the electrophotographic photosensitive member is easily obtained in a transferring step.

In this case, the particle diameter DA at the peak top of the PEA represents the particle diameter of a particle having a highest particle diameter frequency in the surface layer. When the particle diameter DA is less than 80 nm, a height of each of the convex portions that contribute to the point contact between the toner and the convex portions derived from the particles in the surface layer of the electrophotographic photosensitive member is decreased, and the contact area between the toner and the surface of the surface layer of the electrophotographic photosensitive member is increased to deteriorate an adhesive property of the toner, with a result that an transferability is decreased.

When the particle diameter DA is more than 300 nm, the curvature of each of the convex portions derived from the particles is decreased, and the contact area between the toner and the surface of the surface layer is increased to increase the adhesive force between the toner and the surface of the electrophotographic photosensitive member, with a result that the transferability is deteriorated.

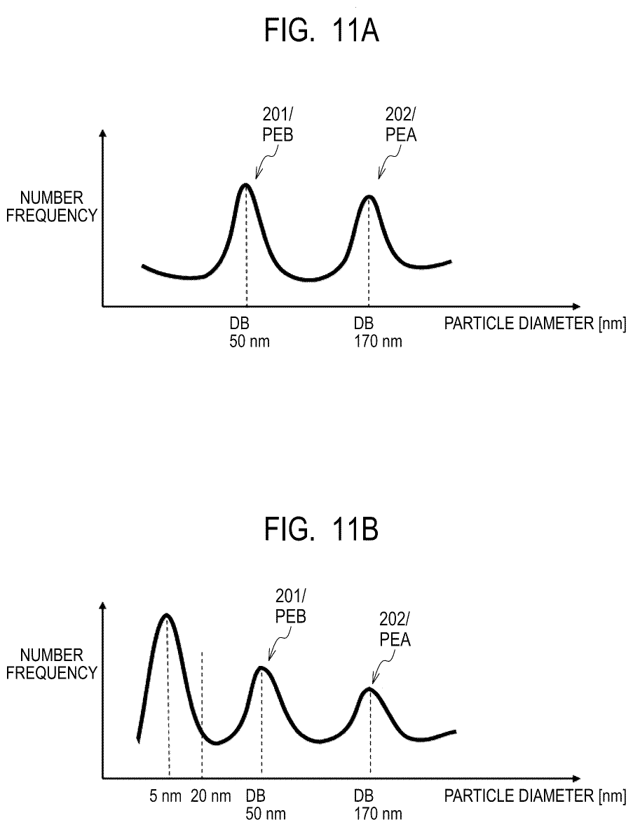

In addition, the first peak and the second peak are selected from a range in which a particle size corresponding to the peak top is 20 nm or more. That is, of the peaks each having a peak top at 20 nm or more among the plurality of peaks, a peak having a highest frequency at the peak top is defined as a first peak, and a peak having a second highest frequency at the peak top after the first peck is defined as a second peak. FIG. 11A is a graph showing an example of a number-based particle size distribution of particles in a surface layer of an electrophotographic photosensitive member, in which a first peak 201 is present at a particle diameter of 50 nm and a second peak 202 is present at a particle diameter of 170 nm. In this case, the second peak 202 at a large particle diameter becomes the peak PEA, and the particle diameter DA thereof is 170 nm. Thus, a condition of 80 nm≤DA is satisfied. In addition, the first peak 201 is present at a particle diameter of 50 nm, and hence the condition that the particle diameter at the peak top is 20 nm or more is satisfied.

FIG. 11B is a graph showing another example of particle size distribution of the particles in the surface layer of the electrophotographic photosensitive member. Although there is a peak at a particle diameter of 5 nm, this peak is not included in the first peak or the second peak because the particle diameter at the peak top is less than 20 nm. Thus, in a same manner as in a case of FIG. 11A, a peak at a particle diameter of 50 nm becomes the first peak 201, and a peak at a particle diameter of 170 nm becomes the second peak 202. The peaks are selected in this manner. Here, even in the electrophotographic photosensitive member 1 containing a large number of significantly small particles in the surface layer 105, the effects of the present invention to be described later can be obtained. In view of the foregoing, effects of the present invention can be stably obtained by selecting the first peak 201 and the second peak 202 from the peaks at a particle diameter of 20 nm or more as described with reference to FIG. 11A and FIG. 11B.

Next, the particles each having a particle diameter in a range of DA±20 nm in the surface layer of the electrophotographic photosensitive member of the present invention are defined as particles PAA. In addition, in the present invention, when convex portions, which are derived from the particles PAA, and which each have a height of 10 nm or more and 300 nm or less, are defined as convex portions CA, the convex portions CA are present on the surface of the surface layer. When a height of each of the convex portions CA is less than 10 nm, the height of each of the convex portions CA becomes too low. Thus, a rotation of the toner is not accelerated in the contact between the electrophotographic photosensitive member and the toner, and the electrostatic adhesive force between the toner and the surface layer of the electrophotographic photosensitive member is not decreased to deteriorate the transferability. When a height of each of the convex portions CA is more than 300 nm, concave portions are enlarged in the surface layer of the electrophotographic photosensitive member, and as a result of a progress of an accumulation of external additives for the toner, the contact area between the surface of the surface layer of the electrophotographic photosensitive member and the toner is increased to deteriorate the transferability.

Next, in the electrophotographic photosensitive member of the present invention, when the surface layer of the electrophotographic photosensitive member is viewed from above, an average value of the distances between gravity centers of the convex portions CA is 150 nm or more and 500 nm or less.

When the average value of the distances between gravity centers of the convex portions CA of the surface layer of the electrophotographic photosensitive member is more than 500 nm, and intervals between the convex portions CA derived from the particles become too large, a possibility of a contact between the toner and the surface of the surface layer of the electrophotographic photosensitive member is increased. As a result, the distance between the toner and the surface of the surface layer of the electrophotographic photosensitive member cannot be kept, and the toner and the concave portions of the surface layer are liable to be brought into contact with each other to deteriorate the transferability. The Coulomb's force is not decreased, and hence an electrostatic adhesive force is increased, with a result that the transferability cannot be improved.

Meanwhile, when the average value of distances between gravity centers of the convex portions CA is less than 150 nm, and the distances between gravity centers of the convex portions CA in the surface layer of the electrophotographic photosensitive member are decreased, the surface layer is filled with the convex portions CA, and the number of contact points between toner parent particles and the surface layer is increased. Thus, the contact area between the toner and the surface layer of the electrophotographic photosensitive member is increased to increase the non-electrostatic adhesive force, with a result that the transferability is deteriorated.

The distances between gravity centers of the convex portions CA on the surface of the surface layer of the electrophotographic photosensitive member of the present invention are each more preferably 150 nm or more and 450 nm or less, still more preferably 150 nm or more and 400 nm or less.

Further, in the electrophotographic photosensitive member of the present invention, standard deviation of the distances between gravity centers of the convex portions CA is 250 nm or less. When the standard deviation of the distances between gravity centers of the convex portions CA is more than 250 nm, there is a wide variation in distribution of the convex portions CA in the surface layer, and this variation causes unevenness in the adhesive force between the toner and the surface of the electrophotographic photosensitive member. This unevenness of the adhesive force causes unevenness of the transferability, and roughness becomes noticeable in a halftone image. The standard deviation of the average value of the distances between gravity centers is preferably 200 nm or less, more preferably 175 nm or less.

Similarly, a coefficient of variation obtained by dividing the standard deviation of the distances between gravity centers of the convex portions CA by the average value of the distances between gravity centers is preferably 50% or less. When a coefficient of variation of the average value of the distances between gravity centers is more than 50%, the surface layer has a wide variation in distribution of the convex portions CA, and this variation causes unevenness in the adhesive force between the toner and the surface of the electrophotographic photosensitive member. This unevenness of the adhesive force causes unevenness of the transferability, and roughness becomes noticeable in a halftone image. The coefficient of variation of the average value of the distances between gravity centers is more preferably 40% or less, still more preferably 35% or less.

An investigation made by the inventors of the present invention has found that, when each region between the particles PAA is further filled with particles except the particles PAA in a surface direction of a drum (electrophotographic photosensitive member) in a manner close to a close-packed state, the closeness between the particles is increased. A reason for this is as described below. When the particles PAA receive impact in a tangent direction of the drum surface, restraint by the binder resin between the particles and the movement of the particles to the drum surface direction are held back by the particles except the particles PAA by controlling the distances between the particles PAA to the above-mentioned range, and thus the movement of the particles PAA is suppressed. As a result, the effect that the detachment of the particles PAA from the surface layer of the electrophotographic photosensitive member is suppressed even with respect to rubbing between the electrophotographic photosensitive member and a charging member, a developing member, and a transfer member that are brought into abutment against the electrophotographic photosensitive member is obtained. Thus, in the present invention, the surface profile of the surface layer of the electrophotographic photosensitive member excellent in transferability can be maintained throughout a durability test. With this configuration, the surface profile of the surface of the surface layer of the electrophotographic photosensitive member is easily imparted, and hence the contact area with the toner is decreased to reduce the adhesive property with the toner, and as a result, the state having improved transferability can be maintained. In addition, the surface of the surface layer of the electrophotographic photosensitive member is less liable to be contaminated, and hence the situation in which a latent image is disturbed, and the density is not easily obtained can be easily avoided.

In addition, in the surface of the surface layer of the electrophotographic photosensitive member of the present invention, the particles refer to all particles, for example, particles A, particles B, and other particles to be described later, and when an area occupied by the particles is represented by S1 and an area occupied by portions except the particles is represented by S2, S1/(S1+S2) is 0.70 or more and 1.00 or less. When the S1/(S1+S2) is less than 0.70, the portions free of the particles cannot form convex portions. In the present invention, the surface of the surface layer of the electrophotographic photosensitive member of the present invention is observed from above with a scanning electron microscope (SEM) under the setting of an acceleration voltage of 5 kV or more. An area in which an image of particles is recognized in a backscattered electron image of the surface layer is added to the area S1 occupied by the particles.

Theoretically, the upper limit of the S1/(S1+S2) is 1.00. The S1/(S1+S2) is more preferably 0.80 or more and 1.00 or less, still more preferably 0.85 or more and 0.95 or less.

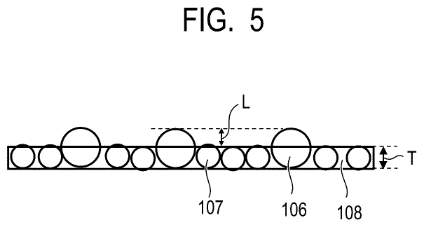

In the case where the particles are laminated in a single layer as illustrated in FIG. 5 in a cross-section of the surface layer in the electrophotographic photosensitive member of the present invention, when an average value of thicknesses of the surface layer in sites that are free of the particles PAA in a cross-section of the surface layer is represented by T, it is preferred that the DA and the T satisfy the following formula (1).

$$D A > T \qquad Formula ( 1 )$$

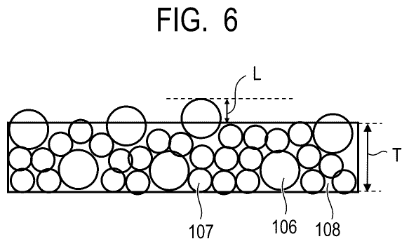

In a case where the particles are laminated in a plurality of layers as illustrated in FIG. 6, when an average value of thicknesses of the surface layer in sites that are free of the particles PAA in the cross-section of the surface layer is represented by T, itis preferred that the DA and the T satisfy the following formula (1)′.

$$D A \times 2 > T \qquad Formula {( 1 )}^{′}$$

When the DA is smaller than the average value T of the thicknesses, it becomes difficult to form such convex portions CA as described above, and reduction of the adhesive property between the toner parent particles and the electrophotographic photosensitive member becomes insufficient, with a result that a risk of deterioration of the transferability is increased. The average value T of the thicknesses is preferably 50 nm or more and 500 nm or less, more preferably 70 nm or more and 450 nm or less, still more preferably 80 nm or more and 400 nm or less as long as the particles are laminated as illustrated in FIG. 1 and FIG. 2 in a manner that satisfies the formula (1).

In addition, in the cross-section of the surface layer in the electrophotographic photosensitive member of the present invention, the particles in the surface layer have a plurality of peaks in a number-based particle size distribution. Among the peaks each having a peak top at 20 nm or more among the plurality of peaks, the peak having the highest frequency at the peak top is defined as a first peak, and the peak having the second highest frequency at the peak top after the first peak is defined as a second peak. Further, when the first peak and the second peak are compared to each other, the peak having a smaller value of a particle diameter at the peak top is defined as a peak PEB, a particle diameter at the peak top of the peak PEB is represented by DB, and an average value of thicknesses of the surface layer in sites that are free of the particles PAA in a cross-section of the surface layer is represented by T, it is preferred that the DB and the T satisfy the following formula (2).

$$DB < T \qquad Formula ( 2 )$$

In the case where particles each having a particle diameter in a range of DB±20 nm among all the particles in the surface layer are defined as particles PAB, when the DB is equal to or less than the average value T of the thicknesses, closeness between the particles PAA for forming the convex portions CA and the particles PAB arranged between the convex portions CA is increased, and clear concave portions are formed in the surface layer. Thus, the detachment of the particles is suppressed. When the DB is equal to or more than the average value T of the thicknesses, the particles PAB are liable to be exposed from the surface layer, and the detachment of the particles is liable to proceed.

Further, in the cross-section of the surface layer in the electrophotographic photosensitive member of the present invention, it is preferred that the DA and the DB satisfy the following formula (3).

$$DB / DA > 1 / 10 \qquad Formula ( 3 )$$

When the particles PAA form the convex portions CA, and the regions between the particles PAA are filled with the particles PAB, the average value and standard deviation of the distances between gravity centers of the convex portions CA can be controlled. In addition, when the sizes of the particle diameters of the particles PAA and the particles PAB satisfy the formula (3), the detachment of the particles can be suppressed with respect to rubbing in a tangent direction in the surface layer of the electrophotographic photosensitive member while the height of each of the convex portions CA is sufficiently kept. The DB/DA in the formula (3) is preferably more than ⅓, and the DB/DA is more preferably more than ½.

Next, a ratio of a number of the convex portions CA to a total number of the convex portions present on the surface of the surface layer in the electrophotographic photosensitive member of the present invention is preferably 90 number % or more. When the ratio of the number of the convex portions CA is less than 90 number %, the convex portions that are not derived from the particles PAA have weak mechanical strength and are abraded with respect to rubbing in a tangent direction of the electrophotographic photosensitive member by rubbing in a developing portion in the electrophotographic apparatus. In this case, it becomes difficult to maintain the transferability in a satisfactory state with respect to long-term use.

Further, half-width of the peak PEA in the surface layer of the electrophotographic photosensitive member of the present invention is preferably 20 nm or more and 50 nm or less. The height of each of the convex portions CA is controlled depending on the size of the particle diameter, and hence it is preferred that the half-width of the peak PEA fall within a certain range to the extent possible. When the half-width of the PEA is more than 50 nm, the heights of the convex portions CA also have large variation, resulting in variation of point contact between the toner parent particles and the surface of the surface layer of the electrophotographic photosensitive member. As a result, the rotation of the toner is not accelerated, and it becomes difficult to reduce the electrostatic adhesive force between the surfaces. The adhesive force of the toner to the electrophotographic photosensitive member is reduced by accelerating the point contact between the toner and the electrophotographic photosensitive member, and hence the transferability can be improved.

Maximum height difference Rz of the surface of the surface layer in the electrophotographic photosensitive member of the present invention is preferably 100 nm or more and 400 nm or less. When the maximum height difference Rz of the surface of the surface layer is less than 100 nm, the rotation of the toner is not properly accelerated, and the transferability is not improved. When the maximum height difference Rz of the surface of the surface layer is more than 400 nm, the accumulation of external additives proceeds in the concave portions, and hence the surface of the surface layer of the electrophotographic photosensitive member is contaminated, with a result that a latent image may be disturbed to make it difficult to obtain density. In addition, the surface profile is not easily imparted to the surface of the surface layer of the electrophotographic photosensitive member, and hence the contact area between the surface and the toner is increased to deteriorate the transferability. In addition, discharge is liable to occur in the transferring step, and roughness caused by density unevenness may occur in a halftone image. The maximum height difference Rz is more preferably 125 nm or more and 375 nm or less, still more preferably 150 nm or more and 350 nm or less. Regarding a method of measuring the maximum height difference Rz, the surface profile of the surface of the electrophotographic photosensitive member measuring 3 μm by 3 μm was measured at a total of 12 locations, one location each for each sample of the photosensitive member, with a scanning probe microscope (SPM “JSPM-5200”, manufactured by JEOL Ltd.) to be described later. In the analysis image of the surface profile to which flattening treatment for correcting the primary linear slope of the entire image was applied, the difference between a maximum value Zmax and a minimum value Zmin of a height “z” was defined as the maximum height difference Rz.

The circularity of each of the particles PAA in the surface layer in the electrophotographic photosensitive member of the present invention is preferably 0.950 or more. When the circularity of each of the particles PAA is less than 0.950, the contact area between the toner parent particles and the surface of the surface layer of the electrophotographic photosensitive member is increased. As a result, an increase in non-electrostatic adhesive force is observed, and the transferability of the toner is liable to be deteriorated with long-term use.

The circularity of the particles was determined with a scanning electron microscope as described below. The particles to be subjected to measurement were observed with the scanning electron microscope (“JSM-7800F”, manufactured by JEOL Ltd.), and the respective particle diameters of 100 particles were measured from an image obtained through the observation. Longest side “a” and shortest side “b” of a primary particle were measured for each of the particles, and the ratio “b/a” was adopted as a circularity. The circularities of the 100 particles were averaged to calculate the circularity of the particles.

As the particles in the surface layer of the electrophotographic photosensitive member of the present invention, it is preferred that the surface layer contain at least the particles PAA and the particles PAB as described above. The particles A contribute to the contact with the toner, and hence it is effective to decrease a specific dielectric constant in order to reduce the electrostatic adhesive force. The particles A have a specific dielectric constant F(A) of preferably 5 or less, more preferably 4 or less, still more preferably 3 or less.

Examples of the particles A to be used in the present invention include: organic resin particles such as acrylic resin particles; and inorganic particles such as silica.

The acrylic particles each contain a polymer of an acrylic acid ester or a methacrylic acid ester. Among those, styrene acrylic particles are more preferred. The polymerization degree of an acrylic resin or a styrene acrylic resin, or on whether the resin is thermoplastic or thermosetting is not particularly limited. Examples of the organic resin particles include crosslinked polystyrene, a crosslinked acrylic resin, a phenol resin, a melamine resin, polyethylene, polypropylene, acrylic particles, polytetrafluoroethylene particles, and silicone particles.

Examples of the inorganic particles include silica particles, metal oxide particles, and metal particles. Inorganic particles, which have low elasticity, and are advantageous in terms of the promotion of point contact between the toner and the electrophotographic photosensitive member, are preferably used as the particles in the surface layer of the electrophotographic photosensitive member of the present invention.

When the inorganic particles are used, silica particles out of the particles are preferred. The silica particles are expected to exhibit the following effect because the particles have a lower elastic modulus and a larger average circularity than those of the other insulating particles: the particles promote a point contact between the toner and the electrophotographic photosensitive member to alleviate the adhesive force of the toner.

Known silica fine particles may be used as the silica particles, and fine particles of dry silica and fine particles of wet silica may each be used. Among those, fine particles of wet silica obtained by a sol-gel method (hereinafter also referred to as “sol-gel silica”) are preferred.

The sol-gel silica to be used as the particles in the surface layer of the electrophotographic photosensitive member of the present invention may be hydrophilic, or its surface may be subjected to hydrophobic treatment.

A method for the hydrophobic treatment is, for example, a method including removing a solvent from a silica sol suspension in the sol-gel method to dry the suspension, and then treating the dried product with a hydrophobic treatment agent, or a method including directly adding the hydrophobic treatment agent to the silica sol suspension to dry and treat the suspension simultaneously. Among those, a method including directly adding the hydrophobic treatment agent to the silica sol suspension is preferred from viewpoints of control of the half-width of the particle size distribution of the sol-gel silica and the control of the saturated moisture adsorption amount thereof.

Examples of the hydrophobic treatment agent include the following:
chlorosilanes, such as methyltrichlorosilane, dimethyldichlorosilane, trimethylchlorosilane, phenyltrichlorosilane, diphenyldichlorosilane, t-butyldimethylchlorosilane, and vinyltrichlorosilane;
alkoxysilanes, such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, and 7-(2-aminoethyl)aminopropylmethyldimethoxysilane;
silazanes, such as hexamethyldisilazane, hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane;
silicone oils, such as a dimethyl silicone oil, a methyl hydrogen silicone oil, a methyl phenyl silicone oil, an alkyl-modified silicone oil, a chloroalkyl-modified silicone oil, a chlorophenyl-modified silicone oil, a fatty acid-modified silicone oil, a polyether-modified silicone oil, an alkoxy-modified silicone oil, a carbinol-modified silicone oil, an amino-modified silicone oil, a fluorine-modified silicone oil, and an end reactive silicone oil;
siloxanes, such as hexamethylcyclotrisiloxane, octamethylcyclotetrasiloxane, decamethylcyclopentasiloxane, hexamethyldisiloxane, and octamethyltrisiloxane; and
as fatty acids and metal salts thereof, long-chain fatty acids, such as undecylic acid, lauric acid, tridecylic acid, dodecylic acid, myristic acid, palmitic acid, pentadecylic acid, stearic acid, heptadecylic acid, arachic acid, montanic acid, oleic acid, linoleic acid, and arachidonic acid, and salts of those fatty acids and metals, such as zinc, iron, magnesium, aluminum, calcium, sodium, and lithium.

Among those, alkoxysilanes, silazanes, and silicone oils are each preferably used because the hydrophobic treatment is easily performed. Those hydrophobic treatment agents may be used alone or in combination thereof.

The surface layer in the present invention may contain an additive, such as an antioxidant, a UV absorber, a plasticizer, a leveling agent, a slipperiness-imparting agent, or an abrasion resistance-improving agent. Specific examples of the additive include a hindered phenol compound, a hindered amine compound, a sulfur compound, a phosphorus compound, a benzophenone compound, a siloxane-modified resin, and a silicone oil.

The surface layer of the present invention may be formed by: preparing a coating liquid for a surface layer containing the above-mentioned respective materials and a solvent; forming a coat of the coating liquid; and drying and/or curing the coat. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

In the surface layer of the electrophotographic photosensitive member of the present invention, a ratio of the volume of the particles to a total volume of the surface layer is preferably 40 vol % or more and 90 vol % or less, more preferably 45 vol % or more and 85 vol % or less, still more preferably 50 vol % or more and 80 vol % or less. When a ratio falls within the above-mentioned ranges, a formation of the convex portions in the surface layer as described above can be reliably achieved. When the ratio is 40 vol % or less, the height of each of the convex portions is decreased, and hence the transferability is not improved. When the ratio is 90 vol % or more, the detachment of the particles is accelerated. Thus, when a durability test is performed, the transferability is deteriorated to decrease an image density.

Among the particles in the surface layer of the electrophotographic photosensitive member of the present invention, the particles except the particles A each preferably have a specific dielectric constant F(NA) that is larger than the F(A) by 5 or more. As described above, as the particles A, the particles each having a specific dielectric constant of 5 or less are used. Thus, when only the particles A are used, an electrostatic capacitance of the surface layer is decreased, and the charge amount per unit area is decreased when the electrophotographic photosensitive member is charged in a charging step.

When the specific dielectric constant of the particles except the particles A is increased, the electrostatic capacitance of the surface layer can be increased, and a large charge amount per unit area can be maintained when the electrophotographic photosensitive member is charged in the charging step. Thus, a latent image with higher definition can be formed. As a result, reduction of roughness and the like can be achieved in a halftone image.

In order to increase the specific dielectric constant of the particles except the particles A, electroconductive particles can be used. When the inorganic particles are used as the electroconductive particles, metal oxide particles are desirably used. Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Among those, in particular, titanium oxide, tin oxide, and zinc oxide are more preferably used.

The surface of the metal oxide may be treated with a silane coupling agent or the like, or the metal oxide may be doped with an element, such as phosphorus, aluminum, or niobium, or an oxide thereof. The doping can control the specific dielectric constant of the metal oxide.

Accordingly, in the electrophotographic photosensitive member of the present invention, it is preferred that the particles except the particles PAA in the surface layer be electroconductive particles obtained by treating surfaces of metal oxide particles with a compound containing Si, and in X-ray photoelectron spectroscopic analysis of the surface layer, when a total of a carbon atom concentration d(C), an oxygen atom concentration d(O), a Ti atom concentration d(Ti), and a Si atom concentration d(Si) is defined as 100.0 atomic %, the d(Ti) (atomic %) and the d(Si) (atomic %) satisfy the following formulae (4) to (6).

$$0 < d ( Ti ) \leq 2. \qquad Formula ( 4 )$$

$$d ( Si ) \leq 15. \qquad Formula ( 5 )$$

$$0.01 \leq d ( Ti ) / d ( Si ) \leq 1. \qquad Formula ( 6 )$$

When the d(Ti) is 2.0 atomic % or less, titanium oxide particles in the surface of the surface layer electrophotographic photosensitive member of the electrophotographic photosensitive member are sufficiently present. As a result, the electrostatic capacitance of the surface layer can be increased, and a high charge amount that can be held per unit area can be maintained when the electrophotographic photosensitive member is charged in the charging step. Thus, a latent image with higher definition can be formed, and hence the reduction of roughness, etc. can be achieved in the output of a halftone image.

In addition, it is preferred that the surface of each of the titanium oxide particles in the surface layer of the electrophotographic photosensitive member of the present invention is treated with a silane coupling agent. Depending on the degree of this treatment, the dispersion condition of the titanium oxide particles in the surface layer is changed, and the electrostatic capacitance of the surface layer is changed.

When the d(Si) is 15.0 atomic % or less and the d(Ti)/d(Si) is 0.01 or more and 1.0 or less, a possibility that the surface of each of the titanium oxide particles has been sufficiently treated with a silane coupling agent is high, and the titanium oxide particles in the surface layer of the electrophotographic photosensitive member are dispersed in the surface layer. As a result, the electrostatic capacitance of the surface layer can be increased.

In addition, when the electrophotographic photosensitive member has a drum shape, the unevenness of the dispersion of the titanium dioxide particles in a longitudinal direction of the electrophotographic photosensitive member is suppressed, and hence a large charge amount per unit area can be maintained when the electrophotographic photosensitive member is charged in the charging step. Thus, a latent image with higher definition can be formed. As a result, the reduction of roughness, etc. can be achieved in a halftone image.

Examples of the electroconductive particles in the surface layer include particles of metal oxides, such as titanium oxide, zinc oxide, tin oxide, and indium oxide, and of those, titanium oxide is preferred. In particular, in the case of anatase-type titanium oxide, charge transfer in the protection layer becomes smooth, and charge injection becomes satisfactory. The anatase-type titanium oxide preferably has an anatase formation degree of 90% or more. The metal oxide particles may be doped with atoms, such as niobium, phosphorus, and aluminum, or oxides thereof, and are particularly preferably titanium oxide particles each containing niobium and having a configuration in which niobium is unevenly distributed in a vicinity of a surface of each of the particles. Uneven distribution of niobium in the vicinity of the surface enables efficient transfer of charge.

Examples of the electroconductive particles include particles formed of metal oxides, such as titanium oxide, zinc oxide, tin oxide, and indium oxide, which have metal oxides containing a titanium atom and a niobium atom on surfaces thereof. Specific examples thereof include particles formed of a metal oxide containing a titanium atom doped with a niobium atom or niobium oxide.

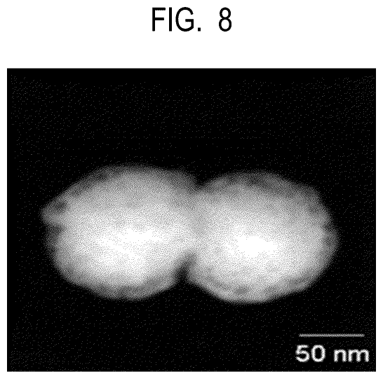

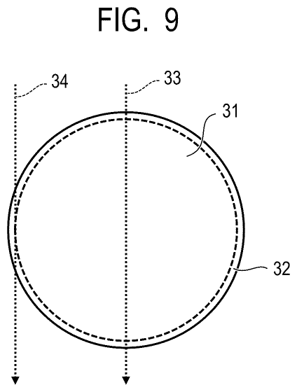

The electroconductive particles are particularly preferably titanium oxide particles each containing a niobium atom and having a configuration in which niobium is unevenly distributed in the vicinity of the surface of the particle. This is because the uneven distribution of the niobium atom in the vicinity of the surface enables efficient transfer of charge. More specifically, in each of the titanium oxide particles, a ratio of a concentration ratio calculated as “niobium atom concentration/titanium atom concentration” at an inside portion at 5% of the maximum diameter of the particle from the surface of the particle to a concentration ratio calculated as “niobium atom concentration/titanium atom concentration” at the center of the particle is 2.0 or more. The niobium atom concentration and the titanium atom concentration are obtained through use of a scanning transmission electron microscope (STEM) having connected thereto an energy-dispersive X-ray spectroscopic analyzer (EDS analyzer). A TEM image of an example (X1) of titanium oxide particles used in Examples of the present invention is shown in FIG. 8. In addition, a view for schematically illustrating the STEM image of FIG. 8 is illustrated in FIG. 9. As described in detail later, niobium-containing titanium oxide particles used in Examples according to the present invention are produced by coating titanium oxide particles with niobium-containing titanium oxide, followed by firing. Accordingly, the coating niobium-containing titanium oxide is conceived to undergo crystal growth as niobium-doped titanium oxide through so-called epitaxial growth along a crystal of the titanium oxide serving as a core. As illustrated in FIG. 9, the thus produced titanium oxide containing niobium has a lower density in the vicinity of the surface than that at a central portion of the particle, and is hence controlled to have a core-shell-like form.

In each of such niobium-containing titanium oxide particles as illustrated in FIG. 9, the niobium/titanium atom concentration ratio in a vicinity 32 of the surface of the particle is higher than the niobium/titanium atom concentration ratio at a central portion 31 of the particle, and the niobium atom is unevenly distributed in the vicinity of the surface of the particle. Specifically, the ratio of the niobium/titanium atom concentration ratio at the inside portion at 5% of the maximum diameter of the particle from the surface of the particle to the niobium/titanium atom concentration ratio at the central portion 31 of the particle (hereinafter also referred to as “ratio between niobium/titanium atom concentration ratios”) is 2.0 or more. In the electrophotographic photosensitive member of the present invention, in each of the electroconductive particles, the ratio of the niobium atom/titanium atom concentration ratio in an inside portion at 5% of the maximum diameter of the electroconductive particle from the surface of the electroconductive particle to the niobium atom/titanium atom concentration ratio in the central portion of the electroconductive particle is preferably 2.0 or more in energy-dispersive X-ray analysis (EDS analysis) connected to a scanning transmission electron microscope (STEM). When the above-mentioned ratio between niobium/titanium atom concentration ratios is set to 2.0 or more, the charge can easily move in the protection layer, and charge injection property can be enhanced. When the ratio between niobium/titanium atom concentration ratios is less than 2.0, charge transfer is not easily performed.

The EDS analysis with the STEM involves observation with a transmission electron microscope and measurement of the niobium/titanium atom concentration ratios by EDS analysis. An electron beam 33 that analyzes the central portion of the particle can measure the niobium/titanium atom concentration ratio at the central portion 31 of the particle. In addition, an electron beam 34 that analyzes an inside portion at 5% of the primary particle diameter of the particle from the surface of the particle can measure the niobium/titanium atom concentration ratio at the inside portion at 5% of the maximum diameter of the particle from the surface of the particle. In addition, the niobium/titanium atom concentration ratios may be directly measured from the electrophotographic photosensitive member through the slicing of the electrophotographic photosensitive member by a method, such as a microtome, Ar milling, or a FIB.

Examples of the electroconductive particles in the surface layer of the present invention include particles of metal oxides, such as titanium oxide, zinc oxide, tin oxide, and indium oxide, and of those, titanium oxide is preferred. In particular, in the case of anatase-type titanium oxide, charge transfer in the surface layer becomes smooth, and charge injection becomes satisfactory. The anatase-type titanium oxide preferably has an anatase formation degree of 90% or more. The metal oxide particles may be doped with atoms, such as niobium, phosphorus, and aluminum, or oxides thereof, and are particularly preferably titanium oxide particles containing niobium and having a configuration in which niobium is unevenly distributed in the vicinity of the surface of each of the particles. The uneven distribution of niobium in the vicinity of the surface enables efficient transfer of charge. Through use of such electroconductive particles, the charge is easily injected from the charging member in contact with the surface of each of the electroconductive particles, and the charge easily moves in the surface layer. Thus, the suppressing effect on a decrease in resistivity of the surface of the electrophotographic photosensitive member can be highly obtained.

When the metal oxide is used as the electroconductive particles, their average primary particle diameter is preferably 20 nm or more and 200 nm or less, more preferably 25 nm or more and 150 nm or less.

The average primary particle diameter D1 of the metal oxide particles was determined with a scanning electron microscope as described below. The particles to be measured were observed with a scanning electron microscope JSM-7800 manufactured by JEOL Ltd. The respective particle diameters of 100 particles were measured from an image obtained through the observation, and an arithmetic average thereof was calculated to provide an average primary particle diameter D1. Each primary particle diameter was determined from (a+b)/2, where “a” and “b” represented the longest side and shortest side of the primary particle, respectively. In needle-shaped metal oxide particles or flake-shaped titanium oxide particles, an average particle diameter was calculated for each of a major axis diameter and a minor axis diameter to determine an average primary particle diameter.

When the specific dielectric constant of each of the particles A and the particles except the particles A is controlled, and the surface treatment of the particles is performed as described above, the surface charge amount in the surface layer of the electrophotographic photosensitive member in charging can be sufficiently maintained while the transferability is maintained.

In addition, a charge-transporting substance may be added to a coating liquid for a surface layer for the purpose of improving the charge-transporting ability of the surface layer. In addition, additives may be added for the purpose of improving the various functions of the layer. Examples of the additives include an antioxidant, a UV absorber, a plasticizer, and a leveling agent.

The binder resin according to the present invention comes in the following forms. In this case, the surface layer preferably contains the charge-transporting substance.

Examples of the binder resin include a polyester resin, an acrylic resin, a phenoxy resin, a polycarbonate resin, a polystyrene resin, a phenol resin, a melamine resin, and an epoxy resin. Among those, a polycarbonate resin, a polyester resin, and an acrylic resin are preferred. In addition, the surface layer of the present invention may be formed as a cured film by polymerizing a composition containing a monomer having a polymerizable functional group. A reaction in this case is, for example, a thermal polymerization reaction, a photopolymerization reaction, or a radiation polymerization reaction. Examples of the polymerizable functional group of the monomer having a polymerizable functional group include an acrylic group and a methacrylic group. A material having a charge-transporting ability may be used as the monomer having a polymerizable functional group.

The compound having a polymerizable functional group may have a charge-transportable structure as well as a chain-polymerizable functional group. A triarylamine structure is preferred as the charge-transportable structure from the viewpoint of charge transportation. An acryloyl group or a methacryloyl group is preferred as the chain-polymerizable functional group. The compound may have one or a plurality of functional groups. In particular, it is preferred that a cured film containing a compound having a plurality of functional groups and a compound having one functional group be formed because strain caused by polymerization between the plurality of functional groups is easily eliminated.

Examples of the above-mentioned compound having one functional group are represented by the formulae (2-1) to the formulae (2-6).

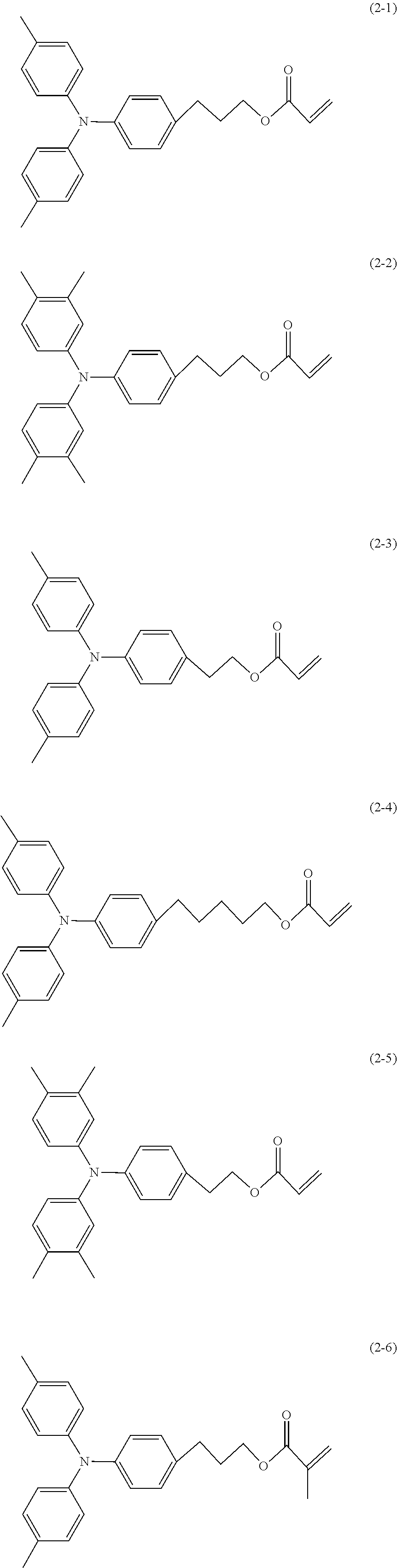

Examples of the above-mentioned compound having a plurality of functional groups are represented by the formulae (3-1) to the formulae (3-5).

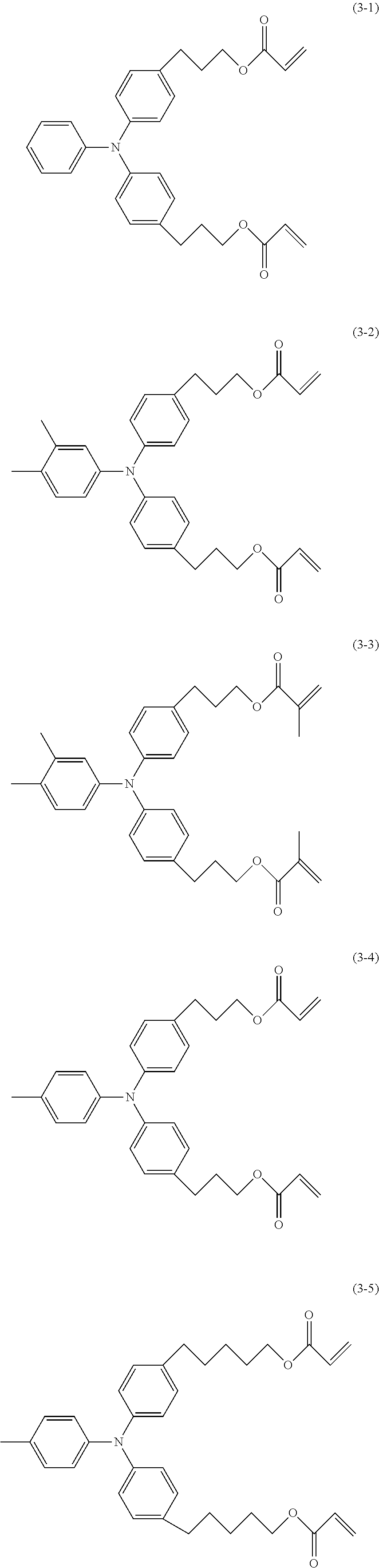

### <Support>

In the present invention, the electrophotographic photosensitive member preferably includes a support. In the present invention, the support is preferably an electroconductive support having electroconductivity. In addition, examples of the shape of the support include a cylindrical shape, a belt shape, and a sheet shape. A support having a cylindrical shape out of those shapes is preferred. In addition, the surface of the support may be subjected to, for example, electrochemical treatment such as anodization, blast treatment, or cutting treatment.

A metal, a resin, glass, etc. is preferred as a material for the support. Examples of the metal include aluminum, iron, nickel, copper, gold, stainless steel, and alloys thereof. An aluminum support using aluminum out of those metals is preferred.

In addition, electroconductivity may be imparted to the resin or the glass through treatment including, for example, mixing or covering the resin or the glass with an electroconductive material.

### <Electroconductive Layer>

In the present invention, an electroconductive layer may be arranged on the support. The arrangement of the electroconductive layer can conceal flaws and unevenness in the surface of the support, and control the reflection of light on the surface of the support. The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Among those, the metal oxide is preferably used as the electroconductive particles, and in particular, titanium oxide, tin oxide, and zinc oxide are more preferably used.

When the metal oxide is used as the electroconductive particles, the surface of the metal oxide may be treated with a silane coupling agent, etc., or the metal oxide may be doped with an element, such as phosphorus or aluminum, or an oxide thereof.

In addition, the electroconductive particles may have a laminated configuration in which particles before being covered, such as titanium oxide, barium sulfate, or zinc oxide, are covered with a metal oxide having composition different from that of the particles before being covered. An example of the covering is a metal oxide such as tin oxide.

In addition, when the metal oxide is used as the electroconductive particles, their average primary particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a silicone oil, resin particles, or a concealing agent such as titanium oxide.

The electroconductive layer has an average thickness of preferably 1 μm or more and 50 μm or less, particularly preferably 3 μm or more and 40 μm or less.

The electroconductive layer may be formed by: preparing a coating liquid for an electroconductive layer containing the above-mentioned respective materials and a solvent; forming a coat of the coating liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method including using a paint shaker, a sand mill, a ball mill, or a liquid collision-type high-speed disperser.

### <Undercoat Layer>

In the present invention, an undercoat layer may be arranged on the support or the electroconductive layer.

The undercoat layer has an average thickness of preferably 0.1 μm or more and 50 μm or less, more preferably 0.2 μm or more and 40 μm or less, particularly preferably 0.3 μm or more and 30 μm or less.

A resin for the undercoat layer is, for example, a polyacrylic acid resin, a polyvinyl alcohol resin, a polyvinyl acetal resin, a polyethylene oxide resin, a polypropylene oxide resin, an ethyl cellulose resin, a methyl cellulose resin, a polyamide resin, a polyamic acid resin, a polyurethane resin, a polyimide resin, a polyamideimide resin, a polyvinylphenol resin, a melamine resin, a phenol resin, an epoxy resin, and an alkyd resin.

In addition, a resin having a structure in which a resin having a polymerizable functional group and a monomer having a polymerizable functional group are crosslinked with each other is also permitted.

In addition, the undercoat layer may contain an inorganic compound or an organic compound in addition to the resin.

Examples of the inorganic compound include a metal, an oxide, and a salt.

Examples of the metal include gold, silver, and aluminum. Examples of the oxide include zinc oxide, white lead, aluminum oxide, indium oxide, silicon oxide, zirconium oxide, tin oxide, titanium oxide, magnesium oxide, antimony oxide, bismuth oxide, indium oxide, tin oxide, and zirconium oxide. Examples of the salt include barium sulfate and strontium titanate.

Those inorganic compounds may each be present as a particle in a film serving as the undercoat layer.

The number-average particle diameter of the particles of the inorganic compound is preferably 1 nm or more and 500 nm or less, more preferably 3 nm or more and 400 nm or less.

Those inorganic compounds may each have a laminated configuration including a core particle and a covering layer covering the particle.

The surfaces of those inorganic compounds may each be treated with, for example, a silicone oil, a silane compound, a silane coupling agent, or any other organosilicon compound, or an organotitanium compound. In addition, those inorganic compounds may each be doped with an element, such as tin, phosphorus, aluminum, or niobium.

Examples of the organic compound include an electron-transporting substance and an electroconductive polymer.

Examples of the electroconductive polymer include polythiophene, polyaniline, polyacetylene, polyphenylene, and polyethylenedioxythiophene.

Examples of the electron-transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound.

The electron-transporting material may have a polymerizable functional group and may be crosslinked with a resin having a functional group reactive with the functional group. Examples of the polymerizable functional group include a hydroxy group, a thiol group, an amino group, a carboxyl group, a vinyl group, an acryloyl group, a methacryloyl group, and an epoxy group.

Those organic compounds may each be present as a particle in the film, or their surfaces may be treated.

Various additives including a leveling agent such as a silicone oil, a plasticizer, and a thickener may be added to the undercoat layer.

The undercoat layer is obtained by: preparing a coating liquid for an undercoat layer containing the above-mentioned materials; then applying the coating liquid onto the support or the electroconductive layer; and then drying or curing the coat.

A solvent in producing the coating liquid is, for example, an alcohol-based solvent, a ketone-based solvent, an ether-based solvent, an ester-based solvent, or an aromatic hydrocarbon-based solvent.

A dispersion method for dispersing the particles of the materials in the coating liquid is, for example, a method including using a paint shaker, a sand mill, a ball mill, or a liquid collision-type high-speed disperser.

### <Photosensitive Layer>

The photosensitive layers of the electrophotographic photosensitive member are mainly classified into (1) a laminate-type photosensitive layer and (2) a monolayer-type photosensitive layer. (1) The laminate-type photosensitive layer is a photosensitive layer having a charge-generating layer containing a charge-generating material and a charge-transporting layer containing a charge-transporting material. (2) The monolayer-type photosensitive layer is a photosensitive layer containing both a charge-generating material and a charge-transporting material.

### (1) Laminate-Type Photosensitive Layer

The laminate-type photosensitive layer has the charge-generating layer and the charge-transporting layer.

### (1-1) Charge-Generating Layer

The charge-generating layer preferably contains the charge-generating material and a resin.

Examples of the charge-generating material include azo pigments, perylene pigments, polycyclic quinone pigments, indigo pigments, and phthalocyanine pigments. Among those, azo pigments and phthalocyanine pigments are preferred. Among the phthalocyanine pigments, an oxytitanium phthalocyanine pigment, a chlorogallium phthalocyanine pigment, and a hydroxygallium phthalocyanine pigment are preferred.

A content of the charge-generating material in the charge-generating layer is preferably 40 mass % or more and 85 mass % or less, more preferably 60 mass % or more and 80 mass % or less with respect to a total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Among those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer may be formed by: preparing a coating liquid for a charge-generating layer containing the above-mentioned respective materials and a solvent; forming a coat of the coating liquid on the undercoat layer; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

The charge-generating layer has a thickness of preferably 0.1 μm or more and 1.5 μm or less, more preferably 0.15 μm or more and 1.0 μm or less.

### (1-2) Charge-Transporting Layer

The charge-transporting layer preferably contains the charge-transporting material and a resin.

Examples of the charge-transporting material include a polycyclic aromatic compound, a heterocyclic compound, a hydrazone compound, a styryl compound, an enamine compound, a benzidine compound, a triarylamine compound, and a resin having a group derived from each of those materials. Of those, a triarylamine compound and a benzidine compound are preferred.

A content of the charge-transporting material in the charge-transporting layer is preferably 25 mass % or more and 70 mass % or less, more preferably 30 mass % or more and 55 mass % or less with respect to a total mass of the charge-transporting layer.

Examples of the resin include a polyester resin, a polycarbonate resin, an acrylic resin, and a polystyrene resin. Among those, a polycarbonate resin and a polyester resin are preferred. A polyarylate resin is particularly preferred as the polyester resin.

A content ratio (mass ratio) between the charge-transporting material and the resin is preferably from 4:10 to 20:10, more preferably from 5:10 to 12:10.

In addition, the charge-transporting layer may contain an additive, such as an antioxidant, a UV absorber, a plasticizer, a leveling agent, a slipperiness-imparting agent, or an abrasion resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The charge-transporting layer may be formed by: preparing a coating liquid for a charge-transporting layer containing the above-mentioned respective materials and a solvent; forming a coat of the coating liquid on the charge-generating layer; and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

The charge-transporting layer has a thickness of 3 μm or more and 50 μm or less, more preferably 5 μm or more and 40 μm or less, particularly preferably 10 μm or more and 30 μm or less.

### (2) Monolayer-Type Photosensitive Layer

The monolayer-type photosensitive layer may be formed by: preparing a coating liquid for a photosensitive layer containing the charge-generating material, the charge-transporting material, a resin, and a solvent; forming a coat of the coating liquid on the undercoat layer; and drying the coat. Examples of the charge-generating material, the charge-transporting material, and the resin are same as those of the materials in the section “(1) Laminate-type Photosensitive Layer.”

The monolayer-type photosensitive layer has a thickness of preferably 10 μm or more and 45 μm or less, more preferably 25 μm or more and 35 μm or less.

### [Process Cartridge and Electrophotographic Apparatus]

A process cartridge of the present invention may integrally support the above-mentioned electrophotographic photosensitive member, and at least one means selected from the group consisting of: charging means; developing means; and cleaning means. The process cartridge is characterized by being detachably attachable onto the main body of an electrophotographic apparatus.

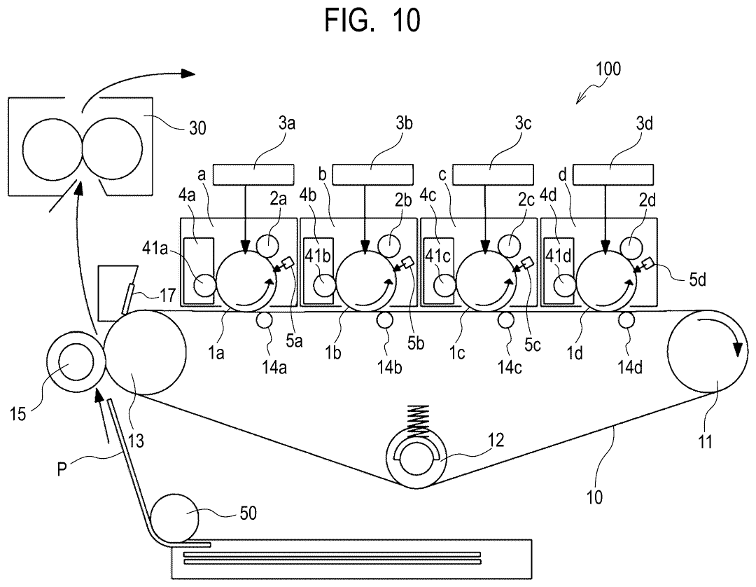

An example of the schematic configuration of an electrophotographic apparatus including a process cartridge including the electrophotographic photosensitive member of the present invention is illustrated in FIG. 10.

### [Configuration of Electrophotographic Apparatus]

An electrophotographic apparatus of the present invention may include: the above-mentioned electrophotographic photosensitive member; and charging means, exposing means, developing means, and transfer means.

An electrophotographic apparatus of this embodiment is a so-called tandem-type electrophotographic apparatus including a plurality of image forming portions “a” to “d”. A first image forming portion “a” forms an image with a toner of yellow (Y). A second image forming portion “b” forms an image with a toner of magenta (M). A third image forming portion “c” forms an image with a toner of cyan (C). A fourth image forming portion “d” forms an image with a toner of black (Bk). Those four image forming portions are arranged in a row at constant intervals, and the configurations of the respective image forming portions are substantially same in many respects except the color of a toner to be stored. Thus, the electrophotographic apparatus of this embodiment is described below through use of the first image forming portion “a”.

The first image forming portion “a” includes a photosensitive drum 1a that is a drum-shaped electrophotographic photosensitive member, a charging roller 2a that is a charging member, developing means 4a, and electricity-removing means 5a.

The photosensitive drum 1a is an image-bearing member that bears a toner image, and is rotationally driven in a direction indicated by the arrow illustrated in the figure at a predetermined peripheral speed (process speed). The developing means 4a stores a yellow toner and develops the yellow toner on the photosensitive drum 1a with a developing roller 41a.

An image forming operation is started when control means (not shown) such as a controller receives an image signal, and the photosensitive drum 1a is rotationally driven. During the rotation process, the photosensitive drum 1a is uniformly charged to a predetermined voltage (charging voltage) with a predetermined polarity (negative polarity in this embodiment) by the charging roller 2a, and is exposed to light by exposing means 3a in accordance with the image signal. Thus, an electrostatic latent image corresponding to a yellow color component image of a target color image is formed on the photosensitive drum 1a. Then, the electrostatic latent image is developed by the developing means 4a at a developing position and visualized as a yellow toner image on the photosensitive drum 1a. Here, the normal charging polarity of the toner stored in the developing means 4a is a negative polarity, and the electrostatic latent image is subjected to reversal development with the toner charged to the same polarity as the charging polarity of the photosensitive drum 1a by the charging roller 2a. However, the present invention is not limited thereto, and the present invention may be applied also to an electrophotographic apparatus in which an electrostatic latent image is subjected to normal development with a toner charged to a polarity opposite to the charging polarity of the photosensitive drum 1a. In addition, many convex portions derived from particles may be arranged on the surface layer of the charging roller 2a. The convex portions arranged on the surface layer of the charging roller 2a each have a role as a spacer between the charging roller 2a and the photosensitive drum 1a in a charging portion. The role is as follows: when transfer residual toner, which is toner remaining on the photosensitive drum 1a without being transferred in a primary transfer portion to be described later, enters the charging portion, the contamination of the charging roller 2a with the transfer residual toner due to the contact of sites except the convex portions with the transfer residual toner is suppressed.

A pre-exposing unit 5a serving as electricity-removing means exposes the surface of the photosensitive drum 1a before the charging of the surface of the photosensitive drum 1a by the charging roller 2a to light to remove electricity therefrom. The unit removes the electricity from a surface of the photosensitive drum 1a to play a role of leveling a surface potential formed on the photosensitive drum 1 and a role of controlling quantity of electricity discharged by discharge occurring in the charging portion.

An endless and movable intermediate transfer belt 10 has electroconductivity, is brought into contact with the photosensitive drum 1a to form a primary transfer portion, and is rotated at substantially the same peripheral speed as that of the photosensitive drum 1a. In addition, the intermediate transfer belt 10 is tensioned by a counter roller 13 serving as a counter member, a drive roller 11 and a tension roller 12 each serving as a tension member, and a metal roller 14a, and is tensioned by the tension roller 12 under a tension of a total pressure of 60 N. The intermediate transfer belt 10 can be moved when the drive roller 11 is rotationally driven in a direction indicated by the arrow illustrated in the figure.

The yellow toner image formed on the photosensitive drum 1a is primarily transferred from the photosensitive drum 1a to the intermediate transfer belt 10 in the process of passing through the primary transfer portion.

The second, third, and fourth image forming portions in FIG. 2 include photosensitive drums 1b, 1c, and id, charging rollers 2b, 2c, and 2d, exposing means 3b, 3c, and 3d, developing means 4b, 4c, and 4d, electricity-removing means 5b, 5c, and 5d, metal rollers 14b, 14c, and 14d, and developing rollers 41b, 41c, and 41d, respectively.

Subsequently, a magenta toner image of the second color, a cyan toner image of the third color, and a black toner image of the fourth color are formed in a same manner, and are sequentially transferred onto the intermediate transfer belt 10 so as to be superimposed on one another. Thus, toner images of four colors corresponding to target color images are formed on the intermediate transfer belt 10. After that, the toner images of the four colors borne on the intermediate transfer belt 10 are secondarily transferred in a batch onto the surface of a transfer material P, such as paper or an OHP sheet, fed by sheet feeding means 50 in the process of passing through a secondary transfer portion formed by the contact between a secondary transfer roller 15 and the intermediate transfer belt 10. The transfer material P having the toner images of the four colors transferred thereto by the secondary transfer is then heated and pressurized in fixing means 30, and the toners of the four colors are melted and mixed to be fixed onto the transfer material P. The toner remaining on the intermediate transfer belt 10 after the secondary transfer is cleaned and removed by belt-cleaning means 17 arranged so as to face the counter roller 13 through intermediation of the intermediate transfer belt 10.

The electrophotographic photosensitive member of the present invention may be used in, for example, a laser beam printer, an LED printer, or a copying machine.

### EXAMPLES

Methods of measuring the respective physical properties of an electrophotographic photosensitive member and electroconductive particles according to the present invention are described below. The present invention is by no means limited by the following Examples without departing from the gist of the present invention. In the following Examples, the term “part(s)” is by mass unless otherwise specified.

### [Measurement of Physical Properties of Electrophotographic Photosensitive Member]

### <Method of Measuring Number-Based Average Primary Particle Diameter of Particles of the Present Invention>

A number-average particle diameter is measured with Zetasizer Nano-ZS (manufactured by Malvern Panalytical Ltd.). The device can measure a particle diameter by a dynamic light scattering method. First, a sample to be measured is prepared by dilution so as to have a solid-liquid ratio of 0.10 mass %(±0.02 mass %), collected in a quartz cell, and placed in a measurement portion. As a dispersion medium, water or a mixed solvent of methyl ethyl ketone and methanol is used when the sample is inorganic fine particles, and water is used when the sample is resin particles or an external additive for toner. As measurement conditions, the measurement is performed by inputting the refractive index of the sample, and the refractive index, viscosity, and temperature of a dispersion solvent in control software Zetasizer Software 6.30. Dn is adopted as a number-based average primary particle diameter.

The refractive index of particles is adopted from “Refractive indices of solids” described on page 517 of Vol. II of Handbook of Chemistry: Fundamentals, Revised 4th ed. (edited by The Chemical Society of Japan, Maruzen Co., Ltd.). As the refractive index of the resin particles, the refractive index of a resin used for the resin particles, which is incorporated into the control software, is adopted. However, when refractive index is not incorporated, a value described in Polymer Database of National Institute for Materials Science is used. The refractive index of the external additive for toner is calculated by taking a weight average from the refractive index of the inorganic fine particles and the refractive index of the resin used for the resin particles. As the refractive index, viscosity, and temperature of the dispersion solvent, numerical values incorporated into the control software are selected. In a case of a mixed solvent, the weight average of the dispersion mediums to be mixed is taken.

### <Method of Measuring Maximum Height Difference Rz on Surface of Surface Layer of Electrophotographic Photosensitive Member>

Surface observation of each of electrophotographic photosensitive members produced in Examples was performed. As a sample subjected to the surface observation, the electrophotographic photosensitive member was divided into four equal sections in a longitudinal direction thereof, and sample pieces measuring 5 mm by 5 mm were cut out from the electrophotographic photosensitive member at intervals of 1200 in a peripheral direction thereof at each of positions corresponding to ¼, ½, and ¾ of a length from an end portion. Each of the sample pieces was fixed to a sample holder so that the surface layer of the electrophotographic photosensitive member was able to be observed. For each of the sample pieces fixed to the sample holder, the surface profile measuring 3 μm by 3 μm on the surface of the surface layer of the electrophotographic photosensitive member was measured at one point of each of the samples with a scanning probe microscope SPM. This measurement was performed in each of the nine sample pieces, and an average value of the maximum height differences Rz at the nine locations was defined as the maximum height difference Rz of the electrophotographic photosensitive member of the present invention.

As the SPM, a scanning probe microscope “JSPM-5200” (manufactured by JEOL Ltd.), a scanning probe microscope “E-sweep” (manufactured by Hitachi High-Tech Corporation), or a medium-sized probe microscope system AFM5500M (manufactured by Hitachi High-Tech Corporation) may be used.

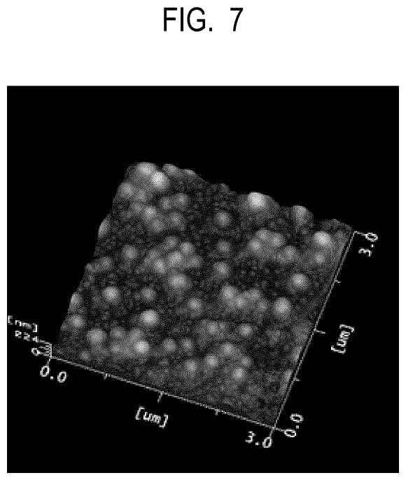

A measurement method including using the scanning probe microscope “JSPM-5200” (manufactured by JEOL Ltd.) is as described below. A scanning operation was performed through WinSPM Scanning, and a data analysis image of a surface profile was output. The maximum height difference Rz on the surface of the surface layer of the electrophotographic photosensitive member of the present invention was measured under observation conditions of the “JSPM-5200” as described below. An example of results of the SPM observation is shown in FIG. 7. FIG. 7 shows the surface profile.

After the measurement, the measurement position of the sample was marked, and the measurement of “Particle Size Distribution of Particles in Surface Layer of Electrophotographic Photosensitive Member and Calculation of Height of each of Convex Portions” to be described later was performed on each of samples.

Observation Conditions of “JSPM-5200”
Scanner: 4
SPM Scan: All SPM Mode
Cantilever: SI-DF3P2 (manufactured by Hitachi High-Tech Fielding Corporation)
Resonance Frequency Detection:
(START) 1.00 kHz
(Stop) 100 kHz (when f=67 kHz, depending on the kind of a cantilever)
   Cantilever Autotune: Normal approach
   Aquisition: 2 Inputs (512)
   Scan Mode: Normal
   STM/AFM: AC-AFM
   Clock: 833.33 s
   Scan Size: 3,000 nm
   Offset: 0
   Bias [V]: 0
   Reference/V: unchanged (calibration value has been input)
   Filter: 1.4 Hz
   Loop gain: 16

An image of the surface profile and a surface height data included in the image were analyzed through WinSPM Scanning to determine the difference between a maximum value Zmax and a minimum value Zmin of a height “z” as a maximum height difference Rz in the image subjected to flattening treatment.

In addition, a measurement method including using the scanning probe microscope “E-sweep” (manufactured by Hitachi High-Tech Corporation) is as described below. The measurement is performed through a scanning operation, and a data analysis image of the surface profile of the electrophotographic photosensitive member can be output.

### Observation Conditions of “E-Sweep”

Cantilever: SI-DF20 (with AL on a back surface) K-A102002771 (manufactured by Hitachi High-Tech Fielding Corporation)
Scanning probe microscope: Hitachi High-Tech Science Corporation
Measurement unit: E-sweep
Measurement mode: DFM (resonance mode) shape image
Resolution: X data number of 512, Y data number of 512
Measurement frequency: 127 Hz

A Q-curve measurement magnification, an excitation voltage, a low-pass filter, a high-pass filter, etc. are adjusted so as to optimize the resonance state of a cantilever.

The difference between the maximum value Zmax and the minimum value Zmin of the height “z” can be determined as the maximum height difference (maximum height) Rz based on JIS B0601:2001 in the image subjected to flattening treatment by analyzing the image of the surface profile and the surface height data included in the image through use of an accompanying software.

<Observation of Lamination State of Particles in Surface Layer of Electrophotographic Photosensitive Member, Ratio of Volume of Particles to Total Volume of Surface Layer, Particle Size Distribution of Particles, and Calculation of Height of Each of Convex Portions CA>

The ratio of the volume of the particles to the total volume of the surface layer was calculated from the addition amounts, densities, and true specific gravities of the monomer having a polymerizable functional group and the particles to be used in the coating liquid for a surface layer. For the specific gravities of a polymerization product obtained after the polymerization of the monomer having a polymerizable functional group, and the particles, reference may be made to values published in manufacturers of respective materials and a database “POLYINFO” of National Institute for Materials Science.

In addition, when the ratio is determined from the electrophotographic photosensitive member, for example, the following method is available. Sectional observation of each of the electrophotographic photosensitive members produced in Examples was performed. It was determined whether the particles were laminated in a single layer in the surface layer as in FIG. 1 or FIG. 5, or the particles were laminated in a plurality of layers as in FIG. 2 or FIG. 6. Samples subjected to the sectional observation were collected from positions determined as follows: positions corresponding to ¼, ½, and ¾ of the length of the electrophotographic photosensitive member from an end portion thereof when the electrophotographic photosensitive member was divided into four equal sections in its longitudinal direction were selected, and were shifted from each other by 120° in the peripheral direction thereof 5-Millimeter square sample pieces were cut out of each of the electrophotographic photosensitive members, and their surface layers were each reconstructed into a three-dimensional object measuring 2 μm by 2 μm by 2 μm with the Slice & View function of a FIB-SEM.

Conditions for the Slice & View function were set as described below.
Processing of sample for analysis: FIB method
Processing and observation device: NVision 40 manufactured by SII/Zeiss
Slice interval: 10 nm

### (Observation Conditions)

Acceleration voltage: 1.0 kV
Sample tilt: 540
WD: 5 mm
Detector: BSE detector
Aperture: 60 μm, high current
ABC: ON
Image resolution: 1.25 nm/pixel

In addition, a measurement environment has a temperature of 23° C. and a pressure of 1×10⁻⁴ Pa. Strata 400S manufactured by FEI (sample tilt: 52°) may also be used as the processing and observation device.

The analysis is performed in a region measuring 2 μm long by 2 μm wide, and pieces of information on the respective sections are integrated to determine a volume V per unit volume measuring 2 μm long by 2 μm wide by 2 μm thick (8 μm³) in a surface of the surface layer. In addition, the images of the respective sections were analyzed with image processing software “Image-Pro Plus” manufactured by Media Cybernetics, Inc.

A content of the particles in the total volume of the surface layer was calculated from a difference in contrast between the layer and the particles obtained by the Slice & View function of a FIB-SEM. In addition, the volume V of the particles of the present invention in a volume measuring 2 μm by 2 μm by 2 μm (unit volume: 8 μm³) was determined in each of the four sample pieces based on an information obtained from an image analysis, and the content [vol %](=V μm³/8 μm³×100) of the particles was calculated. An average of values of the contents of the particles in respective sample pieces was adopted as the content [vol %] of the respective particles of the present invention in the surface layer with respect to a total volume of the surface layer. A composition of the particles was determined by using the SEM-EDX function of the SEM.

From results of the FIB-SEM, presence of a plurality of peaks is checked in a particle size distribution A in which a particle diameter of each of the particles in the surface of the surface layer is plotted on the horizontal axis and the number-based frequency in each of the particle diameters is plotted on the vertical axis.

In the particle distribution A, among peaks each having a peak top at 20 nm or more among a plurality of peaks, the peak having the highest frequency at the peak top is defined as a first peak. Next, in the particle distribution A, among the peaks each having a peak top at 20 nm or more among the plurality of peaks, the peak having a second highest frequency at a peak top after the first peak is defined as a second peak. Further, when the first peak and the second peak are compared to each other, the peak having a larger value of a particle diameter at the peak top was defined as a peak PEA.

Then, the particle diameter at the peak top of the peak PEA in the particle size distribution A is represented by DA. Among all the particles in the surface layer, the particles each having a particle diameter in a range of DA±20 nm are defined as particles PAA. When convex portions, which are derived from the particles PAA, and which each have a height of 10 nm or more and 300 nm or less, are defined as convex portions CA, a height L of each of the convex portions CA is illustrated in FIG. 5 and FIG. 6. As illustrated in FIG. 5 and FIG. 6, a height of each of the convex portions CA measured from the surface which is free of the particles PAA was defined as the height L of each of the convex portions CA. When particles having different compositions were present, these particles were discriminated by a mapping image using EDS. Further, the convex portions were measured at 100 points, and a ratio of the convex portions CA derived from the particles PAA to all the convex portions was calculated. In addition, regarding the height L, an average value LV was calculated.

Next, in a particle size distribution A, the peak having a highest frequency at the peak top is defined as a first peak, and the peak having the second highest frequency at the peak top after the first peak is defined as a second peak. When the first peak and the second peak are compared to each other, the peak having a smaller value of a particle diameter at the peak top is defined as a peak PEB. A particle diameter DB at a peak top of a peak PEB is calculated.

In addition, in a sectional image of the surface layer, an average value of a thicknesses of the surface layer in sites that are free of the particles PAA was defined as an average thickness T as illustrated in FIG. 5 and FIG. 6.

### <Method of Measuring Average Value and Standard Deviation of Distances Between Gravity Centers of Particles on Surface of Surface Layer of Electrophotographic Photosensitive Member>

In the electrophotographic photosensitive member of the present invention, when the surface layer is viewed from above, a calculation of the average value and standard deviation of the distances between gravity centers of a convex portions CA derived from particles PAA may be performed as described below.

The surface of the surface layer of the electrophotographic photosensitive member was photographed with a scanning electron microscope (SEM) (“S-4800”, manufactured by JEOL Ltd.) at an acceleration voltage of 10 kV. Photographic images at a magnification of 30,000 of the surface layer of the electrophotographic photosensitive member of the present invention were captured with a scanner at a total of 12 locations: three locations including positions of 50 mm from the respective end portions of the electrophotographic photosensitive member in a longitudinal direction and a center position; and four locations at intervals of 90° in a peripheral direction. The particles PAA in the electrophotographic images were subjected to binarization processing with an image processing analysis device (“LUZEX AP”, manufactured by NIRECO CORPORATION).

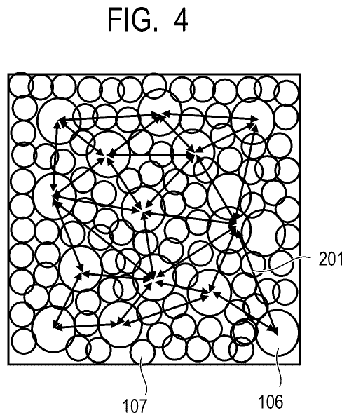

In a mode of distances between adjacent gravity centers of the particles PAA, the distances between gravity centers of the particles PAA adjacent to each other are measured as illustrated in FIG. 4, and an average value of the distances between gravity centers is calculated. In this case, the distances between gravity centers are calculated from each gravity center of the particles PAA by Voronoi division. The distances between gravity centers and a standard deviation were calculated in a total of 10 fields of view, and a resultant average value and standard deviation of the distances between gravity centers were defined as an average value and a standard deviation of the distances between gravity centers of the particles in the surface layer of the electrophotographic photosensitive member, respectively.

### <Method of Measuring Coverage Ratio S1/(S1+S2) of Particles on Surface of Surface Layer of Electrophotographic Photosensitive Member>

In the electrophotographic photosensitive member of the present invention, in a case where the surface layer is viewed from above, when the particles are defined as, for example, particles A, particles B, and other particles as shown in Table 4-1, Table 4-2, Table 4-3, and Table 4-4, and an area of the particles is represented by S1 and a total of areas of portions except the particles is represented by S2, a calculation of a coverage ratio S1/(S1+S2) may be performed as described below. In the present invention, the surface of the surface layer of the electrophotographic photosensitive member of the present invention is observed from above with a scanning electron microscope (SEM) under setting of an acceleration voltage of 5 kV or more. An area in which an image of particles is recognized in a backscattered electron image of the surface layer is added to the area S1 occupied by the particles.

The surface of the surface layer of the electrophotographic photosensitive member was photographed with a scanning electron microscope (SEM) (“S-4800”, manufactured by JEOL Ltd.) at an acceleration voltage of 5 kV. Photographic images at a magnification of 30,000 of the surface layer of the electrophotographic photosensitive member of the present invention were captured with a scanner at a total of 12 locations: three locations including positions of 50 mm from respective end portions of the electrophotographic photosensitive member in a longitudinal direction and a center position; and four locations at intervals of 90° in a peripheral direction. The particles in the electrophotographic images were subjected to binarization processing with an image processing analysis device (“LUZEX AP”, manufactured by NIRECO CORPORATION).

The area of the particles in the photographic image is represented by S1, and a total of areas of portions except the particles is represented by S2. Then, the coverage ratio S1/(S1+S2) (%) is calculated. The coverage ratio was calculated in a total of 10 fields of view, and an average value of resultant coverage ratios was defined as a coverage ratio of the particles in the surface layer of the electrophotographic photosensitive member.

### <Method of Measuring Circularity of Particles PAA of Particles on Surface of Surface Layer of Electrophotographic Photosensitive Member>

The surface of the surface layer of the electrophotographic photosensitive member was photographed with a scanning electron microscope (SEM) (“S-4800”, manufactured by JEOL Ltd.) at an acceleration voltage of 10 kV. Photographic images at a magnification of 30,000 of the surface layer of the electrophotographic photosensitive member were captured with a scanner at a total of 12 locations: three locations including positions of 50 mm from respective end portions of the electrophotographic photosensitive member in a longitudinal direction and a center position; and four locations at intervals of 90° in a peripheral direction. Further, the particles PAA of the photographic image are subjected to image processing with an image processing analysis device (“LUZEX AP”, manufactured by NIRECO CORPORATION), and an average value of circularities is calculated in a total of 10 fields of view to be defined as a circularity of the particles PAA.

### <Measurement of Thickness of Each Layer>

A thicknesses of the respective layers of each of the electrophotographic photosensitive members of Examples and Comparative Examples except a surface layer and a charge-generating layer were determined by a method including using an eddy current-type thickness meter (Fischerscope, manufactured by Fischer Instruments K.K.), or a method including converting a mass of the layer per unit area into a specific gravity. A thickness of the charge-generating layer was measured by converting a Macbeth density value of the electrophotographic photosensitive member with a calibration curve obtained in advance from: a Macbeth density value measured by pressing a spectral densitometer (product name: X-Rite 504/508, manufactured by X-Rite, Inc.) against the surface of the electrophotographic photosensitive member; and a value of the thickness of the layer measured through an observation of a sectional SEM image thereof.

### <Measurement of Relative Concentration of Each Atom on Surface of Surface Layer>

X-ray photoelectron spectroscopic analysis on the surface of the surface layer may be specifically performed as described below.

First, five sections each measuring 5 mm by 5 mm were cut out from positions that are randomly selected from the surface of the electrophotographic photosensitive member to prepare five sample pieces for observation. Subsequently, X-ray photoelectron spectroscopic (XPS) analysis is performed on the surface layer of each of the sample pieces for observation. An apparatus and measurement conditions for the XPS are as described below.
Apparatus used: Quantum 2000 manufactured by ULVAC-PHI, Inc.
Analysis method: narrow analysis
X-ray source: Al-Kα
X-ray conditions: 100 μm, 25 W, 15 kV
Photoelectron acceptance angle: 45°
Pass Energy: 58.70 eV
Measurement range: φ100 μm

Measurement is performed under the above-mentioned conditions, and a peak derived from a C—C bond of carbon 1s orbitals is corrected to 285 eV After that, a relative sensitivity factor provided by ULVAC-PHI, Inc. is applied to a peak area of an atom having a peak top detected at from 100 eV to 103 eV Results obtained from five sample pieces for observation are averaged, and integration and conversion are performed on each spectrum peak of a carbon atom, an oxygen atom, a titanium atom, and a silicon atom. When a total of a relative concentration d(C) of a carbon atom, a relative concentration d(O) of an oxygen atom, a relative concentration d(Ti) of a titanium atom, and a relative concentration d(Si) of a silicon atom is defined as 100.0 atomic %, the relative concentration d(C) of a carbon atom, the relative concentration d(O) of an oxygen atom, the relative concentration d(Ti) of a titanium atom, and the relative concentration d(Si) of a silicon atom are determined. Atom concentration ratios d(Ti) (atomic %), d(Si) (atomic %), and d(Ti)/d(Si) in a metal oxide were calculated.

### <Calculation of Niobium Atom/Titanium Atom Concentration Ratio in Electroconductive Particles in Surface Layer of Electrophotographic Photosensitive Member>

One 5-millimeter square sample piece was cut out of the electrophotographic photosensitive member, and was cut to a thickness of 200 nm with an ultrasonic ultramicrotome (Leica, UC7) at a cutting speed of 0.6 mm/s to produce a sliced sample. The sliced sample was observed at a magnification of from 500,000 to 1,200,000 in a STEM mode of a scanning transmission electron microscope (JEOL Ltd., JEM2800) having connected thereto an energy-dispersive X-ray spectroscopic analyzer (EDS analyzer).

Among the cross-sections of electroconductive particles observed, the cross-sections of the electroconductive particles each having a maximum diameter that was about 0.9 or more times and about 1.1 or less times as large as the primary particle diameter calculated in the foregoing were selected through visual observation. Subsequently, spectra of constituent elements of selected cross-sections of the electroconductive particles were collected through use of the EDS analyzer to produce EDS mapping images. The collection and analysis of spectra were performed through use of NSS (Thermo Fischer Scientific). Collection conditions were set to an acceleration voltage of 200 kV, a probe size of 1.0 nm or 1.5 nm appropriately selected so as to achieve a dead time of 15 or more and 30 or less, a mapping resolution of 256×256, and a Frame number of 300. The EDS mapping images were obtained for 100 cross-sections of the electroconductive particles.

The thus obtained EDS mapping images are each analyzed to calculate a ratio between a niobium atom concentration (atom % (the same unit as the atomic % described above)) and a titanium atom concentration (atom %) at each of the central portion of a particle and an inside portion at 5% of a maximum diameter of a measurement particle from the surface of the particle. Specifically, first, the “Line Extraction” button of NSS is pressed to draw a straight line so as to coincide with the maximum diameter of the particle, and information is obtained on an atom concentration (atom %) on a straight line extending from one surface, passing through the inside of the particle, and reaching an other surface. When the maximum diameter of the particle obtained by this analyzation falls within a range of less than 0.9 times or more than 1.1 times as large as the primary particle diameter calculated in the foregoing, the particle was excluded from a subsequent analysis. (Only particles each having a maximum diameter that falls within the range of 0.9 or more times and less than 1.1 times as large as the primary particle diameter were subjected to the analysis described below.) Next, on the surfaces on both sides of the particle, the niobium atom concentration (atom %) at an inside portion at 5% of the maximum diameter of the measurement particle from the surface of the particle is read. Similarly, the “titanium atom concentration (atom %) at the inside portion at 5% of the maximum diameter of the measurement particle from the surface of the particle” is obtained. Then, through use of those values, the “concentration ratio between the niobium atom and the titanium atom at the inside portion at 5% of the maximum diameter of the measurement particle from the surface of the particle” on each of the surfaces on both sides of the particle is obtained from the following formula.

The concentration ratio between the niobium atom and the titanium atom at the inside portion at 5% of the maximum diameter of the measurement particle from the surface of the particle is (niobium atom concentration (atom %) at inside portion at 5% of maximum diameter of measurement particle from surface of particle)/(titanium atom concentration (atom %) at inside portion at 5% of maximum diameter of measurement particle from surface of particle).

A smaller value out of a resultant two concentration ratios is adopted as the “concentration ratio between the niobium atom and the titanium atom at the inside portion at 5% of the maximum diameter of the measurement particle from the surface of the particle” in the present invention.

In addition, a niobium atom concentration (atom %) and a titanium atom concentration (atom %) at a position located on the above-mentioned straight line and coinciding with the middle point of the maximum diameter are read. Through use of those values, the “concentration ratio between the niobium atom and the titanium atom at the central portion of the particle” was obtained from the following formula.

The concentration ratio between the niobium atom and the titanium atom at the central portion of the particle is (niobium atom concentration (atomic %) at central portion of particle)/(titanium atom concentration (atomic %) at central portion of particle).

The “ratio of the concentration ratio calculated as niobium atom concentration/titanium atom concentration at the inside portion at 5% of the maximum diameter of the measurement particle from the surface of the particle to the concentration ratio calculated as niobium atom concentration/titanium atom concentration at the central portion of the particle” is (concentration ratio between niobium atom and titanium atom at inside portion at 5% of maximum diameter of measurement particle from surface of particle)/(concentration ratio between niobium atom and titanium atom at central portion of particle).

### <Method of Measuring Specific Dielectric Constants F(A) and F(NA) of Particles a and Particles Except Particles A>

Dielectric characteristics of the particles A and particles except the particles Ain the present invention are measured by the following method.

0.1 Grams each of the particles A and particles except the particles A in the present invention were weighed, and a load of 20 kPa was applied thereto for 1 minute, to thereby mold the particles into disc-shaped measurement samples each having a diameter of 25 mm and a thickness of 0.15±0.01 mm. Regarding the particles except particles A, particles B and other particles in Example are mixed in advance at a loading amount ratio and weighed.

Each of the measurement samples is mounted on an ARES (manufactured by TA Instruments) including a dielectric constant measuring jig (electrode) having a diameter of 25 mm. A specific dielectric constant ε(A) and a specific dielectric constant ε(NA) are each calculated from the following formula (7) by calculating a dielectric constant ε from measured values of a retention dielectric constant ε′ and a loss dielectric constant ε″ of a complex dielectric constant at 100 kHz and a temperature of 40° C. and dividing a resultant by a dielectric constant in a vacuum with a 4284A precision LCR meter (manufactured by Hewlett-Packard Co., Ltd.) under a state in which a load of 250 g/cm² was applied at a measurement temperature of 40° C.

$$ε = {( {ε}^{′2} + {ε}^{″2} )}^{1 / 2} \qquad Formula ( 7 )$$

### [Production of Electrophotographic Photosensitive Member]

A support, an electroconductive layer, an undercoat layer, a charge-generating layer, a charge-transporting layer, and a surface layer were produced by the following methods.

### <Preparation of Coating Liquid 1 for Electroconductive Layer>

Anatase-type titanium oxide having an average primary particle diameter of 200 nm was used as a substrate, and a sulfuric acid solution of titanium and niobium containing 33.7 parts of titanium in terms of TiO₂ and 2.9 parts of niobium in terms of Nb₂O₅ was prepared. 100 Parts of the substrate was dispersed in pure water to provide 1,000 parts of a suspension, and the suspension was warmed to 60° C. The sulfuric acid solution of titanium and niobium, and 10 mol/l sodium hydroxide were dropped over 3 hours so that the pH of the suspension became from 2 to 3. After the dropping of total amounts of the solutions, the pH was adjusted to a vicinity of a neutral value, and a polyacrylamide-based aggregating agent was added to precipitate a solid content. A supernatant was removed, and the residue was filtered and washed, followed by drying at 110° C. Thus, an intermediate containing 0.1 wt % of organic matter derived from the aggregating agent in terms of C was obtained. The intermediate was fired in nitrogen at 750° C. for 1 hour, and was then fired in air at 450° C. to produce titanium oxide particles 1. The average primary particle diameter of the resultant particles measured by the above-mentioned method of measuring a particle diameter with a scanning electron microscope was 220 nm.

Subsequently, 50 parts of a phenol resin (monomer/oligomer of a phenol resin) (product name: PLYOPHEN J-325, manufactured by DIC Corporation, resin solid content: 60%, density after curing: 1.3 g/cm²) serving as a binding material was dissolved in 35 parts of 1-methoxy-2-propanol serving as a solvent to provide a solution.

60 Parts of the titanium oxide particles 1 were added to the solution, and the mixture was loaded into a vertical sand mill using 120 parts of glass beads having a number-average primary particle diameter of 1.0 mm as a dispersion medium, and was subjected to dispersion treatment for 4 hours under the conditions of a dispersion liquid temperature of 23° C.±3° C. and a number of revolutions of 1,500 rpm (peripheral speed: 5.5 m/s). Thus, a dispersion liquid was obtained. The glass beads were removed from the dispersion liquid with a mesh. 0.01 Parts of a silicone oil (product name: SH28 PAINT ADDITIVE, manufactured by Dow Corning Toray Co., Ltd.) serving as a leveling agent and 8 parts of silicone resin particles (product name: KMP-590, manufactured by Shin-Etsu Chemical Co., Ltd., average primary particle diameter: 2 μm, density: 1.3 g/cm³) serving as a surface roughness-imparting material were added to the dispersion liquid after the removal of the glass beads, and the mixture was stirred, followed by filtration with PTFE filter paper (product name: PF-060, manufactured by Advantec Toyo Kaisha, Ltd.) under pressure. Thus, a coating liquid 1 for an electroconductive layer was prepared.

### <Preparation of Coating Liquid 1 for Undercoat Layer>

100 Parts of rutile-type titanium oxide particles (average primary particle diameter: 50 nm, manufactured by Tayca Corporation) were stirred and mixed with 500 parts of toluene, and 3.5 parts of vinyltrimethoxysilane (product name: KBM-1003, manufactured by Shin-Etsu Chemical Co., Ltd.) was added to the mixture, followed by dispersion treatment in a vertical sand mill using glass beads each having a diameter of 1.0 mm for 8 hours. After the glass beads had been removed, toluene was evaporated by distillation under reduced pressure, and the residue was dried for 3 hours at 120° C. to provide rutile-type titanium oxide particles whose surfaces had already been treated with an organosilicon compound. When a volume of the resultant titanium oxide particles was represented by “a”, and the average primary particle diameter of the titanium oxide particles was represented by “b” [μm], the ratio “a/b” was 15.6. A value of the “a” was determined from a microscopic image obtained by observing a cross-section of an electrophotographic photosensitive member with a field emission scanning electron microscope (FE-SEM, product name: S-4800, manufactured by Hitachi High-Technologies Corporation) after production of the electrophotographic photosensitive member.

18.0 Parts of the rutile-type titanium oxide particles whose surfaces had already been treated with the organosilicon compound, 4.5 parts of N-methoxymethylated nylon (product name: TORESIN (trademark) EF-30T, manufactured by Nagase ChemteX Corporation), and 1.5 parts of a copolymerized nylon resin (product name: AMILAN (trademark) CM8000, manufactured by Toray Industries, Inc.) were added to a mixed solvent of 90 parts of methanol and 60 parts of 1-butanol to prepare a dispersion liquid.

The dispersion liquid was subjected to dispersion treatment in a vertical sand mill using glass beads each having a diameter of 1.0 mm for 5 hours, and the glass beads were removed. Thus, a coating liquid 1 for an undercoat layer was prepared.

### <Synthesis of Phthalocyanine Pigment>

### Synthesis Example 1

Under a nitrogen flow atmosphere, 100 g of gallium trichloride and 291 g of orthophthalonitrile were added to 1,000 ml of α-chloronaphthalene, and the mixture was subjected to a reaction at a temperature of 200° C. for 24 hours, followed by the filtration of the product. The resultant wet cake was stirred in N,N-dimethylformamide under heating at a temperature of 150° C. for 30 minutes, and was then filtered. The resultant filter residue was washed with methanol, and was then dried to provide a chlorogallium phthalocyanine pigment in a yield of 83%.

20 Grams of the chlorogallium phthalocyanine pigment obtained by the above-mentioned method was dissolved in 500 ml of concentrated sulfuric acid, and the solution was stirred for 2 hours. After that, the solution was dropped into a mixed solution of 1,700 ml of distilled water and 660 ml of concentrated ammonia water, which had been cooled with ice, so that the pigment was reprecipitated. The precipitate was sufficiently washed with distilled water, and was dried to provide a hydroxygallium phthalocyanine pigment.

### <Preparation of Coating Liquid 1 for Charge-Generating Layer>

0.5 Parts of the hydroxygallium phthalocyanine pigment obtained in Synthesis Example 1, 7.5 parts of N,N-dimethylformamide (product code: D0722, manufactured by Tokyo Chemical Industry Co., Ltd.), and 29 parts of glass beads each having a diameter of 0.9 mm were subjected to milling treatment with a sand mill (BSG-20, manufactured by AIMEX Co., Ltd.) under a temperature of 25° C. for 24 hours. At this time, the treatment was performed under such a condition that a disc of the sand mill rotated 1,500 times in 1 minute. The liquid thus treated was filtered with a filter (product number: N-NO. 125T, pore diameter: 133 μm, manufactured by NBC Meshtec Inc.) so that the glass beads were removed. 30 Parts of N,N-dimethylformamide was added to the liquid, and then the mixture was filtered, followed by sufficient washing of a filter residue on a filter with n-butyl acetate. Then, a washed filter residue was dried in a vacuum to provide 0.45 parts of a hydroxygallium phthalocyanine pigment. The resultant pigment contained N,N-dimethylformamide.

Subsequently, 20 parts of hydroxygallium phthalocyanine pigment obtained by the milling treatment, 10 parts of polyvinyl butyral (product name: S-LEC (trademark) BX-1, manufactured by Sekisui Chemical Co., Ltd.), 190 parts of cyclohexanone, and 482 parts of glass beads each having a diameter of 0.9 mm were subjected to dispersion treatment with a sand mill (K-800, manufactured by Igarashi Machine Production Co., Ltd. (currently AIMEX Co., Ltd.), disc diameter: 70 mm, number of discs: 5) under a cooling water temperature of 18° C. for 4 hours. At this time, the treatment was performed under such a condition that the discs each rotated 1,800 times in 1 minute. The glass beads were removed from the dispersion liquid, and 444 parts of cyclohexanone and 634 parts of ethyl acetate were added to a residue to prepare a coating liquid 1 for a charge-generating layer.

### <Preparation of Coating Liquid 1 for Charge-Transporting Layer>

Next, the following materials were prepared to produce a mixed solvent.

| | |
|---|---|
| Orthoxylene | 25 parts by mass |
| Methyl benzoate | 25 parts by mass |
| Dimethoxymethane | 25 parts by mass |

Further, the following materials were dissolved in the mixed solvent to prepare a coating liquid 1 for a charge-transporting layer.

| | | |
|---|---|---|
| Charge-transporting substance (hole- | 5 | parts by mass |
| transportable substance) represented by | | |
| the following structural formula (C-1) | | |
| Charge-transporting substance (hole- | 5 | parts by mass |
| transportable substance) represented by | | |
| the following structural formula (C-2) | | |
| Polycarbonate (product name: Iupilon | 10 | parts by mass |
| (trademark) Z400, manufactured by Mitsubishi | | |
| Engineering-Plastics Corporation) | | |

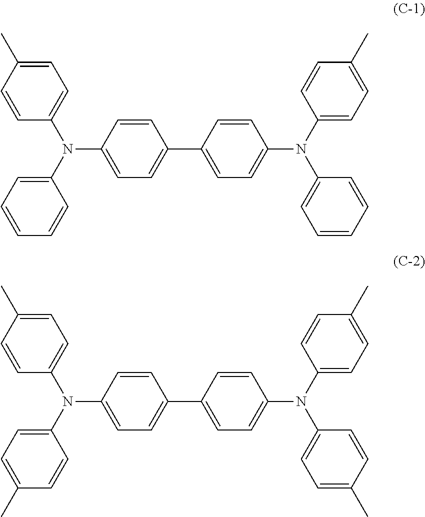 [SMILES: Cc1ccc(N(c2ccccc2)c2ccc(-c3ccc(N(c4ccccc4)c4ccc(C)cc4)cc3)cc2)cc1 ; Cc1ccc(N(c2ccc(C)cc2)c2ccc(-c3ccc(N(c4ccc(C)cc4)c4ccc(C)cc4)cc3)cc2)cc1]

### Production Example 1 of Surface Layer Containing Particles

Materials shown in Table 1 were prepared as particles A and particles B.

TABLE 1

| | | | Average |
|---|---|---|---|
| | | | primary |
| | | | particle |
| | | | diameter |
| | Product name | Manufacturer | [nm] |
| Particles 1 | QSG-170 | Shin-Etsu Chemical Co., Ltd. | 170 |
| Particles 2 | QSG-80 | Shin-Etsu Chemical Co., Ltd. | 80 |
| Particles 3 | QSG-30 | Shin-Etsu Chemical Co., Ltd. | 30 |
| Particles 4 | QSG-100 | Shin-Etsu Chemical Co., Ltd. | 100 |
| Particles 5 | QSG-10 | Shin-Etsu Chemical Co., Ltd. | 10 |
| Particles 6 | KE-P30 | Nippon Shokubai Co., Ltd. | 300 |
| Particles 7 | KE-P50 | Nippon Shokubai Co., Ltd. | 500 |
| Particles 8 | Electroconductive | — | 65 |
| | particles 1 | | |
| Particles 9 | Electroconductive | — | 65 |
| | particles 2 | | |
| Particles | Electroconductive | — | 30 |
| 10 | particles 3 | | |
| Particles | Electroconductive | — | 270 |
| 11 | particles 4 | | |
| Particles | Electroconductive | — | 65 |
| 12 | particles 5 | | |
| Particles | Electroconductive | — | 65 |
| 13 | particles 6 | | |
| Particles | Hydrotalcite | Kyowa Chemical Industry | 250 |
| 14 | | Co., Ltd. | |

### Production Examples of Anatase-Type Titanium Oxide Particles 1 to 3 Anatase-type titanium oxide particles may be produced by a known sulfuric acid

method. In the production of titanium oxide, a solution containing titanium sulfate and titanyl sulfate as titanium compounds is hydrolyzed through heating to produce a hydrous titanium dioxide slurry, and a titanium dioxide slurry is dewatered and fired. Thus, anatase-type titanium oxide having an anatase degree of nearly 100% is obtained.

Anatase-type titanium oxide particles 1 to 3 were each produced by controlling a solution concentration of titanyl sulfate in the above-mentioned method. The particle diameters thereof are shown in Table 2.

### Production Example of Anatase-Type Titanium Oxide Particles 4

Niobium sulfate (water-soluble niobium compound) was added to a hydrous titanium dioxide slurry obtained by hydrolyzing a titanyl sulfate aqueous solution. For an addition amount, niobium sulfate was added at a ratio of 1.8 mass % in terms of niobium ions with respect to an amount of titanium (in terms of titanium dioxide) in the slurry.

The titanyl sulfate aqueous solution to which niobium sulfate was added at a ratio of 1.8 mass % in terms of niobium ions was hydrolyzed to provide a hydrous titanium dioxide slurry. Next, the hydrous titanium dioxide slurry containing niobium ions, etc. was dewatered, and was fired at a firing temperature of 1,000° C. Thus, anatase-type titanium oxide particles 4 containing 1.8 mass % of a niobium element were obtained. The particle diameter thereof is shown in Table 2.

TABLE 2

| | Average primary |
|---|---|
| Titanium oxide particles | particle diameter [nm] |
| Anatase-type titanium oxide particles 1 | 55 |
| Anatase-type titanium oxide particles 2 | 22 |
| Anatase-type titanium oxide particles 3 | 220 |
| Anatase-type titanium oxide particles 4 | 150 |

### <Production of Electroconductive Particles>

### (Production of Electroconductive Particles 1)

Niobium(V) hydroxide was dissolved in concentrated sulfuric acid, and the solution was mixed with a titanium sulfate aqueous solution to prepare an acidic mixed liquid of a niobium salt and a titanium salt (hereinafter referred to as “titanium-niobium mixed liquid”).

100 Parts of the anatase-type titanium oxide particles 1 were measured, and were dispersed in water as particles before being covered to provide a suspension, and 1,000 parts of the aqueous suspension was warmed to 67° C. under stirring.

While the pH of the suspension was maintained at 2.5, the titanium-niobium mixed liquid containing 337 g/kg of Ti and 10.3 g/kg of Nb with respect to a weight of the anatase-type titanium oxide particles 1, and a sodium hydroxide aqueous solution were simultaneously added to the suspension.

In addition, a titanium-niobium acid solution obtained by mixing a niobium solution in which 3 parts of niobium pentachloride (NbCl₅) was dissolved in 100 parts of 11.4 mol/l hydrochloric acid and 200 parts of a titanium sulfate solution containing 12.0 parts of titanium (weight ratio between a niobium atom and a titanium atom in the solution was 1.0/20.0) was prepared. The titanium-niobium acid solution and a 10.7 mol/l sodium hydroxide aqueous solution were simultaneously dropped into the above-mentioned aqueous suspension over 3 hours so that the pH of the aqueous suspension was from 2 to 3 (parallel addition). After a completion of the dropping, the suspension was filtered and washed, and dried at 110° C. for 8 hours. The dried product was fired together with organic matter at 725° C. for 1 hour in a nitrogen atmosphere to provide niobium atom-containing titanium oxide particles 1 each having a niobium atom unevenly distributed to the vicinity of the surface.

Next, the following materials were prepared.

| Niobium atom-containing titanium oxide particles 1 | 100.0 | parts |
|---|---|---|
| Surface treatment agent 1 (compound represented by | 6.0 | parts |
| the following formula (S-1)) (product name: | | |
| trimethoxypropylsilane, manufactured by Tokyo | | |
| Chemical Industry Co., Ltd.) | | |
| 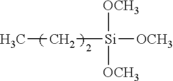 | (S-1) | |
| Toluene | 200.0 | parts |

Those materials were mixed, and were stirred with a stirring device for 4 hours, followed by filtration and washing. After that, the washed product was further subjected to heating treatment at 130° C. for 3 hours to provide electroconductive particles 1. Various physical property values are shown in Table 3.

### <Production of Electroconductive Particles 2 to 6>

Electroconductive particles 2 to 6 were each produced in a same manner as in the production of the electroconductive particles 1 except that in the production of the electroconductive particles 1, a kind of core particles to be used, and the weight ratio between the niobium atoms and the titanium atoms in the titanium-niobium mixed liquid with respect to the core were changed as shown in Table 3. Various physical property values of the resultant electroconductive particles 2 to 6 are shown in Table 3.

TABLE 3

| | Particles before | | | | | | |
|---|---|---|---|---|---|---|---|
| | being covered | | Niobium/ | | | | |
| | | Average | titanium | | Average | | |
| | | primary | mass ratio | | primary particle | | |
| | | particle | in titanium- | Covering | diameter of | Surface | |
| | | diameter | niobium mixed | material | electroconductive | treatment | |
| | Kind | [nm] | liquid | Kind | particles [nm] | agent | C/D |
| Electroconductive | Anatase-type | 55 | 21/337 | Niobium- | 65 | Surface | 7.7 |
| particles 1 | titanium oxide | | | doped | | treatment | |
| | particles 1 | | | titanium | | agent 1 | |
| Electroconductive | Anatase-type | 55 | 4/354 | Niobium- | 65 | Surface | 1.9 |
| particles 2 | titanium oxide | | | doped | | treatment | |
| | particles 1 | | | titanium | | agent 1 | |
| Electroconductive | Anatase-type | 22 | 14/344 | Niobium- | 30 | Surface | 6.1 |
| particles 3 | titanium oxide | | | doped | | treatment | |
| | particles 2 | | | titanium | | agent 1 | |
| Electroconductive | Anatase-type | 220 | 12/346 | Niobium- | 270 | Surface | 5.8 |
| particles 4 | titanium oxide | | | doped | | treatment | |
| | particles 3 | | | titanium | | agent 1 | |
| Electroconductive | Anatase-type | 55 | 21/337 | Niobium- | 65 | Surface | 7.7 |
| particles 5 | titanium oxide | | | doped | | treatment | |
| | particles 1 | | | titanium | | agent 2 | |
| Electroconductive | Anatase-type | 55 | 21/337 | Niobium- | 65 | Surface | 7.7 |
| particles 6 | titanium oxide | | | doped | | treatment | |
| | particles 1 | | | titanium | | agent 3 | |

Surface treatment agent 1: trimethoxy(propyl)silane (manufactured by Tokyo Chemical Industry Co., Ltd.)
Surface treatment agent 2: dimethoxy(methyl)-n-octylsilane (manufactured by Tokyo Chemical Industry Co., Ltd.)
Surface treatment agent 3: decyltrimethoxysilane (manufactured by Tokyo Chemical Industry Co., Ltd.)

In the table, C represents a “concentration ratio between a niobium atom and a titanium atom in the inside portion at 5% of the maximum diameter of the measurement particle from the surface of the particle,” and D represents “concentration ratio between a niobium atom and a titanium atom in the central portion of the particle.” That is, C/D is the “ratio of the concentration ratio calculated as niobium atom concentration/titanium atom concentration in the inside portion at 5% of the maximum diameter of the measurement particle from the surface of the particle to the concentration ratio calculated as niobium atom concentration/titanium atom concentration in the central portion of the particle” described above.

### <Preparation of Coating Liquid 1 for Surface Layer>

| | | |
|---|---|---|
| Particles A: silica particles (“QSG-170”, | 2.5 | parts by mass |
| manufactured by Shin-Etsu Chemical Co., Ltd.) | | |
| Particles B: silica particles (“QSG-80”, | 2.5 | parts by mass |
| manufactured by Shin-Etsu Chemical Co., Ltd.) | | |
| Monomer 1 having a polymerizable functional | 0.90 | parts by mass |
| group (the structural formula (2-1)) | | |
| Monomer 2 having a polymerizable functional | 0.90 | parts by mass |
| group (the structural formula (3-1)) | | |
| Siloxane-modified acrylic compound (product | 0.1 | parts by mass |
| name: SYMAC US270, manufactured by | | |
| Toagosei Co., Ltd.) | | |
| 1-Propanol | 100.0 | parts by mass |
| Cyclohexane | 100.0 | parts by mass |

The above-mentioned components were mixed, and were stirred with a stirring device for 6 hours to prepare a coating liquid 1 for a surface layer.

### <Preparation of Coating Liquids 2 to 68 for Surface Layers>

Coating liquids 2 to 68 for surface layers were each prepared in a same manner as in the preparation of the coating liquid 1 for a surface layer except that the kinds and addition amounts of the particles A, the particles B, and the other particles were changed as shown in Table 4-1, Table 4-2, Table 4-3, and Table 4-4.

### <Preparation of Coating Liquid 69 for Surface Layer>

| | | |
|---|---|---|
| Particles A: silica particles (“QSG-170”, | 2.5 | parts by mass |
| manufactured by Shin-Etsu Chemical Co., Ltd.) | | |
| Particles B: silica particles (“QSG-80”, | 2.5 | parts by mass |
| manufactured by Shin-Etsu Chemical Co., Ltd.) | | |
| Polycarbonate (product name: Iupilon Z400, | 1.8 | parts by mass |
| manufactured by Mitsubishi Engineering- | | |
| Plastics Corporation, density: 1.2 g/cm³) | | |
| Siloxane-modified acrylic compound (product | 0.1 | parts by mass |
| name: SYMAC US270, manufactured by | | |
| Toagosei Co., Ltd.) | | |
| Toluene | 200.0 | parts by mass |

The above-mentioned components were mixed, and were stirred with a stirring device for 6 hours to prepare a coating liquid 69 for a surface layer.

### <Preparation of Coating Liquid 70 for Surface Layer>

| | | |
|---|---|---|
| Anatase-type titanium oxide particles 4 | 10 | parts by mass |
| Dipentaerythritol | 10 | parts by mass |
| 1-Hydroxycyclohexyl(phenyl)methanone | 1 | part by mass |
| (IRGACURE 184, manufactured by Ciba | | |
| Specialty Chemicals) | | |
| n-Propyl alcohol | 40 | parts by mass |

The above-mentioned components were mixed, and were dispersed with a sand mill for 2 hours to produce a coating liquid 70 for a surface layer.

### <Preparation of Coating Liquid 71 for Surface Layer>

| | | |
|---|---|---|
| Methanol | 10 | parts by mass |
| Tin oxide (number-average primary | 5 | parts by mass |
| particle diameter: 100 nm) | | |

The above-mentioned materials were dispersed with a US homogenizer at room temperature for 30 minutes.

Next, the following materials were added to the above-mentioned dispersion liquid, and the mixture was stirred at room temperature for 60 minutes.

| | | |
|---|---|---|
| 3-Methacryloxypropyltrimethoxysilane | 0.25 | parts by mass |
| (“KBM-503”, manufactured by | | |
| Shin-Etsu Chemical Co., Ltd.) | | |
| Toluene | 10 | parts by mass |

After the solvent a been remove with an evaporator, the mixture was heated at 120° C. for 60 minutes to provide tin oxide particles 1 subjected to surface treatment with a reactive surface treatment agent.

Subsequently, the following materials were mixed and dispersed with a US homogenizer at room temperature for 60 minutes.

| | | |
|---|---|---|
| Tin oxide particles 1 subjected to surface treatment | 15 | parts by mass |
| 2-Butanol | 40 | parts by mass |

Next, 0.15 g of a linear silicone surface treatment agent (“KF-9908”, manufactured by Shin-Etsu Chemical Co., Ltd.) was added to the dispersed product, and was further dispersed therein at room temperature for 60 minutes with a US homogenizer. After the dispersion, the solvent was volatilized under room temperature, and the residue was dried at 120° C. for 60 minutes to produce surface-treated particles 1.

| | | |
|---|---|---|
| Trimethylolpropane trimethacrylate | 120 | parts by mass |
| Surface-treated particles 1 | 100 | parts by mass |
| Polymerization initiator (manufactured by | 10 | parts by mass |
| BASF Japan Ltd., IRGACURE (trademark) 819) | | |
| 2-Butanol | 400 | parts by mass |

The above-mentioned components were mixed to prepare a coating liquid 71 for a surface layer.

### <Preparation of Coating Liquid 72 for Surface Layer>

| | | |
|---|---|---|
| Trimethylolpropane triacrylate (manufactured | 70 | parts by mass |
| by Tokyo Chemical Industry Co., Ltd.) | | |
| Alumina particles AA-05 (manufactured by | 20 | parts by mass |
| Sumitomo Chemical Company, Limited, | | |
| average primary particle diameter: 500 nm) | | |
| Zinc oxide particles (aluminum-doped, | 10 | parts by mass |
| average primary particle diameter: 165 nm) | | |
| 1-Hydroxycyclohexyl phenyl ketone | 3.5 | parts by mass |
| (IRGACURE 184, manufactured by | | |
| Ciba Specialty Chemicals) | | |
| Isopropyl alcohol | 860 | parts by mass |

The above-mentioned components were mixed to prepare a coating liquid 72 for a surface layer.

### <Preparation of Coating Liquid 73 for Surface Layer>

| | | |
|---|---|---|
| Tin oxide (manufactured by CIK NanoTek | 100 | parts by mass |
| Corporation, number-average primary particle | | |
| diameter: 20 nm, volume resistivity: | | |
| 1.05 × 10⁵ (Ω · cm)) | | |
| 3-Methacryloxypropyltrimethoxysilane | 30 | parts by mass |
| (“KBM-503”, manufactured by Shin-Etsu | | |
| Chemical Co., Ltd.) | | |
| Toluene | 150 | parts by mass |
| Isopropyl alcohol | 150 | parts by mass |
| Zirconia beads | 300 | parts by mass |

The above-mentioned components were mixed, and were stirred with a sand mill at 40° C. and a number of revolutions of 1,500 rpm. The tin oxide particles were subjected to surface treatment with a surface treatment agent having a reactive organic group.

Further, the above-mentioned treated mixture was taken out and loaded into a Henschel mixer, followed by stirring at a number of revolutions of 1,500 rpm for 15 minutes. After that, the resultant was dried at 120° C. for 3 hours to provide tin oxide particles 2 subjected to surface treatment.

| | | |
|---|---|---|
| Tin oxide particles subjected to surface treatment | 50 | parts by mass |
| Silica particles (“AEROSIL (trademark) RX-50”, | 10 | parts by mass |
| manufactured by Nippon Aerosil Co., Ltd.) | | |
| Pentaerythritol | 100 | parts by mass |
| Charge-transporting substance (hole-transportable | 5 | parts by mass |
| substance) represented by the structural formula | | |
| (C-1) | | |
| sec-Butyl alcohol | 320 | parts by mass |
| Tetrahydrofuran | 80 | parts by mass |

Next, the above-mentioned components were mixed, and were dispersed with a sand mill at a number of revolutions of 1,500 rpm to provide a coating liquid 73 for a surface layer.

TABLE 4-1

| | Monomer 1 having | | Monomer 2 having | | | | |
|---|---|---|---|---|---|---|---|
| | polymerizable | | polymerizable | | | | |
| | functional group | | functional group | | Particles A | | |
| | Density of | | Density of | | | True | |
| | polymer | Addition | polymer | Addition | Kind of | specific | Addition |
| | [g/cm³] | amount | [g/cm³] | amount | particles | gravity | amount |
| Coating liquid 1 | 1.2 | 0.9 | 1.2 | 0.9 | 1 | 1.8 | 2.5 |
| for surface layer | | | | | | | |
| Coating liquid 2 | 1.2 | 0.9 | 1.2 | 0.9 | 1 | 1.8 | 4.2 |
| for surface layer | | | | | | | |
| Coating liquid 3 | 1.2 | 0.9 | 1.2 | 0.9 | 1 | 1.8 | 3.5 |
| for surface layer | | | | | | | |
| Coating liquid 4 | 1.2 | 0.9 | 1.2 | 0.9 | 1 | 1.8 | 2 |
| for surface layer | | | | | | | |
| Coating liquid 5 | 1.2 | 0.9 | 1.2 | 0.9 | 1 | 1.8 | 0.8 |
| for surface layer | | | | | | | |
| Coating liquid 6 | 1.2 | 0.9 | 1.2 | 0.9 | 1 | 1.8 | 1.5 |
| for surface layer | | | | | | | |
| Coating liquid 7 | 1.2 | 0.9 | 1.2 | 0.9 | 1 | 1.8 | 1.9 |
| for surface layer | | | | | | | |
| Coating liquid 8 | 1.2 | 0.9 | 1.2 | 0.9 | 1 | 1.8 | 3 |
| for surface layer | | | | | | | |
| Coating liquid 9 | 1.2 | 0.9 | 1.2 | 0.9 | 1 | 1.8 | 4 |
| for surface layer | | | | | | | |
| Coating liquid 10 | 1.2 | 0.6 | 1.2 | 0.6 | 1 | 1.8 | 2.5 |
| for surface layer | | | | | | | |
| Coating liquid 11 | 1.2 | 1.2 | 1.2 | 1.2 | 1 | 1.8 | 2.5 |
| for surface layer | | | | | | | |
| Coating liquid 12 | 1.2 | 1.5 | 1.2 | 1.5 | 1 | 1.8 | 2.5 |
| for surface layer | | | | | | | |
| Coating liquid 13 | 1.2 | 0.9 | 1.2 | 0.9 | 1 | 1.8 | 2.5 |
| for surface layer | | | | | | | |
| Coating liquid 14 | 1.2 | 0.9 | 1.2 | 0.9 | 1 | 1.8 | 2.5 |
| for surface layer | | | | | | | |
| Coating liquid 15 | 1.2 | 0.9 | 1.2 | 0.9 | 1 | 1.8 | 2.5 |
| for surface layer | | | | | | | |
| Coating liquid 16 | 1.2 | 0.9 | 1.2 | 0.9 | 1 | 1.8 | 2.5 |
| for surface layer | | | | | | | |
| Coating liquid 17 | 1.2 | 0.9 | 1.2 | 0.9 | 14 | 2 | 5 |
| for surface layer | | | | | | | |
| Coating liquid 18 | 1.2 | 0.9 | 1.2 | 0.9 | 1 | 1.8 | 2.5 |
| for surface layer | | | | | | | |
| Coating liquid 19 | 1.2 | 0.9 | 1.2 | 0.9 | 1 | 1.8 | 2.5 |
| for surface layer | | | | | | | |
| Coating liquid 20 | 1.2 | 0.9 | 1.2 | 0.9 | 1 | 1.8 | 2.5 |
| for surface layer | | | | | | | |

| | Particles B | | | Other particles | | |
|---|---|---|---|---|---|---|
| | | True | | | True | |
| | Kind of | specific | Addition | Kind of | specific | Addition |
| | particles | gravity | amount | particles | gravity | amount |
| Coating liquid 1 | 2 | 1.8 | 2.5 | — | — | — |
| for surface layer | | | | | | |
| Coating liquid 2 | 2 | 1.8 | 0.8 | — | — | — |
| for surface layer | | | | | | |
| Coating liquid 3 | 2 | 1.8 | 1.5 | — | — | — |
| for surface layer | | | | | | |
| Coating liquid 4 | 2 | 1.8 | 3 | — | — | — |
| for surface layer | | | | | | |
| Coating liquid 5 | 2 | 1.8 | 4.2 | — | — | — |
| for surface layer | | | | | | |
| Coating liquid 6 | 2 | 1.8 | 1.5 | — | — | — |
| for surface layer | | | | | | |
| Coating liquid 7 | 2 | 1.8 | 1.9 | — | — | — |
| for surface layer | | | | | | |
| Coating liquid 8 | 2 | 1.8 | 3 | — | — | — |
| for surface layer | | | | | | |
| Coating liquid 9 | 2 | 1.8 | 4 | — | — | — |
| for surface layer | | | | | | |
| Coating liquid 10 | 2 | 1.8 | 2.5 | — | — | — |
| for surface layer | | | | | | |
| Coating liquid 11 | 2 | 1.8 | 2.5 | — | — | — |
| for surface layer | | | | | | |
| Coating liquid 12 | 2 | 1.8 | 2.5 | — | — | — |
| for surface layer | | | | | | |
| Coating liquid 13 | 3 | 1.8 | 2.5 | — | — | — |
| for surface layer | | | | | | |
| Coating liquid 14 | 5 | 1.8 | 2.5 | — | — | — |
| for surface layer | | | | | | |
| Coating liquid 15 | 2 | 1.8 | 2.5 | — | — | — |
| for surface layer | | | | | | |
| Coating liquid 16 | 2 | 1.8 | 2.5 | 7 | 1.8 | 0.2 |
| for surface layer | | | | | | |
| Coating liquid 17 | 2 | 1.8 | 2.5 | — | — | — |
| for surface layer | | | | | | |
| Coating liquid 18 | 8 | 4 | 5 | — | — | — |
| for surface layer | | | | | | |
| Coating liquid 19 | 9 | 4 | 5 | — | — | — |
| for surface layer | | | | | | |
| Coating liquid 20 | 10 | 4 | 5 | — | — | [symbol] |
| for surface layer | | | | | | |

TABLE 4-2

| | Monomer 1 having | | Monomer 2 having | | | | |
|---|---|---|---|---|---|---|---|
| | polymerizable | | polymerizable | | | | |
| | functional group | | functional group | | Particles A | | |
| | Density | | Density | | | True | |
| | of polymer | Addition | of polymer | Addition | Kind of | specific | Addition |
| | [g/cm³] | amount | [g/cm³] | amount | particles | gravity | amount |
| Coating liquid 21 | 1.2 | 0.9 | 1.2 | 0.9 | 1 | 1.8 | 2.5 |
| for surface layer | | | | | | | |
| Coating liquid 22 | 1.2 | 0.9 | 1.2 | 0.9 | 1 | 1.8 | 2.5 |
| for surface layer | | | | | | | |
| Coating liquid 23 | 1.2 | 0.9 | 1.2 | 0.9 | 1 | 1.8 | 2.5 |
| for surface layer | | | | | | | |
| Coating liquid 24 | 1.2 | 0.9 | 1.2 | 0.9 | 4 | 1.8 | 2.5 |
| for surface layer | | | | | | | |
| Coating liquid 25 | 1.2 | 0.9 | 1.2 | 0.9 | 1 | 1.8 | 2.5 |
| for surface layer | | | | | | | |
| Coating liquid 26 | 1.2 | 0.9 | 1.2 | 0.9 | 6 | 1.8 | 2.5 |
| for surface layer | | | | | | | |
| Coating liquid 27 | 1.2 | 0.9 | 1.2 | 0.9 | 6 | 1.8 | 2.5 |
| for surface layer | | | | | | | |
| Coating liquid 28 | 1.2 | 0.9 | 1.2 | 0.9 | 1 | 1.8 | 2.5 |
| for surface layer | | | | | | | |
| Coating liquid 29 | 1.2 | 0.9 | 1.2 | 0.9 | 1 | 1.8 | 2.5 |
| for surface layer | | | | | | | |
| Coating liquid 30 | 1.2 | 1.8 | 1.2 | 1.8 | 1 | 1.8 | 5 |
| for surface layer | | | | | | | |
| Coating liquid 31 | 1.2 | 1.8 | 1.2 | 1.8 | 1 | 1.8 | 8.4 |
| for surface layer | | | | | | | |
| Coating liquid 32 | 1.2 | 1.8 | 1.2 | 1.8 | 1 | 1.8 | 7 |
| for surface layer | | | | | | | |
| Coating liquid 33 | 1.2 | 1.8 | 1.2 | 1.8 | 1 | 1.8 | 4 |
| for surface layer | | | | | | | |
| Coating liquid 34 | 1.2 | 1.8 | 1.2 | 1.8 | 1 | 1.8 | 1.6 |
| for surface layer | | | | | | | |
| Coating liquid 35 | 1.2 | 1.8 | 1.2 | 1.8 | 1 | 1.8 | 8 |
| for surface layer | | | | | | | |
| Coating liquid 36 | 1.2 | 0.6 | 1.2 | 0.6 | 1 | 1.8 | 5 |
| for surface layer | | | | | | | |
| Coating liquid 37 | 1.2 | 2.4 | 1.2 | 2.4 | 1 | 1.8 | 5 |
| for surface layer | | | | | | | |
| Coating liquid 38 | 1.2 | 3 | 1.2 | 3 | 1 | 1.8 | 5 |
| for surface layer | | | | | | | |
| Coating liquid 39 | 1.2 | 1.8 | 1.2 | 1.8 | 1 | 1.8 | 5 |
| for surface layer | | | | | | | |
| Coating liquid 40 | 1.2 | 1.8 | 1.2 | 1.8 | 1 | 1.8 | 5 |
| for surface layer | | | | | | | |

| | Particles B | | | Other particles | | |
|---|---|---|---|---|---|---|
| | | True | | | True | |
| | Kind of | specific | Addition | Kind of | specific | Addition |
| | particles | gravity | amount | particles | gravity | amount |
| Coating liquid 21 | 11 | 4 | 5 | — | — | — |
| for surface layer | | | | | | |
| Coating liquid 22 | 12 | 4 | 5 | — | — | — |
| for surface layer | | | | | | |
| Coating liquid 23 | 13 | 4 | 5 | — | — | — |
| for surface layer | | | | | | |
| Coating liquid 24 | 3 | 1.8 | 2.5 | — | — | — |
| for surface layer | | | | | | |
| Coating liquid 25 | 4 | 1.8 | 2.5 | — | — | — |
| for surface layer | | | | | | |
| Coating liquid 26 | 1 | 1.8 | 2.5 | — | — | — |
| for surface layer | | | | | | |
| Coating liquid 27 | 5 | 1.8 | 2.5 | — | — | — |
| for surface layer | | | | | | |
| Coating liquid 28 | 2 | 1.8 | 2.5 | 4 | 4 | 0.2 |
| for surface layer | | | | | | |
| Coating liquid 29 | 2 | 1.8 | 2.5 | 5 | 1.8 | 0.2 |
| for surface layer | | | | | | |
| Coating liquid 30 | 2 | 1.8 | 5 | — | — | — |
| for surface layer | | | | | | |
| Coating liquid 31 | 2 | 1.8 | 1.6 | — | — | — |
| for surface layer | | | | | | |
| Coating liquid 32 | 2 | 1.8 | 3 | — | — | — |
| for surface layer | | | | | | |
| Coating liquid 33 | 2 | 1.8 | 6 | — | — | — |
| for surface layer | | | | | | |
| Coating liquid 34 | 2 | 1.8 | 8.4 | — | — | — |
| for surface layer | | | | | | |
| Coating liquid 35 | 2 | 1.8 | 8 | — | — | — |
| for surface layer | | | | | | |
| Coating liquid 36 | 2 | 1.8 | 5 | — | — | — |
| for surface layer | | | | | | |
| Coating liquid 37 | 2 | 1.8 | 5 | — | — | — |
| for surface layer | | | | | | |
| Coating liquid 38 | 2 | 1.8 | 5 | — | — | — |
| for surface layer | | | | | | |
| Coating liquid 39 | 3 | 1.8 | 5 | — | — | — |
| for surface layer | | | | | | |
| Coating liquid 40 | 5 | 1.8 | 5 | — | — | — |
| for surface layer | | | | | | |

TABLE 4-3

| | Monomer 1 having | | Monomer 2 having | | | | |
|---|---|---|---|---|---|---|---|
| | polymerizable | | polymerizable | | | | |
| | functional group | | functional group | | Particles A | | |
| | Density | | Density | | | True | |
| | of polymer | Addition | of polymer | Addition | Kind of | specific | Addition |
| | [g/cm³] | amount | [g/cm³] | amount | particles | gravity | amount |
| Coating liquid 41 | 1.2 | 4.2 | 1.2 | 4.2 | 1 | 1.8 | 4.5 |
| for surface layer | | | | | | | |
| Coating liquid 42 | 1.2 | 1.8 | 1.2 | 1.8 | 1 | 1.8 | 5 |
| for surface layer | | | | | | | |
| Coating liquid 43 | 1.2 | 1.8 | 1.2 | 1.8 | 1 | 1.8 | 5 |
| for surface layer | | | | | | | |
| Coating liquid 44 | 1.2 | 1.8 | 1.2 | 1.8 | 14 | 2 | 10 |
| for surface layer | | | | | | | |
| Coating liquid 45 | 1.2 | 1.8 | 1.2 | 1.8 | 1 | 1.8 | 5 |
| for surface layer | | | | | | | |
| Coating liquid 46 | 1.2 | 1.8 | 1.2 | 1.8 | 1 | 1.8 | 5 |
| for surface layer | | | | | | | |
| Coating liquid 47 | 1.2 | 1.8 | 1.2 | 1.8 | 1 | 1.8 | 5 |
| for surface layer | | | | | | | |
| Coating liquid 48 | 1.2 | 1.8 | 1.2 | 1.8 | 1 | 1.8 | 5 |
| for surface layer | | | | | | | |
| Coating liquid 49 | 1.2 | 1.8 | 1.2 | 1.8 | 1 | 1.8 | 5 |
| for surface layer | | | | | | | |
| Coating liquid 50 | 1.2 | 1.8 | 1.2 | 1.8 | 1 | 1.8 | 5 |
| for surface layer | | | | | | | |
| Coating liquid 51 | 1.2 | 1.8 | 1.2 | 1.8 | 4 | 1.8 | 10 |
| for surface layer | | | | | | | |
| Coating liquid 52 | 1.2 | 1.8 | 1.2 | 1.8 | 1 | 1.8 | 10 |
| for surface layer | | | | | | | |
| Coating liquid 53 | 1.2 | 1.8 | 1.2 | 1.8 | 6 | 1.8 | 5 |
| for surface layer | | | | | | | |
| Coating liquid 54 | 1.2 | 1.8 | 1.2 | 1.8 | 6 | 1.8 | 5 |
| for surface layer | | | | | | | |
| Coating liquid 55 | 1.2 | 1.8 | 1.2 | 1.8 | 1 | 1.8 | 5 |
| for surface layer | | | | | | | |
| Coating liquid 56 | 1.2 | 1.8 | 1.2 | 1.8 | 1 | 1.8 | 5 |
| for surface layer | | | | | | | |
| Coating liquid 57 | 1.2 | 0.9 | 1.2 | 0.9 | 7 | 1.8 | 5 |
| for surface layer | | | | | | | |
| Coating liquid 58 | 1.2 | 0.9 | 1.2 | 0.9 | 3 | 1.8 | 3.6 |
| for surface layer | | | | | | | |
| Coating liquid 59 | 1.2 | 0.9 | 1.2 | 0.9 | 4 | 1.8 | 9 |
| for surface layer | | | | | | | |
| Coating liquid 60 | 1.2 | 0.9 | 1.2 | 0.9 | 1 | 1.8 | 0.4 |
| for surface layer | | | | | | | |

| | Particles B | | | Other particles | | |
|---|---|---|---|---|---|---|
| | | True | | | True | |
| | Kind of | specific | Addition | Kind of | specific | Addition |
| | particles | gravity | amount | particles | gravity | amount |
| Coating liquid 41 | 2 | 1.8 | 9.5 | — | — | — |
| for surface layer | | | | | | |
| Coating liquid 42 | 2 | 1.8 | 5 | — | — | — |
| for surface layer | | | | | | |
| Coating liquid 43 | 2 | 1.8 | 5 | 7 | 1.8 | 0.4 |
| for surface layer | | | | | | |
| Coating liquid 44 | 2 | 1.8 | 5 | — | — | — |
| for surface layer | | | | | | |
| Coating liquid 45 | 8 | 4 | 10 | — | — | — |
| for surface layer | | | | | | |
| Coating liquid 46 | 9 | 4 | 10 | — | — | — |
| for surface layer | | | | | | |
| Coating liquid 47 | 10 | 4 | 10 | — | — | — |
| for surface layer | | | | | | |
| Coating liquid 48 | 11 | 4 | 10 | — | — | — |
| for surface layer | | | | | | |
| Coating liquid 49 | 12 | 4 | 10 | — | — | — |
| for surface layer | | | | | | |
| Coating liquid 50 | 13 | 4 | 10 | — | — | — |
| for surface layer | | | | | | |
| Coating liquid 51 | 3 | 1.8 | 5 | — | — | — |
| for surface layer | | | | | | |
| Coating liquid 52 | 4 | 1.8 | 5 | — | — | — |
| for surface layer | | | | | | |
| Coating liquid 53 | 1 | 1.8 | 5 | — | — | — |
| for surface layer | | | | | | |
| Coating liquid 54 | 5 | 1.8 | 5 | — | — | — |
| for surface layer | | | | | | |
| Coating liquid 55 | 2 | 1.8 | 5 | 4 | 4 | 0.4 |
| for surface layer | | | | | | |
| Coating liquid 56 | 2 | 1.8 | 5 | 5 | 1.8 | 0.4 |
| for surface layer | | | | | | |
| Coating liquid 57 | 2 | 1.8 | 10 | — | — | — |
| for surface layer | | | | | | |
| Coating liquid 58 | 5 | 1.8 | 3.2 | — | — | — |
| for surface layer | | | | | | |
| Coating liquid 59 | 3 | 1.8 | 1 | — | — | — |
| for surface layer | | | | | | |
| Coating liquid 60 | 2 | 1.8 | 4.6 | — | — | — |
| for surface layer | | | | | | |

TABLE 4-4

| | Monomer 1 having | | Monomer 2 having | | | | |
|---|---|---|---|---|---|---|---|
| | polymerizable | | polymerizable | | | | |
| | functional group | | functional group | | Particles A | | |
| | Density | | Density | | | True | |
| | of polymer | Addition | of polymer | Addition | Kind of | specific | Addition |
| | [g/cm³] | amount | [g/cm³] | amount | particles | gravity | amount |
| Coating liquid 61 | 1.2 | 0.9 | 1.2 | 0.9 | 1 | 1.8 | 1 |
| for surface layer | | | | | | | |
| Coating liquid 62 | 1.2 | 0.9 | 1.2 | 0.9 | 1 | 1.8 | 2.5 |
| for surface layer | | | | | | | |
| Coating liquid 63 | 1.2 | 1.8 | 1.2 | 1.8 | 7 | 1.8 | 10 |
| for surface layer | | | | | | | |
| Coating liquid 64 | 1.2 | 1.8 | 1.2 | 1.8 | 3 | 1.8 | 7.2 |
| for surface layer | | | | | | | |
| Coating liquid 65 | 1.2 | 1.8 | 1.2 | 1.8 | 4 | 1.8 | 18 |
| for surface layer | | | | | | | |
| Coating liquid 66 | 1.2 | 1.8 | 1.2 | 1.8 | 1 | 1.8 | 0.8 |
| for surface layer | | | | | | | |
| Coating liquid 67 | 1.2 | 1.8 | 1.2 | 1.8 | 1 | 1.8 | 2 |
| for surface layer | | | | | | | |
| Coating liquid 68 | 1.2 | 1.8 | 1.2 | 1.8 | 1 | 1.8 | 5 |
| for surface layer | | | | | | | |

| | Particles B | | | Other particles | | |
|---|---|---|---|---|---|---|
| | | True | | | True | |
| | Kind of | specific | Addition | Kind of | specific | Addition |
| | particles | gravity | amount | particles | gravity | amount |
| Coating liquid 61 | 2 | 1.8 | 1 | — | — | — |
| for surface layer | | | | | | |
| Coating liquid 62 | 2 | 1.8 | 2.5 | 7 | 1.8 | 5 |
| for surface layer | | | | | | |
| Coating liquid 63 | 2 | 1.8 | 20 | — | — | — |
| for surface layer | | | | | | |
| Coating liquid 64 | 5 | 1.8 | 20 | — | — | — |
| for surface layer | | | | | | |
| Coating liquid 65 | 3 | 1.8 | 20 | — | — | — |
| for surface layer | | | | | | |
| Coating liquid 66 | 2 | 1.8 | 9.2 | — | — | — |
| for surface layer | | | | | | |
| Coating liquid 67 | 2 | 1.8 | 2 | — | — | — |
| for surface layer | | | | | | |
| Coating liquid 68 | 2 | 1.8 | 5 | 7 | 1.8 | 10 |
| for surface layer | | | | | | |

### <Production Example of Electrophotographic Photosensitive Member 1>

### (Support)

An aluminum cylinder having a diameter of 24 mm and a length of 257 mm was used as a support (cylindrical support).

### (Electroconductive Layer)

The coating liquid 1 for an electroconductive layer was applied onto the above-mentioned support by dip coating to form a coat, and the coat was heated at 150° C. for 30 minutes to be cured. Thus, an electroconductive layer having a thickness of 22 μm was formed.

### (Undercoat Layer)

The coating liquid 1 for an undercoat layer was applied onto the above-mentioned electroconductive layer by dip coating to form a coat, and the coat was heated at 100° C. for 10 minutes to be cured. Thus, an undercoat layer having a thickness of 1.8 m was formed.

### (Charge-Generating Layer)

The coating liquid 1 for a charge-generating layer was applied onto the above-mentioned undercoat layer by dip coating to form a coat, and the coat was dried by heating at a temperature of 100° C. for 10 minutes. Thus, a charge-generating layer having a thickness of 0.20 μm was formed.

### (Charge-Transporting Layer)

The coating liquid 1 for a charge-transporting layer was applied onto the above-mentioned charge-generating layer by dip coating to form a coat, and the coat was dried by heating at a temperature of 120° C. for 30 minutes. Thus, a charge-transporting layer having a thickness of 21 μm was formed.

### (Surface Layer)

The coating liquid 1 for a surface layer was applied onto the above-mentioned charge-transporting layer by dip coating to form a coat, and the coat was warmed at a temperature of 50° C. for 5 minutes. After that, under a nitrogen atmosphere, the coat was irradiated with electron beams for 2.0 seconds under conditions of an acceleration voltage of 65 kV and a beam current of 5.0 mA while a support (irradiation target) was rotated at a speed of 300 rpm. The dose of the electron beams was 15 kGy. After that, under the nitrogen atmosphere, a temperature of the coat was increased to 120° C. An oxygen concentration of the atmosphere during a time period from the electron beam irradiation to the subsequent heating treatment was 10 ppm.

Next, in the air, the coat was naturally cooled until its temperature became 25° C., and then heating treatment was performed for 30 minutes under such a condition that the temperature of the coat became 120° C. Thus, a surface layer having a thickness of 1.0 μm was formed. The physical properties of the resultant electrophotographic photosensitive member are shown in Table 5-1, Table 5-2, Table 5-3, Table 5-4, Table 5-5, and Table 5-6.

### Production Examples of Electrophotographic Photosensitive Members 2 to 68

Electrophotographic photosensitive members 2 to 68 were each produced in a same manner as in the production of the electrophotographic photosensitive member 1 except that in the production of the electrophotographic photosensitive member 1, the coating liquid 1 for a surface layer was changed as represented by a condition shown in Table 5-1, Table 5-2, Table 5-3, Table 5-4, Table 5-5, and Table 5-6. The physical properties of the resultant electrophotographic photosensitive members 1 to 68 are shown in Table 5-1, Table 5-2, Table 5-3, Table 5-4, Table 5-5, and Table 5-6.

### Production Example of Electrophotographic Photosensitive Member 69

An electrophotographic photosensitive member 69 was produced in a same manner as in the production of the electrophotographic photosensitive member 1 except that in the production of the electrophotographic photosensitive member 1, the coating liquid 1 for a surface layer was changed to the coating liquid 69 for a surface layer. The physical properties of the resultant electrophotographic photosensitive member are shown in Table 5-4, Table 5-5, and Table 5-6.

### Production Example of Electrophotographic Photosensitive Member 70

In the production of the electrophotographic photosensitive member 1, a same production as that in the electrophotographic photosensitive member 1 was performed up to the formation of a charge-transporting layer. After that, a coating liquid 70 for a surface layer was applied onto the charge-transporting layer and then irradiated with UV light through use of a metal halide lamp at 16 mW/cm² for 1 minute (integrated light quantity: 960 mJ/cm²) to produce an electrophotographic photosensitive member 70. Physical properties of the resultant electrophotographic photosensitive member 70 are shown in Table 5-4, Table 5-5, and Table 5-6.

### Production Example of Electrophotographic Photosensitive Member 71

In the production of the electrophotographic photosensitive member 1, a same production as that in the electrophotographic photosensitive member 1 was performed up to the formation of a charge-transporting layer. After that, the coating liquid 71 for a surface layer was applied onto the charge-transporting layer and then irradiated with UV light through use of a metal halide lamp for 1 minute (irradiation intensity: 15 mW/cm²), followed by drying at 80° C. for 120 minutes, to produce an electrophotographic photosensitive member 71. Physical properties of the resultant electrophotographic photosensitive member 71 are shown in Table 5-4, Table 5-5, and Table 5-6.

### Production Example of Electrophotographic Photosensitive Member 72

In the production of the electrophotographic photosensitive member 1, a same production as that in the electrophotographic photosensitive member 1 was performed up to the formation of a charge-transporting layer. After that, the coating liquid 72 for a surface layer was applied onto the charge-transporting layer and then irradiated with UV light through use of a metal halide lamp at an irradiation intensity of 500 mW/cm² for 20 seconds, followed by drying at 130° C. for 30 minutes, to produce an electrophotographic photosensitive member 72. Physical properties of the resultant electrophotographic photosensitive member 72 are shown in Table 5-4, Table 5-5, and Table 5-6.

### Production Example of Electrophotographic Photosensitive Member 73

In the production of the electrophotographic photosensitive member 1, a same production as that in the electrophotographic photosensitive member 1 was performed up to the formation of a charge-transporting layer. After that, the coating liquid 73 for a surface layer was applied onto the charge-transporting layer and then irradiated with UV light through use of a metal halide lamp at 16 mW/cm² for 1 minute (integrated light quantity: 960 mJ/cm²) to produce an electrophotographic photosensitive member 73. Physical properties of the resultant electrophotographic photosensitive member 73 are shown in Table 5-4, Table 5-5, and Table 5-6.

TABLE 5-1

| | | | | Average | Standard | Coefficient |
|---|---|---|---|---|---|---|
| | | | | value of | deviation of | of variation |
| | | | | distances | distances | of distances |
| | | | Particle | between | between | between |
| | Coating | | diameter | gravity | gravity | gravity |
| | liquid for | | DA of | centers | centers of | centers of |
| Electrophotographic | surface layer | Lamination state | PEA at | of convex | convex | convex |
| photosensitive | used in | in sectional | peak top | portions | portions | portions |
| member No. | production | observation | [nm] | CA[nm] | CA[nm] | CA |
| 1 | 1 | Single layer | 170 | 200 | 40 | 20% |
| 2 | 2 | Single layer | 170 | 170 | 51 | 30% |
| 3 | 3 | Single layer | 170 | 200 | 60 | 30% |
| 4 | 4 | Single layer | 170 | 220 | 66 | 30% |
| 5 | 5 | Single layer | 170 | 480 | 216 | 45% |
| 6 | 6 | Single layer | 170 | 320 | 96 | 30% |
| 7 | 7 | Single layer | 170 | 280 | 98 | 35% |
| 8 | 8 | Single layer | 170 | 450 | 180 | 40% |
| 9 | 9 | Single layer | 170 | 470 | 212 | 45% |
| 10 | 10 | Single layer | 170 | 250 | 75 | 30% |
| 11 | 11 | Single layer | 170 | 250 | 75 | 30% |
| 12 | 12 | Single layer | 170 | 250 | 75 | 30% |
| 13 | 13 | Single layer | 170 | 220 | 55 | 25% |
| 14 | 14 | Single layer | 170 | 200 | 60 | 30% |
| 15 | 15 | Single layer | 170 | 320 | 96 | 30% |
| 16 | 16 | Single layer | 170 | 350 | 105 | 30% |
| 17 | 17 | Single layer | 250 | 450 | 203 | 45% |
| 18 | 18 | Single layer | 170 | 255 | 77 | 30% |
| 19 | 19 | Single layer | 170 | 245 | 74 | 30% |
| 20 | 20 | Single layer | 170 | 350 | 105 | 30% |
| 21 | 21 | Single layer | 170 | 245 | 74 | 30% |
| 22 | 22 | Single layer | 170 | 255 | 77 | 30% |
| 23 | 23 | Single layer | 170 | 260 | 78 | 30% |
| 24 | 24 | Single layer | 100 | 250 | 75 | 30% |
| 25 | 25 | Single layer | 170 | 250 | 75 | 30% |
| 26 | 26 | Single layer | 300 | 470 | 165 | 35% |
| 27 | 27 | Single layer | 300 | 350 | 123 | 35% |
| 28 | 28 | Single layer | 170 | 250 | 75 | 30% |
| 29 | 29 | Single layer | 170 | 250 | 75 | 30% |
| 30 | 30 | Plurality of layers | 170 | 200 | 40 | 20% |
| 31 | 31 | Plurality of layers | 170 | 170 | 51 | 30% |
| 32 | 32 | Plurality of layers | 170 | 200 | 60 | 30% |
| 33 | 33 | Plurality of layers | 170 | 220 | 66 | 30% |
| 34 | 34 | Plurality of layers | 170 | 480 | 216 | 45% |
| 35 | 35 | Plurality of layers | 170 | 470 | 141 | 30% |
| 36 | 36 | Plurality of layers | 170 | 250 | 88 | 35% |
| 37 | 37 | Plurality of layers | 170 | 250 | 100 | 40% |
| 38 | 38 | Plurality of layers | 170 | 250 | 75 | 30% |

TABLE 5-2

| | | | | | Ratio of number | | |
|---|---|---|---|---|---|---|---|
| | | | | | of convex | | |
| | | | | Particle | portions CA to | | |
| | | | | diameter | total number of | | Maximum |
| | | | | DB of | convex portions | Half- | height |
| Electrophotographic | | Average | | PEB at | present on | width of | difference |
| photosensitive | S1/ | thickness | | peak | surface | distribution | of surface |
| member No. | (S1 + S2) | T [nm] | DB/DA | top[nm] | (number %) | of PEA[nm] | Rz [nm] |
| 1 | 0.9 | 100 | 0.47 | 80 | 96 | 30 | 270 |
| 2 | 0.9 | 100 | 0.47 | 80 | 95 | 30 | 261 |
| 3 | 0.9 | 100 | 0.47 | 80 | 97 | 30 | 270 |
| 4 | 0.9 | 100 | 0.47 | 80 | 94 | 30 | 276 |
| 5 | 0.9 | 100 | 0.47 | 80 | 95 | 30 | 354 |
| 6 | 0.73 | 100 | 0.47 | 80 | 95 | 30 | 306 |
| 7 | 0.81 | 100 | 0.47 | 80 | 96 | 30 | 294 |
| 8 | 0.95 | 100 | 0.47 | 80 | 95 | 30 | 345 |
| 9 | 1 | 100 | 0.47 | 80 | 97 | 30 | 351 |
| 10 | 1 | 67 | 0.47 | 80 | 94 | 30 | 285 |
| 11 | 0.81 | 133 | 0.47 | 80 | 95 | 30 | 285 |
| 12 | 0.73 | 167 | 0.47 | 80 | 95 | 30 | 285 |
| 13 | 0.9 | 100 | 0.18 | 30 | 96 | 30 | 276 |
| 14 | 0.9 | 100 | 0.06 | 10 | 95 | 30 | 270 |
| 15 | 0.9 | 100 | 0.47 | 80 | 97 | 60 | 306 |
| 16 | 0.9 | 100 | 0.47 | 80 | 94 | 30 | 425 |
| 17 | 1 | 100 | 0.32 | 80 | 95 | 60 | 315 |
| 18 | 0.88 | 100 | 0.38 | 65 | 95 | 30 | 287 |
| 19 | 0.88 | 100 | 0.38 | 65 | 96 | 30 | 284 |
| 20 | 0.88 | 100 | 0.18 | 30 | 95 | 30 | 315 |
| 21 | 0.88 | 100 | 1.59 | 270 | 97 | 30 | 284 |
| 22 | 0.88 | 100 | 0.38 | 65 | 94 | 30 | 287 |
| 23 | 0.88 | 100 | 0.38 | 65 | 95 | 30 | 288 |
| 24 | 0.9 | 100 | 0.3 | 30 | 95 | 18 | 215 |
| 25 | 0.9 | 100 | 0.06 | 10 | 96 | 30 | 285 |
| 26 | 0.9 | 100 | 0.57 | 170 | 95 | 53 | 481 |
| 27 | 0.9 | 100 | 0.03 | 10 | 97 | 53 | 445 |
| 28 | 0.9 | 100 | 0.47 | 80 | 94 | 30 | 285 |
| 29 | 0.9 | 100 | 0.47 | 80 | 95 | 30 | 285 |
| 30 | 1 | 200 | 0.47 | 80 | 95 | 30 | 270 |
| 31 | 1 | 200 | 0.47 | 80 | 96 | 30 | 261 |
| 32 | 1 | 200 | 0.47 | 80 | 95 | 30 | 270 |
| 33 | 1 | 200 | 0.47 | 80 | 97 | 30 | 276 |
| 34 | 1 | 200 | 0.47 | 80 | 94 | 30 | 354 |
| 35 | 1 | 200 | 0.47 | 80 | 95 | 30 | 351 |
| 36 | 1 | 67 | 0.47 | 80 | 95 | 30 | 285 |
| 37 | 0.81 | 267 | 0.47 | 80 | 95 | 30 | 285 |
| 38 | 0.73 | 333 | 0.47 | 80 | 94 | 30 | 285 |

TABLE 5-3

| | | | Specific | | | | | |
|---|---|---|---|---|---|---|---|---|
| | | Specific | dielectric | | | | | |
| | | dielectric | constant | | | | | Content of |
| | | constant | ε (A) of | | | | | particles |
| Electrophotographic | Circularity | ε (A) of | particles | | | | | in surface |
| photosensitive | of particles | particles | except | d(Ti) | d(Si) | d(Ti)/ | | layer |
| member No. | PAA | A | particles | [atomic %] | [atomic %] | d(Si) | C/D | [vol %] |
| 1 | 0.98 | 2 | 2 | 0 | 21 | 0 | — | 65 |
| 2 | 0.98 | 2 | 2 | 0 | 20 | 0 | — | 65 |
| 3 | 0.98 | 2 | 2 | 0 | 22 | 0 | — | 65 |
| 4 | 0.98 | 2 | 2 | 0 | 23 | 0 | — | 65 |
| 5 | 0.98 | 2 | 2 | 0 | 22 | 0 | — | 65 |
| 6 | 0.98 | 2 | 2 | 0 | 23 | 0 | — | 53 |
| 7 | 0.98 | 2 | 2 | 0 | 24 | 0 | — | 58 |
| 8 | 0.98 | 2 | 2 | 0 | 23 | 0 | — | 69 |
| 9 | 0.98 | 2 | 2 | 0 | 21 | 0 | — | 75 |
| 10 | 0.98 | 2 | 2 | 0 | 20 | 0 | — | 74 |
| 11 | 0.98 | 2 | 2 | 0 | 22 | 0 | — | 58 |
| 12 | 0.98 | 2 | 2 | 0 | 23 | 0 | — | 53 |
| 13 | 0.98 | 2 | 2 | 0 | 22 | 0 | — | 65 |
| 14 | 0.98 | 2 | 2 | 0 | 23 | 0 | — | 65 |
| 15 | 0.98 | 2 | 2 | 0 | 23 | 0 | — | 65 |
| 16 | 0.98 | 2 | 2 | 0 | 22 | 0 | — | 65 |
| 17 | 0.85 | 30 | 2 | 0 | 20 | 0 | — | 72 |
| 18 | 0.97 | 2 | 50 | 1.8 | 9 | 0.2 | 7.7 | 64 |
| 19 | 0.975 | 2 | 50 | 1.6 | 9.5 | 0.17 | 1.9 | 64 |
| 20 | 0.972 | 2 | 50 | 4 | 9.3 | 0.43 | 6.1 | 64 |
| 21 | 0.975 | 2 | 50 | 4 | 10 | 0.4 | 5.8 | 64 |
| 22 | 0.98 | 2 | 50 | 2.2 | 12 | 0.18 | 7.7 | 64 |
| 23 | 0.975 | 2 | 50 | 1.8 | 14 | 0.13 | 7.7 | 64 |
| 24 | 0.98 | 2 | 2 | 0 | 20 | 0 | — | 65 |
| 25 | 0.98 | 2 | 2 | 0 | 22 | 0 | — | 65 |
| 26 | 0.98 | 2 | 2 | 0 | 23 | 0 | — | 65 |
| 27 | 0.98 | 2 | 2 | 0 | 22 | 0 | — | 65 |
| 28 | 0.98 | 2 | 2 | 0 | 23 | 0 | — | 65 |
| 29 | 0.98 | 2 | 2 | 0 | 24 | 0 | — | 65 |
| 30 | 0.98 | 2 | 2 | 0 | 23 | 0 | — | 65 |
| 31 | 0.98 | 2 | 2 | 0 | 22 | 0 | — | 65 |
| 32 | 0.98 | 2 | 2 | 0 | 20 | 0 | — | 65 |
| 33 | 0.98 | 2 | 2 | 0 | 22 | 0 | — | 65 |
| 34 | 0.98 | 2 | 2 | 0 | 23 | 0 | — | 65 |
| 35 | 0.98 | 2 | 2 | 0 | 23 | 0 | — | 75 |
| 36 | 0.98 | 2 | 2 | 0 | 22 | 0 | — | 85 |
| 37 | 0.98 | 2 | 2 | 0 | 23 | 0 | — | 58 |
| 38 | 0.98 | 2 | 2 | 0 | 24 | 0 | — | 53 |

TABLE 5-4

| | | | | Average | Standard | Coefficient |
|---|---|---|---|---|---|---|
| | | | | value of | deviation of | of variation |
| | | | | distances | distances | of distances |
| | Coating | | Particle | between | between | between |
| | liquid for | | diameter | gravity | gravity | gravity |
| | surface | | DA of | centers | centers of | centers of |
| Electrophotographic | layer | Lamination state | PEA at | of convex | convex | convex |
| photosensitive | used in | in sectional | peak top | portions | portions | portions |
| member No. | production | observation | [nm] | CA[nm] | CA[nm] | CA |
| 39 | 39 | Plurality of layers | 170 | 220 | 66 | 30% |
| 40 | 40 | Plurality of layers | 170 | 200 | 60 | 30% |
| 41 | 41 | Plurality of layers | 170 | 270 | 81 | 30% |
| 42 | 42 | Plurality of layers | 170 | 320 | 96 | 30% |
| 43 | 43 | Plurality of layers | 170 | 350 | 105 | 30% |
| 44 | 44 | Plurality of layers | 250 | 450 | 203 | 45% |
| 45 | 45 | Plurality of layers | 170 | 255 | 77 | 30% |
| 46 | 46 | Plurality of layers | 170 | 245 | 74 | 30% |
| 47 | 47 | Plurality of layers | 170 | 350 | 105 | 30% |
| 48 | 48 | Plurality of layers | 170 | 245 | 74 | 30% |
| 49 | 49 | Plurality of layers | 170 | 255 | 77 | 30% |
| 50 | 50 | Plurality of layers | 170 | 260 | 78 | 30% |
| 51 | 51 | Plurality of layers | 100 | 250 | 75 | 30% |
| 52 | 52 | Plurality of layers | 170 | 250 | 75 | 30% |
| 53 | 53 | Plurality of layers | 300 | 470 | 165 | 35% |
| 54 | 54 | Plurality of layers | 300 | 350 | 123 | 35% |
| 55 | 55 | Plurality of layers | 170 | 250 | 75 | 30% |
| 56 | 56 | Plurality of layers | 170 | 250 | 75 | 30% |
| 57 | 57 | Single layer | 500 | 550 | 275 | 50% |
| 58 | 58 | Single layer | 30 | 550 | 248 | 45% |
| 59 | 59 | Single layer | 100 | 100 | 30 | 30% |
| 60 | 60 | Single layer | 170 | 550 | 248 | 45% |
| 61 | 61 | Single layer | 170 | 600 | 270 | 45% |
| 62 | 62 | Single layer | 500 | 550 | 248 | 45% |
| 63 | 63 | Plurality of layers | 500 | 550 | 275 | 50% |
| 64 | 64 | Plurality of layers | 30 | 550 | 248 | 45% |
| 65 | 65 | Plurality of layers | 100 | 100 | 50 | 50% |
| 66 | 66 | Plurality of layers | 170 | 550 | 248 | 45% |
| 67 | 67 | Plurality of layers | 170 | 600 | 270 | 45% |
| 68 | 68 | Plurality of layers | 500 | 550 | 248 | 45% |
| 69 | 69 | Single layer | 170 | 200 | 60 | 30% |
| 70 | 70 | Plurality of layers | 150 | 550 | 275 | 50% |
| 71 | 71 | Plurality of layers | 100 | 250 | 100 | 40% |
| 72 | 72 | Plurality of layers | 500 | 600 | 300 | 50% |
| 73 | 73 | Plurality of layers | 50 | 550 | 275 | 50% |

TABLE 5-5

| | | | | | Ratio of number | | |
|---|---|---|---|---|---|---|---|
| | | | | | of convex | | |
| | | | | Particle | portions CA to | | |
| | | | | diameter | total number of | | Maximum |
| | | | | DB of | convex portions | Half- | height |
| Electrophotographic | S1/ | Average | | PEB at | present on | width of | difference |
| photosensitive | (S1 + | thickness | | peak | surface | distribution | of surface |
| member No. | S2) | T [nm] | DB/DA | top[nm] | (number %) | of PEA[nm] | Rz [nm] |
| 39 | 1 | 200 | 0.18 | 30 | 95 | 30 | 276 |
| 40 | 1 | 200 | 0.06 | 10 | 95 | 30 | 270 |
| 41 | 0.73 | 467 | 0.47 | 80 | 80 | 30 | 291 |
| 42 | 1 | 200 | 0.47 | 80 | 94 | 60 | 306 |
| 43 | 1 | 200 | 0.47 | 80 | 95 | 30 | 430 |
| 44 | 1 | 200 | 0.32 | 80 | 95 | 60 | 325 |
| 45 | 1 | 200 | 0.38 | 65 | 94 | 30 | 287 |
| 46 | 1 | 200 | 0.38 | 65 | 95 | 30 | 284 |
| 47 | 1 | 200 | 0.18 | 30 | 95 | 30 | 315 |
| 48 | 1 | 200 | 1.59 | 270 | 94 | 30 | 284 |
| 49 | 1 | 200 | 0.38 | 65 | 95 | 30 | 287 |
| 50 | 1 | 200 | 0.38 | 65 | 95 | 30 | 288 |
| 51 | 1 | 200 | 0.3 | 30 | 94 | 18 | 215 |
| 52 | 1 | 200 | 0.59 | 100 | 95 | 30 | 285 |
| 53 | 1 | 200 | 0.57 | 170 | 95 | 53 | 481 |
| 54 | 1 | 200 | 0.03 | 10 | 94 | 53 | 445 |
| 55 | 1 | 200 | 0.47 | 80 | 95 | 30 | 285 |
| 56 | 1 | 200 | 0.47 | 80 | 95 | 30 | 285 |
| 57 | 0.91 | 100 | 0.16 | 80 | 95 | 88 | 705 |
| 58 | 1 | 100 | 0.33 | 10 | 94 | 5 | 235 |
| 59 | 0.85 | 100 | 0.3 | 30 | 95 | 18 | 170 |
| 60 | 0.9 | 100 | 0.47 | 80 | 95 | 30 | 375 |
| 61 | 0.59 | 100 | 0.47 | 80 | 80 | 30 | 390 |
| 62 | 0.9 | 100 | 0.16 | 80 | 94 | 88 | 705 |
| 63 | 0.91 | 200 | 0.16 | 80 | 95 | 88 | 705 |
| 64 | 1 | 200 | 0.33 | 10 | 94 | 5 | 235 |
| 65 | 0.94 | 200 | 0.3 | 30 | 95 | 18 | 170 |
| 66 | 0.9 | 200 | 0.47 | 80 | 95 | 30 | 375 |
| 67 | 0.59 | 200 | 0.47 | 80 | 94 | 30 | 485 |
| 68 | 0.9 | 200 | 0.16 | 80 | 95 | 88 | 705 |
| 69 | 1 | 100 | 0.47 | 80 | 94 | 30 | 270 |
| 70 | 0.35 | 2,000 | — | 0 | 94 | 26 | 425 |
| 71 | 0.5 | 1,500 | — | 0 | 95 | 18 | 175 |
| 72 | 0.45 | 1,500 | 0.33 | 165 | 95 | 88 | 680 |
| 73 | 0.5 | 3,000 | 0.4 | 20 | 95 | 9 | 215 |

TABLE 5-6

| | | | Specific | | | | | |
|---|---|---|---|---|---|---|---|---|
| | | Specific | dielectric | | | | | |
| | | dielectric | constant | | | | | Content of |
| | | constant | ε (A) of | | | | | particles |
| Electrophotographic | Circularity | ε (A) of | particles | | | | | in surface |
| photosensitive | of particles | particles | except | d(Ti) | d(Si) | d(Ti)/ | | layer |
| member No. | PAA | A | particles | [atomic %] | [atomic %] | d(Si) | C/D | [vol %] |
| 39 | 0.98 | 2 | 2 | 0 | 23 | 0 | — | 65 |
| 40 | 0.98 | 2 | 2 | 0 | 22 | 0 | — | 65 |
| 41 | 0.98 | 2 | 2 | 0 | 20 | 0 | — | 53 |
| 42 | 0.98 | 2 | 2 | 0 | 22 | 0 | — | 65 |
| 43 | 0.98 | 2 | 2 | 0 | 24 | 0 | — | 65 |
| 44 | 0.85 | 30 | 2 | 0 | 23 | 0 | — | 72 |
| 45 | 0.97 | 2 | 50 | 1.8 | 9 | 0.2 | 7.7 | 64 |
| 46 | 0.975 | 2 | 50 | 1.6 | 9.5 | 0.17 | 1.9 | 64 |
| 47 | 0.972 | 2 | 50 | 4 | 9.3 | 0.43 | 6.1 | 64 |
| 48 | 0.975 | 2 | 50 | 4 | 10 | 0.4 | 5.8 | 64 |
| 49 | 0.98 | 2 | 50 | 2.2 | 12 | 0.18 | 7.7 | 64 |
| 50 | 0.975 | 2 | 50 | 1.8 | 14 | 0.13 | 7.7 | 64 |
| 51 | 0.98 | 2 | 2 | 0 | 24 | 0 | — | 74 |
| 52 | 0.98 | 2 | 2 | 0 | 23 | 0 | — | 74 |
| 53 | 0.98 | 2 | 2 | 0 | 22 | 0 | — | 65 |
| 54 | 0.98 | 2 | 2 | 0 | 20 | 0 | — | 65 |
| 55 | 0.98 | 2 | 2 | 0 | 22 | 0 | — | 65 |
| 56 | 0.98 | 2 | 2 | 0 | 23 | 0 | — | 65 |
| 57 | 0.98 | 2 | 2 | 0 | 23 | 0 | — | 85 |
| 58 | 0.98 | 2 | 2 | 0 | 22 | 0 | — | 72 |
| 59 | 0.98 | 2 | 2 | 0 | 20 | 0 | — | 79 |
| 60 | 0.98 | 2 | 2 | 0 | 22 | 0 | — | 65 |
| 61 | 0.98 | 2 | 2 | 0 | 23 | 0 | — | 43 |
| 62 | 0.98 | 2 | 2 | 0 | 24 | 0 | — | 65 |
| 63 | 0.98 | 2 | 2 | 0 | 23 | 0 | — | 85 |
| 64 | 0.98 | 2 | 2 | 0 | 24 | 0 | — | 83 |
| 65 | 0.98 | 2 | 2 | 0 | 23 | 0 | — | 88 |
| 66 | 0.98 | 2 | 2 | 0 | 22 | 0 | — | 65 |
| 67 | 0.98 | 2 | 2 | 0 | 20 | 0 | — | 43 |
| 68 | 0.98 | 2 | 2 | 0 | 22 | 0 | — | 65 |
| 69 | 0.98 | 2 | 2 | 0 | 24 | 0 | — | 65 |
| 70 | 0.94 | 45 | — | 1.6 | 23 | 0.07 | 1.1 | 25 |
| 71 | 0.945 | 2 | — | 0 | 15 | 0 | — | 5 |
| 72 | 0.945 | 8.5 | 2.5 | 0 | 15 | 0 | — | 15 |
| 73 | 0.945 | 2 | 2.5 | 0 | 10 | 0 | — | 23 |

In the table, C represents a “concentration ratio between a niobium atom and a titanium atom in the inside portion at 5% of the maximum diameter of the measurement particle from the surface of the particle,” and D represents a “concentration ratio between a niobium atom and a titanium atom in the central portion of the particle.” That is, C/D is the “ratio of the concentration ratio calculated as niobium atom concentration/titanium atom concentration in the inside portion at 5% of the maximum diameter of the measurement particle from the surface of the particle to the concentration ratio calculated as niobium atom concentration/titanium atom concentration in the central portion of the particle” described above.

### Production Example of Toner Particles 1

### (Preparation of Aqueous Medium 1)

650.0 Parts of ion-exchanged water and 14.0 parts of sodium phosphate (manufactured by RASA Industries, Ltd., dodecahydrate) were loaded into a reaction vessel including a stirring machine, a temperature gauge, and a reflux tube, and a temperature of the mixture was held at 65° C. for 1.0 hour while the vessel was purged with nitrogen.

While the mixture was stirred with T.K. HOMOMIXER (manufactured by Tokushu Kika Kogyo Co., Ltd.) at 15,000 rpm, a calcium chloride aqueous solution obtained by dissolving 9.2 parts of calcium chloride (dihydrate) in 10.0 parts of ion-exchanged water was collectively loaded into the mixture to prepare an aqueous medium containing a dispersion stabilizer. Further, 10 mass % hydrochloric acid was loaded into an aqueous medium to adjust its pH to 5.0. Thus, an aqueous medium 1 was obtained.

### (Preparation of Polymerizable Monomer Composition)

| | | |
|---|---|---|
| Styrene | 60.0 | parts by mass |
| C.I. Pigment Blue 15:3 | 6.5 | parts by mass |

The materials were loaded into an attritor (manufactured by Mitsui Miike Kakoki K.K.), and were dispersed with zirconia particles each having a diameter of 1.7 mm at 220 rpm for 5.0 hours, followed by a removal of the zirconia particles. Thus, a colorant dispersion liquid was prepared.

| | | |
|---|---|---|
| Styrene | 20.0 | parts by mass |
| n-Butyl acrylate | 20.0 | parts by mass |
| Crosslinking agent (divinylbenzene) | 0.3 | parts by mass |
| Saturated polyester resin | 5.0 | parts by mass |

(polycondensate of propylene oxide-modified bisphenol A (2-mol adduct) and terephthalic acid (at a molar ratio of 10:12), glass transition temperature (Tg): 68° C., weight-average molecular weight (Mw): 10,000, molecular weight distribution (Mw/Mn): 5.12)

| | |
|---|---|
| Fischer-Tropsch wax (melting point: 78° C.) | 7.0 parts by mass |

Meanwhile, the materials were added to the above-mentioned colorant dispersion liquid, and the mixture was heated to 65° C. After that, the materials were uniformly dissolved and dispersed in the dispersion liquid with T.K. HOMOMIXER (manufactured by Tokushu Kika Kogyo Co., Ltd.) at 500 rpm to prepare a polymerizable monomer composition.

### (Granulating Step)

While a temperature of the aqueous medium 1 was adjusted to 70° C., and a number of revolutions of the T.K. HOMOMIXER was kept at 15,000 rpm, the polymerizable monomer composition was loaded into the aqueous medium 1, and 10.0 parts by mass of t-butyl peroxypivalate serving as a polymerization initiator was added thereto. The mixture was granulated as it was with the stirring device for 10 minutes while a number of revolutions was maintained at 15,000 rpm.

### (Polymerization Step and Distillation Step)

After the granulating step, the stirring machine was changed to a propeller stirring blade, and polymerization was performed for 5.0 hours by holding a temperature of the granulated product at 70° C. while stirring the granulated product at 150 rpm. Further, polymerization was performed by increasing the temperature to 85° C. and holding the temperature at the value for 2.0 hours. After that, a reflux tube of the reaction vessel was replaced with a cooling tube, and an unreacted polymerizable monomer was evaporated by performing distillation for 6 hours through the heating of a resultant slurry to 100° C. Thus, a toner particle dispersion liquid 1 was obtained.

### (Filtration Step, Washing Step, Drying Step, and Classification Step)

Hydrochloric acid was added to the resultant toner particle dispersion liquid 1 to set the pH to 1.4 or less, and the above-mentioned dispersion stabilizer was dissolved in the liquid, followed by filtration, washing, drying, and classification. Thus, toner particles 1 were obtained. The toner particles 1 had a number-average particle diameter (D1) of 6.2 μm and a weight-average particle diameter (D4) of 6.7 μm.

### Production Example of Toner 1

100.0 Parts by mass of the resultant toner particles 1 and 1.0 part by mass of silica fine particles (hydrophobic treatment with hexamethyldisilazane, number-average particle diameter of primary particles: 8 nm, BET specific surface area: 160 m²/g) were mixed in a Henschel mixer (manufactured by Mitsui Miike Kakoki K.K.). The resultant mixture was sieved through a mesh having a mesh aperture of 75 μm to provide a toner 1.

### [Evaluation Method]

Examples and Comparative Examples were evaluated by the following evaluation methods.

### <Evaluation of Transferability (Evaluation Method 1)>

A reconstructed machine of a commercially available laser beam printer “i-SENSYS LBP 673 Cdw” manufactured by Canon Inc. was used. The printer was reconstructed as follows: a main body and software of the evaluation machine were changed to enable a change in bias to be applied in a transferring step.

Toner in the cyan cartridge of the evaluation machine “i-SENSYS LBP 673 Cdw” is removed, and a required amount of the toner 1 is loaded thereinto. The cyan toner cartridge, into which the toner had been reloaded, was left to stand under a normal-temperature and normal-humidity environment (25° C., 50% RH; hereinafter also referred to as “under a N/N environment”) for 24 hours. The cyan toner cartridge after 24 hours of standing under the environment was mounted on the above-mentioned evaluation machine, and an image having a print percentage of 2.0% was output on up to 30 sheets of A4 paper under the N/N environment as follows: margins each having a width of 50 mm were arranged on left and right sides of the paper, and the image was output on the central portion of the paper in its horizontal direction. Plain paper CS-680 (68 g/m²) (Canon Marketing Japan Inc.) was used as the paper.

Next, an entire solid image having a width of 30 mm was output on a plain paper CS-680 in a vertical direction of the paper. The output in the forming the solid image was stopped, and transfer residual toner on the electrophotographic photosensitive member was collected with a transparent tape (Polyester tape 5511, manufactured by NICHIBAN Co., Ltd.) made of transparent polyester.

A density of the transfer residual toner was measured by the following method. The transparent tape, which had been peeled from the surface of the electrophotographic photosensitive member and had collected the transfer residual toner, and a brand-new transparent tape were each bonded onto high white paper (GF-C081, Canon Inc.). Then, a density D1 of the transparent tape in the portion from which the transfer residual toner had been collected and a density DO of a brand-new transparent tape portion were each measured with an X-Rite color reflection densitometer (manufactured by X-Rite, Inc., X-Rite 500 Series).

The difference “D1-D0” obtained by the measurement was adopted as the density of the transfer residual toner (transfer residual density). A smaller numerical value of the transfer residual toner density (transfer residual density) means that an amount of the transfer residual toner is smaller.

The transferability was judged as described below. The resultant transfer residual density was ranked on 5 stages of from A to E based on the following criteria. The ranks A to D out of the ranks were each regarded as the rank at which the effects of the present invention were expressed. Evaluation results are shown in Table 6-1, Table 6-2, Table 6-3, and Table 6-4.

### (Evaluation Criteria)

A: The transfer residual density is less than 0.02.
B: The transfer residual density is 0.02 or more and less than 0.05.
C: The transfer residual density is 0.05 or more and less than 0.10.
D: The transfer residual density is 0.10 or more.

### <Evaluation of Transferability at Time of Endurance (Evaluation Method 2)>

As one of durability evaluations, after the taping evaluation of the transfer residual toner was performed, an image having a print percentage of 2.0% was output on up to 5,000 sheets of A4 paper under the N/N environment as follows: margins each having a width of 50 mm were arranged on left and right sides of the paper, and the image was output on the central portion of the paper in its horizontal direction, and then, the transfer residual toner was evaluated by taping in a same manner as in the above-mentioned <Evaluation of Transferability (Evaluation Method 1)> in the above-mentioned <Evaluation of Transferability>. Determination was performed based on the same evaluation criteria.

### <Evaluation of Roughness (Evaluation Method 3)>

As one of durability evaluations, after a character image having a print percentage of 1% was output on 10,000 sheets with a reconstructed machine placed under an environment of 30° C. and 80% RH, a halftone (20H) image was formed, and a roughness (density uniformity) of this image was evaluated based on the following criteria. Plain paper CS-680 (68 g/m²) (Canon Marketing Japan Inc.) was used as the paper. The 20H image is a halftone image that uses values expressed in 256 gradations represented in hexadecimal format in which OOH is solid white (non-image) and FFH is solid black (full image).

As the evaluation criteria for the roughness, the roughness was evaluated based on the following criteria. Density measurement was performed at 20 locations, and determination was performed as described below from a value of a difference in density between a maximum value and a minimum value (density uniformity). The density was measured with an X-Rite color reflection densitometer (manufactured by X-Rite, Inc., X-Rite 500 Series).

### (Evaluation Criteria)

A: The density uniformity is less than 0.04.
B: The density uniformity is 0.04 or more and less than 0.06.
C: The density uniformity is 0.06 or more and less than 0.08.
D: The density uniformity is 0.08 or more.

### <Evaluation of Endurance Density Transition (Evaluation Method 4)>

As one of durability evaluations, a density transition in a durability test was evaluated with a reconstructed machine placed under an environment of 30° C. and 80% RH. An original image in which solid black patches each measuring 20 mm by 20 mm were placed at five locations in a development region was output, and a development bias was set so that an initial reflection density was 1.3. Next, a durability test in which a character image having a print percentage of 1% was output on 10,000 sheets was performed. Plain paper CS-680 (68 g/m²) (Canon Marketing Japan Inc.) was used as paper. Durability was evaluated by comparing density differences of an image density after a durability test from the density of the initial image in terms of average density of five points of solid black patches.

The image density was obtained by measuring a density relative to a white ground blank portion of an original image with “Macbeth reflection densitometer RD918” (manufactured by Macbeth).

### (Evaluation Criteria)

A: The density difference is less than 0.10.
B: The density difference is 0.10 or more and less than 0.15.
C: The density difference is 0.15 or more and less than 0.20.
D: The density difference is 0.20 or more.

The results are shown in Table 6-1, Table 6-2, Table 6-3, and Table 6-4 below.

TABLE 6-1

| | | | Evaluation method 1 | |
|---|---|---|---|---|
| | | | Evaluation of | Transfer |
| | | | initial | residual |
| | | Toner | transferability | density |
| Example 1 | Electrophotographic photosensitive member 1 | Toner 1 | A | 0.01 |
| Example 2 | Electrophotographic photosensitive member 2 | Toner 1 | B | 0.03 |
| Example 3 | Electrophotographic photosensitive member 3 | Toner 1 | B | 0.02 |
| Example 4 | Electrophotographic photosensitive member 4 | Toner 1 | B | 0.03 |
| Example 5 | Electrophotographic photosensitive member 5 | Toner 1 | B | 0.02 |
| Example 6 | Electrophotographic photosensitive member 6 | Toner 1 | A | 0.01 |
| Example 7 | Electrophotographic photosensitive member 7 | Toner 1 | A | 0.01 |
| Example 8 | Electrophotographic photosensitive member 8 | Toner 1 | B | 0.03 |
| Example 9 | Electrophotographic photosensitive member 9 | Toner 1 | B | 0.02 |
| Example 10 | Electrophotographic photosensitive member 10 | Toner 1 | A | 0.01 |
| Example 11 | Electrophotographic photosensitive member 11 | Toner 1 | A | 0.01 |
| Example 12 | Electrophotographic photosensitive member 12 | Toner 1 | A | 0.01 |
| Example 13 | Electrophotographic photosensitive member 13 | Toner 1 | A | 0.01 |
| Example 14 | Electrophotographic photosensitive member 14 | Toner 1 | A | 0.01 |
| Example 15 | Electrophotographic photosensitive member 15 | Toner 1 | B | 0.02 |
| Example 16 | Electrophotographic photosensitive member 16 | Toner 1 | A | 0.01 |
| Example 17 | Electrophotographic photosensitive member 17 | Toner 1 | B | 0.02 |
| Example 18 | Electrophotographic photosensitive member 18 | Toner 1 | A | 0.01 |
| Example 19 | Electrophotographic photosensitive member 19 | Toner 1 | B | 0.02 |
| Example 20 | Electrophotographic photosensitive member 20 | Toner 1 | B | 0.02 |
| Example 21 | Electrophotographic photosensitive member 21 | Toner 1 | B | 0.02 |
| Example 22 | Electrophotographic photosensitive member 22 | Toner 1 | B | 0.02 |
| Example 23 | Electrophotographic photosensitive member 23 | Toner 1 | B | 0.02 |
| Example 24 | Electrophotographic photosensitive member 24 | Toner 1 | B | 0.02 |
| Example 25 | Electrophotographic photosensitive member 25 | Toner 1 | B | 0.02 |
| Example 26 | Electrophotographic photosensitive member 26 | Toner 1 | A | 0.01 |
| Example 27 | Electrophotographic photosensitive member 27 | Toner 1 | A | 0.01 |
| Example 28 | Electrophotographic photosensitive member 28 | Toner 1 | A | 0.01 |
| Example 29 | Electrophotographic photosensitive member 29 | Toner 1 | A | 0.01 |
| Example 30 | Electrophotographic photosensitive member 30 | Toner 1 | A | 0.01 |
| Example 31 | Electrophotographic photosensitive member 31 | Toner 1 | B | 0.03 |
| Example 32 | Electrophotographic photosensitive member 32 | Toner 1 | B | 0.02 |
| Example 33 | Electrophotographic photosensitive member 33 | Toner 1 | B | 0.03 |
| Example 34 | Electrophotographic photosensitive member 34 | Toner 1 | B | 0.02 |
| Example 35 | Electrophotographic photosensitive member 35 | Toner 1 | B | 0.02 |
| Example 36 | Electrophotographic photosensitive member 36 | Toner 1 | A | 0.01 |
| Example 37 | Electrophotographic photosensitive member 37 | Toner 1 | A | 0.01 |

TABLE 6-2

| | Evaluation method 2 | | | | Evaluation method 4 | |
|---|---|---|---|---|---|---|
| | Evaluation of | Transfer | Evaluation method 3 | | Evaluation of | |
| | transferability | residual | Evaluation of | Density | endurance | Density |
| | at time of | density | roughness | uniformity | density | difference |
| Example 1 | A | 0.01 | A | 0.03 | A | 0.06 |
| Example 2 | B | 0.03 | A | 0.02 | B | 0.12 |
| Example 3 | B | 0.03 | A | 0.02 | B | 0.12 |
| Example 4 | B | 0.03 | A | 0.02 | B | 0.12 |
| Example 5 | A | 0.01 | B | 0.05 | C | 0.17 |
| Example 6 | C | 0.06 | C | 0.06 | B | 0.12 |
| Example 7 | B | 0.04 | B | 0.05 | B | 0.12 |
| Example 8 | C | 0.08 | B | 0.05 | C | 0.15 |
| Example 9 | C | 0.08 | B | 0.05 | C | 0.17 |
| Example 10 | C | 0.09 | A | 0.03 | B | 0.12 |
| Example 11 | C | 0.09 | B | 0.05 | B | 0.12 |
| Example 12 | C | 0.09 | C | 0.06 | B | 0.12 |
| Example 13 | B | 0.04 | A | 0.03 | B | 0.12 |
| Example 14 | C | 0.09 | A | 0.03 | C | 0.17 |
| Example 15 | B | 0.02 | C | 0.06 | A | 0.08 |
| Example 16 | A | 0.01 | C | 0.06 | C | 0.18 |
| Example 17 | C | 0.05 | B | 0.05 | A | 0.08 |
| Example 18 | A | 0.01 | B | 0.05 | B | 0.12 |
| Example 19 | B | 0.02 | A | 0.03 | B | 0.12 |
| Example 20 | C | 0.06 | A | 0.03 | C | 0.18 |
| Example 21 | B | 0.02 | B | 0.05 | B | 0.12 |
| Example 22 | B | 0.02 | A | 0.03 | B | 0.12 |
| Example 23 | B | 0.02 | A | 0.03 | B | 0.12 |
| Example 24 | B | 0.02 | A | 0.03 | A | 0.08 |
| Example 25 | C | 0.06 | A | 0.03 | C | 0.17 |
| Example 26 | B | 0.05 | C | 0.06 | B | 0.12 |
| Example 27 | C | 0.07 | B | 0.05 | C | 0.16 |
| Example 28 | A | 0.01 | A | 0.03 | A | 0.08 |
| Example 29 | A | 0.01 | A | 0.03 | B | 0.12 |
| Example 30 | A | 0.01 | A | 0.03 | A | 0.06 |
| Example 31 | B | 0.03 | A | 0.02 | B | 0.12 |
| Example 32 | B | 0.03 | A | 0.02 | B | 0.12 |
| Example 33 | B | 0.03 | A | 0.02 | B | 0.12 |
| Example 34 | A | 0.01 | C | 0.06 | C | 0.17 |
| Example 35 | C | 0.08 | C | 0.06 | C | 0.17 |
| Example 36 | C | 0.09 | A | 0.03 | B | 0.12 |
| Example 37 | C | 0.09 | B | 0.05 | B | 0.12 |

TABLE 6-3

| | | | Evaluation method 1 | |
|---|---|---|---|---|
| | | | Evaluation of | Transfer |
| | | | initial | residual |
| | | Toner | transferability | density |
| Example 38 | Electrophotographic photosensitive member 38 | Toner 1 | A | 0.01 |
| Example 39 | Electrophotographic photosensitive member 39 | Toner 1 | A | 0.01 |
| Example 40 | Electrophotographic photosensitive member 40 | Toner 1 | A | 0.01 |
| Example 41 | Electrophotographic photosensitive member 41 | Toner 1 | A | 0.01 |
| Example 42 | Electrophotographic photosensitive member 42 | Toner 1 | B | 0.02 |
| Example 43 | Electrophotographic photosensitive member 43 | Toner 1 | A | 0.01 |
| Example 44 | Electrophotographic photosensitive member 44 | Toner 1 | B | 0.02 |
| Example 45 | Electrophotographic photosensitive member 45 | Toner 1 | A | 0.01 |
| Example 46 | Electrophotographic photosensitive member 46 | Toner 1 | B | 0.02 |
| Example 47 | Electrophotographic photosensitive member 47 | Toner 1 | B | 0.02 |
| Example 48 | Electrophotographic photosensitive member 48 | Toner 1 | B | 0.02 |
| Example 49 | Electrophotographic photosensitive member 49 | Toner 1 | B | 0.02 |
| Example 50 | Electrophotographic photosensitive member 50 | Toner 1 | B | 0.02 |
| Example 51 | Electrophotographic photosensitive member 51 | Toner 1 | B | 0.02 |
| Example 52 | Electrophotographic photosensitive member 52 | Toner 1 | B | 0.02 |
| Example 53 | Electrophotographic photosensitive member 53 | Toner 1 | A | 0.01 |
| Example 54 | Electrophotographic photosensitive member 54 | Toner 1 | A | 0.01 |
| Example 55 | Electrophotographic photosensitive member 55 | Toner 1 | A | 0.01 |
| Example 56 | Electrophotographic photosensitive member 56 | Toner 1 | A | 0.01 |
| Example 57 | Electrophotographic photosensitive member 69 | Toner 1 | A | 0.01 |
| Comparative Example 1 | Electrophotographic photosensitive member 57 | Toner 1 | D | 0.12 |
| Comparative Example 2 | Electrophotographic photosensitive member 58 | Toner 1 | D | 0.12 |
| Comparative Example 3 | Electrophotographic photosensitive member 59 | Toner 1 | D | 0.12 |
| Comparative Example 4 | Electrophotographic photosensitive member 60 | Toner 1 | C | 0.06 |
| Comparative Example 5 | Electrophotographic photosensitive member 61 | Toner 1 | D | 0.12 |
| Comparative Example 6 | Electrophotographic photosensitive member 62 | Toner 1 | D | 0.12 |
| Comparative Example 7 | Electrophotographic photosensitive member 63 | Toner 1 | D | 0.12 |
| Comparative Example 8 | Electrophotographic photosensitive member 64 | Toner 1 | D | 0.12 |
| Comparative Example 9 | Electrophotographic photosensitive member 65 | Toner 1 | D | 0.12 |
| Comparative Example 10 | Electrophotographic photosensitive member 66 | Toner 1 | C | 0.06 |
| Comparative Example 11 | Electrophotographic photosensitive member 67 | Toner 1 | D | 0.12 |
| Comparative Example 12 | Electrophotographic photosensitive member 68 | Toner 1 | D | 0.12 |
| Comparative Example 13 | Electrophotographic photosensitive member 70 | Toner 1 | C | 0.06 |
| Comparative Example 14 | Electrophotographic photosensitive member 71 | Toner 1 | C | 0.06 |
| Comparative Example 15 | Electrophotographic photosensitive member 72 | Toner 1 | C | 0.06 |
| Comparative Example 16 | Electrophotographic photosensitive member 73 | Toner 1 | D | 0.12 |

TABLE 6-4

| | Evaluation method 2 | | | | Evaluation method 4 | |
|---|---|---|---|---|---|---|
| | Evaluation of | | | | Evaluation of | |
| | transferability | Transfer | Evaluation method 3 | | endurance | |
| | at time of | residual | Evaluation of | Density | density | Density |
| | endurance | density | roughness | uniformity | transition | difference |
| Example 38 | C | 0.09 | C | 0.06 | B | 0.12 |
| Example 39 | B | 0.04 | A | 0.03 | B | 0.12 |
| Example 40 | C | 0.09 | A | 0.03 | C | 0.17 |
| Example 41 | C | 0.09 | A | 0.03 | C | 0.17 |
| Example 42 | B | 0.02 | C | 0.06 | A | 0.08 |
| Example 43 | A | 0.01 | C | 0.06 | C | 0.18 |
| Example 44 | C | 0.05 | B | 0.05 | A | 0.08 |
| Example 45 | A | 0.01 | B | 0.05 | B | 0.12 |
| Example 46 | B | 0.02 | A | 0.03 | B | 0.12 |
| Example 47 | C | 0.06 | A | 0.03 | C | 0.18 |
| Example 48 | B | 0.02 | B | 0.05 | B | 0.12 |
| Example 49 | B | 0.02 | A | 0.03 | B | 0.12 |
| Example 50 | B | 0.02 | A | 0.03 | B | 0.12 |
| Example 51 | B | 0.02 | A | 0.03 | A | 0.08 |
| Example 52 | C | 0.06 | A | 0.03 | C | 0.17 |
| Example 53 | B | 0.05 | C | 0.06 | B | 0.12 |
| Example 54 | C | 0.07 | B | 0.05 | C | 0.16 |
| Example 55 | A | 0.01 | A | 0.03 | A | 0.08 |
| Example 56 | A | 0.01 | A | 0.03 | B | 0.12 |
| Example 57 | A | 0.01 | A | 0.03 | A | 0.06 |
| Comparative Example 1 | C | 0.06 | D | 0.08 | B | 0.12 |
| Comparative Example 2 | C | 0.06 | C | 0.06 | B | 0.12 |
| Comparative Example 3 | D | 0.12 | C | 0.06 | D | 0.21 |
| Comparative Example 4 | D | 0.11 | C | 0.06 | B | 0.12 |
| Comparative Example 5 | D | 0.12 | C | 0.06 | C | 0.18 |
| Comparative Example 6 | D | 0.11 | D | 0.08 | C | 0.18 |
| Comparative Example 7 | C | 0.06 | D | 0.08 | B | 0.12 |
| Comparative Example 8 | C | 0.06 | C | 0.06 | B | 0.12 |
| Comparative Example 9 | D | 0.11 | C | 0.06 | D | 0.21 |
| Comparative Example 10 | D | 0.11 | C | 0.06 | B | 0.12 |
| Comparative Example 11 | D | 0.11 | D | 0.08 | B | 0.12 |
| Comparative Example 12 | D | 0.12 | D | 0.08 | C | 0.18 |
| Comparative Example 13 | D | 0.12 | C | 0.06 | D | 0.21 |
| Comparative Example 14 | D | 0.12 | B | 0.05 | D | 0.2 |
| Comparative Example 15 | D | 0.12 | D | 0.08 | D | 0.22 |
| Comparative Example 16 | D | 0.12 | B | 0.05 | D | 0.22 |

The present invention can provide the electrophotographic photosensitive member, which has transferability improved by controlling a distance between particles in a surface layer to reduce the adhesive force of toner, and which has durability improved by suppressing the detachment of the particles from the surface layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electrophotographic photosensitive member comprising a surface layer containing particles and a binder resin,
wherein the particles in the surface layer have a plurality of peaks in a number-based particle size distribution,
wherein, when, among the peaks each having a peak top at 20 nm or more among the plurality of peaks, the peak having a highest frequency at the peak top is defined as a first peak, and the peak having a second highest frequency at the peak top after the first peak is defined as a second peak, and
when, of the first peak and the second peak, the peak having a larger value of a particle diameter at the peak top is defined as a peak PEA,
a particle diameter DA at the peak top of the peak PEA falls within a range of 80 nm or more and 300 nm or less,
wherein, when, among the particles in the surface layer, the particles each having a particle diameter in a range of DA±20 nm are defined as particles PAA, and convex portions, which are derived from the particles PAA, and which each have a height in a range of 10 nm or more and 300 nm or less, are defined as convex portions CA, the convex portions CA are arranged on a surface of the surface layer,
wherein, when the surface layer is viewed from above, an average value of distances between gravity centers of the convex portions CA is 150 nm or more and 500 nm or less, and a standard deviation of the distances between gravity centers of the convex portions CA is 250 nm or less, and
wherein, when the surface layer is viewed from above, and when an area occupied by the particles on the surface of the surface layer is represented by S1 and an area occupied by portions except the particles is represented by S2, S1/(S1+S2) is 0.70 or more and 1.00 or less.

2. The electrophotographic photosensitive member according to claim 1, wherein, when an average value of thicknesses of the surface layer in sites that are free of the particles PAA in a cross-section of the surface layer is represented by T, the DA and the T satisfy the following formula (1),
$$D A > T . \qquad Formula ( 1 )$$

3. The electrophotographic photosensitive member according to claim 1, wherein, when, of the first peak and the second peak, the peak having a smaller value of a particle diameter at the peak top is defined as a peak PEB, a particle diameter at the peak top of the peak PEB is represented by DB, and an average value of thicknesses of the surface layer in sites that are free of the particles PAA in a cross-section of the surface layer is represented by T, the DB and the T satisfy the following formula (2),
$$D B < T . \qquad Formula ( 2 )$$

4. The electrophotographic photosensitive member according to claim 3, wherein the DA and the DB satisfy the following formula (3),
$$DB / DA > 1 / 10. \qquad Formula ( 3 )$$

5. The electrophotographic photosensitive member according to claim 1, wherein a ratio of the number of the convex portions CA to a total number of convex portions present on the surface of the surface layer is 90 number % or more.

6. The electrophotographic photosensitive member according to claim 1, wherein the peak PEA has a half-width of 20 nm or more and 50 nm or less.

7. The electrophotographic photosensitive member according to claim 1, wherein the surface of the surface layer has a maximum height difference Rz of 100 nm or more and 400 nm or less.

8. The electrophotographic photosensitive member according to claim 1, wherein the particles PAA each have a circularity of 0.950 or more.

9. The electrophotographic photosensitive member according to claim 1, wherein particles A in the surface layer each have a specific dielectric constant F(A) of 5 or less, and particles except the particles A incorporated into the surface layer each have a specific dielectric constant P(NA) that is larger than the F(A) by 5 or more.

10. The electrophotographic photosensitive member according to claim 9,
wherein particles except the particles PAA in the surface layer are electroconductive particles obtained by treating surfaces of metal oxide particles with a compound containing Si, and
wherein, in X-ray photoelectron spectroscopic analysis of the surface layer, when a total of a relative concentration d(C) of a carbon atom, a relative concentration d(O) of an oxygen atom, a relative concentration d(Ti) of a titanium atom, and a relative concentration d(Si) of a silicon atom determined by the X-ray photoelectron spectroscopic analysis is defined as 100.0 atomic %, the d(Ti) (atomic %) and the d(Si) (atomic %) satisfy the following formulae (4) to (6):
$$0 < d ( Ti ) \leq 2. , \qquad Formula ( 4 )$$
$$d ( Si ) \leq 15. and \qquad Formula ( 5 )$$
$$0.01 \leq d ( Ti ) / d ( Si ) \leq 1. . \qquad Formula ( 6 )$$

11. The electrophotographic photosensitive member according to claim 10, wherein, in each of the electroconductive particles, a ratio of a niobium atom/titanium atom concentration ratio in an inside portion at 5% of a maximum diameter of the electroconductive particle from a surface of the electroconductive particle to a niobium atom/titanium atom concentration ratio in a central portion of the electroconductive particle is 2.0 or more in energy-dispersive X-ray analysis (EDS analysis) connected to a scanning transmission electron microscope (STEM).

12. A process cartridge comprising:
An electrophotographic photosensitive member comprising a surface layer containing particles and a binder resin,
wherein the particles in the surface layer have a plurality of peaks in a number-based particle size distribution,
wherein, when, among the peaks each having a peak top at 20 nm or more among the plurality of peaks, the peak having a highest frequency at the peak top is defined as a first peak, and the peak having a second highest frequency at the peak top after the first peak is defined as a second peak, and
when, of the first peak and the second peak, the peak having a larger value of a particle diameter at the peak top is defined as a peak PEA,
a particle diameter DA at the peak top of the peak PEA falls within a range of 80 nm or more and 300 nm or less,
wherein, when, among the particles in the surface layer, the particles each having a particle diameter in a range of DA±20 nm are defined as particles PAA, and convex portions, which are derived from the particles PAA, and which each have a height in a range of 10 nm or more and 300 nm or less, are defined as convex portions CA, the convex portions CA are arranged on a surface of the surface layer,
wherein, when the surface layer is viewed from above, an average value of distances between gravity centers of the convex portions CA is 150 nm or more and 500 nm or less, and a standard deviation of the distances between gravity centers of the convex portions CA is 250 nm or less, and
wherein, when the surface layer is viewed from above, and when an area occupied by the particles on the surface of the surface layer is represented by S1 and an area occupied by portions except the particles is represented by S2, S1/(S1+S2) is 0.70 or more and 1.00 or less; and
at least one means selected from the group consisting of: charging means; developing means; and cleaning means,
the process cartridge integrally supporting the electrophotographic photosensitive member and the at least one means, and being detachably attachable onto a main body of an electrophotographic apparatus.

13. An electrophotographic apparatus comprising:
an electrophotographic photosensitive member comprising a surface layer containing particles and a binder resin,
wherein the particles in the surface layer have a plurality of peaks in a number-based particle size distribution,
wherein, when, among the peaks each having a peak top at 20 nm or more among the plurality of peaks, the peak having a highest frequency at the peak top is defined as a first peak, and the peak having a second highest frequency at the peak top after the first peak is defined as a second peak, and
when, of the first peak and the second peak, the peak having a larger value of a particle diameter at the peak top is defined as a peak PEA,
a particle diameter DA at the peak top of the peak PEA falls within a range of 80 nm or more and 300 nm or less,
wherein, when, among the particles in the surface layer, the particles each having a particle diameter in a range of DA±20 nm are defined as particles PAA, and convex portions, which are derived from the particles PAA, and which each have a height in a range of 10 nm or more and 300 nm or less, are defined as convex portions CA, the convex portions CA are arranged on a surface of the surface layer,
wherein, when the surface layer is viewed from above, an average value of distances between gravity centers of the convex portions CA is 150 nm or more and 500 nm or less, and a standard deviation of the distances between gravity centers of the convex portions CA is 250 nm or less, and
wherein, when the surface layer is viewed from above, and when an area occupied by the particles on the surface of the surface layer is represented by S1 and an area occupied by portions except the particles is represented by S2, S1/(S1+S2) is 0.70 or more and 1.00 or less; and
charging means, exposing means, developing means, and transfer means.
